(19) United States
(12) Patent Application Publication
(10) Pub. No.: US 2008/0255912 A1
(43) Pub. Date: Oct. 16, 2008

(54) Framework System and Method for Determining Deliverables Required to Implement a Technology-Enabled Business Change

(75) Inventors: Sandy A. Christiansen, Lakewood, CO (US); Matthew B. Reid, Orem, UT (US); Carl F. Neer, Brighton, CO (US)

Correspondence Address: BAKER BOTTS L.L.P., 2001 ROSS AVENUE, 6TH FLOOR, DALLAS, TX, 75201-2980, US

(73) Assignee: Electronic Data Systems Corporation, Plano, TX (US)

(21) Appl. No.: 11/961,863

(22) Filed: Dec. 20, 2007

Related U.S. Application Data
(60) Provisional application No. 60/911,499, filed on Apr. 12, 2007.

(51) Int. Cl. G06Q 10/00

(52) U.S. Cl. 705/8

(57) ABSTRACT

Methods, systems, and computer program products are provided for determining and implementing business changes. In one embodiment, a set of stages in a business change process are defined. A set of deliverables are also defined corresponding to each stage. A set of components are defined corresponding to each deliverable. And, a set of supporting assets are defined corresponding to each component. The various items may be view via a graphical user interface and may be selected to provide a customized plan for providing the deliverables to implement the business change.

### CROSS-REFERENCE TO RELATED APPLICATIONS

This application claims the benefit of priority under 35 U.S.C. §119(e) of U.S. Provisional Application Ser. No. 60/911,499 filed Apr. 12, 2007.

### TECHNICAL FIELD OF THE INVENTION

The present invention relates generally to the field of computer software and, more specifically to business methods and, even more specifically, to improving methods of business change.

### BACKGROUND

In today's highly competitive business world, enterprises must continually change themselves in order to meet the needs of an ever changing marketplace so as to survive and make a profit. Those that do not change are superseded in the marketplace by competitors who have taken the initiative to improve the manner in which they do business in order to better service the customer.

Information Technology (IT) and Information Services (IS) providers as well as Business Process Outsourcing in general play an integral role in helping businesses change successfully to improve their position in the marketplace These Outsourcers do this, for example, by providing technology infrastructure and solutions that enable the business to perform one or more of its functions better. For example, an IT and IS provider may change the method that a business maintains inventory records and accounting records or may provide a new and better method for handling customer phone calls. The ways in which IT and IS providers may aid a business are virtually limitless.

### SUMMARY

The present invention provides a method, system, and computer program product for determining and implementing business changes. In one embodiment, a set of stages in a business change process that are performed sequentially are defined. This may include defining a set of elements corresponding to each stage, wherein each element groups a set of related activities and deliverables together. A set of work product may also be defined comprising a group of closely related transformation activities that produce a client recognizable product for each element. The stages are presented to a user as selectable components in a graphical user interface. Responsive to selection of a component by a user, the user may be presented with a display of greater detail of the corresponding stage. Successive selection of components presents greater detail to the user about the corresponding component, thus enabling a user to ensure that all aspects of a business change are considered when planning a business change project.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system is depicted in which the present invention may be implemented;

FIG. 2 depicts a block diagram of a data processing system which may be implemented as a server in accordance with the present invention;

FIG. 3 depicts a block diagram of a data processing system in which the present invention may be implemented is illustrated;

FIG. 4 depicts a block diagram illustrating an exemplary BCL Framework Stages and major Elements within each stage in accordance with one embodiment of the present invention;

FIG. 5 depicts a block diagram illustrating the concepts of stages and strands in accordance with one embodiment of the present invention;

FIG. 6 depicts a block diagram illustrating how the Work Products and Work Product Components fit within the overall BCL Framework;

FIG. 7 depicts a block diagram which provides an example of a program's Work Products and Work Product Components in accordance with one embodiment of the present invention;

FIG. 8 depicts a block diagram illustrating an exemplary overall structure to a BCL program in accordance with one embodiment of the present invention;

FIG. 9 depicts an exemplary main user display in accordance with one embodiment of the present invention;

FIG. 10 depicts an exemplary Graphical User Interface (GUI) presented to a user upon selection of the stages icon 904 depicted in FIG. 9 in accordance with one embodiment of the present invention;

FIG. 11 depicts a block diagram illustrating an exemplary set of components for the Discovery Stage 1002 in accordance with one embodiment of the present invention;

FIG. 12 depicts a block diagram illustrating an exemplary set of components for the Define and Initiate Stage 1004 in accordance with one embodiment of the present invention;

FIG. 13 depicts a block diagram illustrating an exemplary set of components for the Design Stage 1006 in accordance with one embodiment of the present invention;

FIG. 14 depicts a block diagram illustrating an exemplary set of components for the Develop Stage 1008 in accordance with one embodiment of the present invention;

FIG. 15 depicts a block diagram illustrating an exemplary set of components for the Implement Stage 1010 in accordance with one embodiment of the present invention;

FIG. 16 depicts a block diagram illustrating an exemplary set of components for the Operate and Support Stage 1012 in accordance with one embodiment of the present invention;

FIG. 17 depicts a pictorial diagram illustrating an exemplary display 1700 that may be presented to a user upon selection of the Strands area 906 in FIG. 9 in accordance with one embodiment of the present invention;

FIG. 18 depicts a pictorial diagram illustrating an exemplary display 1800 that may be presented to a user upon selection of the Index area 910 in FIG. 9 in accordance with one embodiment of the present invention;

FIG. 19 depicts a pictorial diagram illustrating exemplary ways in which the BCL Framework may be utilized by differing groups of people in accordance with one embodiment of the present invention;

FIG. 20 depicts a pictorial diagram illustrating an exemplary user Flight Plan Menu display 2000 that may be presented to a user upon selection of the Flight Plan area 908 in FIG. 9 in accordance with one embodiment of the present invention;

FIG. 21 depicts a pictorial diagram illustrating an exemplary graphical user interface presented to a user top facilitate the creation of a flight plan by the user in accordance with one embodiment of the present invention;

FIGS. 22-26 depicts diagrams 2200, 2300, 2400, 2500, 2600 illustrate an exemplary BCL framework and its use to aid the hypothetical client in accordance with one embodiment of the present invention in order to aid in understanding how the BCL framework can be applied to solving the hypothetical client's problems;

FIG. 27 is a block diagram of a business change lifecycle system according to an embodiment of the present invention;

FIGS. 28, 29, and 31 are block diagrams of a processing system in which certain embodiments of the present invention may be implemented;

FIG. 30 is a block diagram of an Agile Right step framework and a Supporting Assets Repository according to an embodiment of the present invention;

FIGS. 32-36 are example screen shots of a graphical user interface according to various embodiments of the present invention;

FIGS. 37-51 are flow diagrams illustrating various processes, portions of processes, and components and elements of processes of various embodiments of the present invention; and

FIGS. 52-54 are example screen shots of a graphical user interface according to various embodiments of the present invention.

### DETAILED DESCRIPTION

One problem encountered by many IT and IS providers is the lack of a utilization of a uniform set of terminology across the board by all members of the IT and IS provider. Thus, when a sales representative meets with a prospective client and works out an agreement to provide a set of services and technology to that client, there is the potential that the engineers, other technologists, stakeholders, and other groups associated with the transformation project that work to supply the solution the client has requested end up supplying a solution to a different problem than the client had in mind.

Furthermore, in large Outsourcing providers, there is often an inefficiency in delivering solutions to clients due to duplication of effort by various teams within the provider. For example, one team of consultants may have come up with a solution for one client that may also have application for another client. However, the team working on solutions for this second client may not be aware of the work of the first team and, therefore, end up performing the work of the first team all over again.

Thus, there is a need to have a method, system, and computer program product to reinforce an IT and IS provider's service and product offerings in the business transformation arena by providing consistency across the engagements and eliminating the duplication of work between multiple project teams. Furthermore, it would be desirable to have a system that reduces any unnecessary duplication of work for both the IT/IS provider and the client through better sharing of information across different projects and inhibits the need to collect or analyze the same data several times. It would also be desirable to have a method, system, and computer program product that prevents any confusion caused by using different terminologies within different parts of a business change program. It would also be desirable to have a method, system, and computer program product that enables the IT/IS provider to find the information it needs easily, without getting lost in the vast amount of overlapping/duplicated material that is difficult to correlate. And, moreover, it would be desirable to have a method, system, and computer program product that collates and consolidates the intellectual capital across the IT/IS provider in order to provide an effective way to find the information and help adapt the relevant processes and tools to specific engagements. Such a system, among other advantages, would allow experienced consultants to pass on their knowledge to junior consultants with minimum effort.

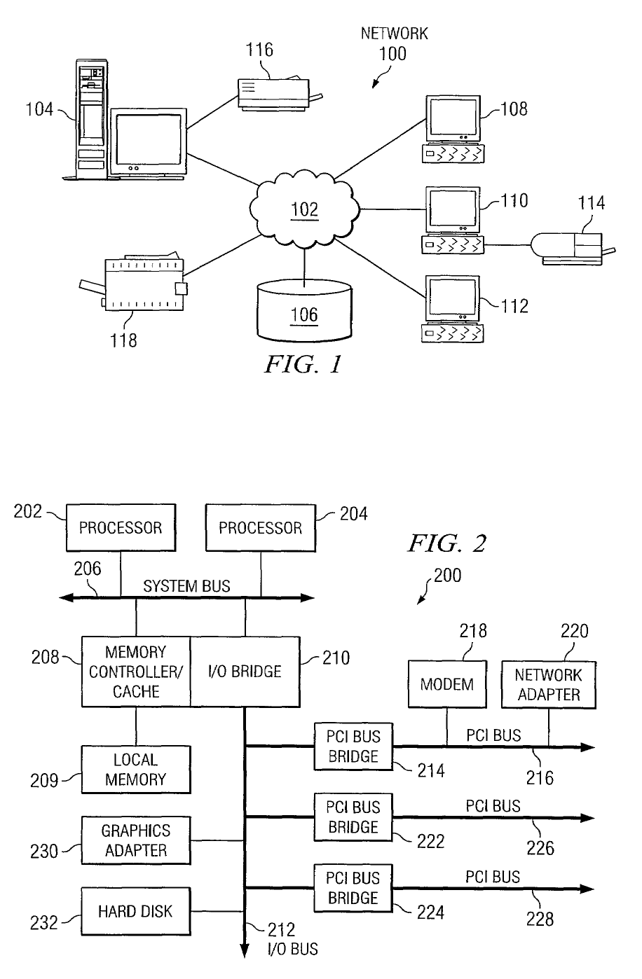

Some of the discussion that follows is drawn from published U.S. Patent Application No. 2006/0143219, which is hereby incorporated by reference. With reference now to the figures, and in particular with reference to FIG. 1, a pictorial representation of a distributed data processing system is depicted in which the present invention may be implemented. Certain embodiments of the present invention provide a Business Change Lifecycle (BCL) framework that may be implemented within a stand alone data processing system, such as, for example, a laptop or desktop computer, or may be implemented in conjunction with a networked data processing system as depicted in FIG. 1. The BCL framework is described in great detail below after first describing an example of hardware on which the BCL framework of the present invention may be implemented.

Distributed data processing system 100 is a network of computers in which the present invention may be implemented. Distributed data processing system 100 contains network 102, which is the medium used to provide communications links between various devices and computers connected within distributed data processing system 100. Network 102 may include permanent connections, such as wire or fiber optic cables, or temporary connections made through telephone connections.

In the depicted example, server 104 is connected to network 102, along with storage unit 106. In addition, clients 108, 110 and 112 are also connected to network 102. These clients, 108, 110 and 112, may be, for example, personal computers or network computers. For purposes of this application, a network computer is any computer coupled to a network that receives a program or other application from another computer coupled to the network. In the depicted example, server 104 provides data, such as boot files, operating system images and applications, to clients 108-112. Clients 108, 110 and 112 are clients to server 104. Distributed data processing system 100 may include additional servers, clients, and other devices not expressly shown. Distributed data processing system 100 also includes printers 114, 116 and 118. A client, such as client 110, may print directly to printer 114. Clients such as client 108 and client 112 do not have directly attached printers. These clients may print to printer 116, which is attached to server 104, or to printer 118, which is a network printer that does not require connection to a computer for printing documents. Client 110, alternatively, may print to printer 116 or printer 118, depending on the printer type and the document requirements.

In the depicted example, distributed data processing system 100 is the Internet, with network 102 representing a worldwide collection of networks and gateways that use the TCP/IP suite of protocols to communicate with one another. At the heart of the Internet is a backbone of high-speed data communication lines between major nodes or host computers consisting of thousands of commercial, government, education, and other computer systems that route data and messages. Of course, distributed data processing system 100 also may be implemented as a number of different types of networks such as, for example, an intranet, local area network, wide area network, or other suitable telecommunications network. FIG. 1 is intended as an example and not as an architectural limitation for the processes of the present invention.

Referring to FIG. 2, a block diagram of a data processing system which may be implemented as a server, such as server 104 in FIG. 1, is depicted in accordance with at least one embodiment. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and 1/0 bus bridge 210 may be integrated as depicted.

Peripheral component interconnect (PCI) bus bridge 214 connected to I/O bus 212 provides an interface to PCI local bus 216. A number of modems 218-220 may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A memory mapped graphics adapter 230 and hard disk 232 may also be connected to I/O bus 212 as depicted, either directly or indirectly. Server 200 may be used, for example, to facilitate sharing of BCL information between users as is described below. Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the various embodiments described herein.

Data processing system 200 may be implemented as, for example, an AlphaServer GS1280 running a UNIX® operating system. AlphaServer GS1280 is a product of Hewlett-Packard Company of Palo Alto, Calif. “AlphaServer” is a trademark of Hewlett-Packard Company. “UNIX” is a registered trademark of The Open Group in the United States and other countries.

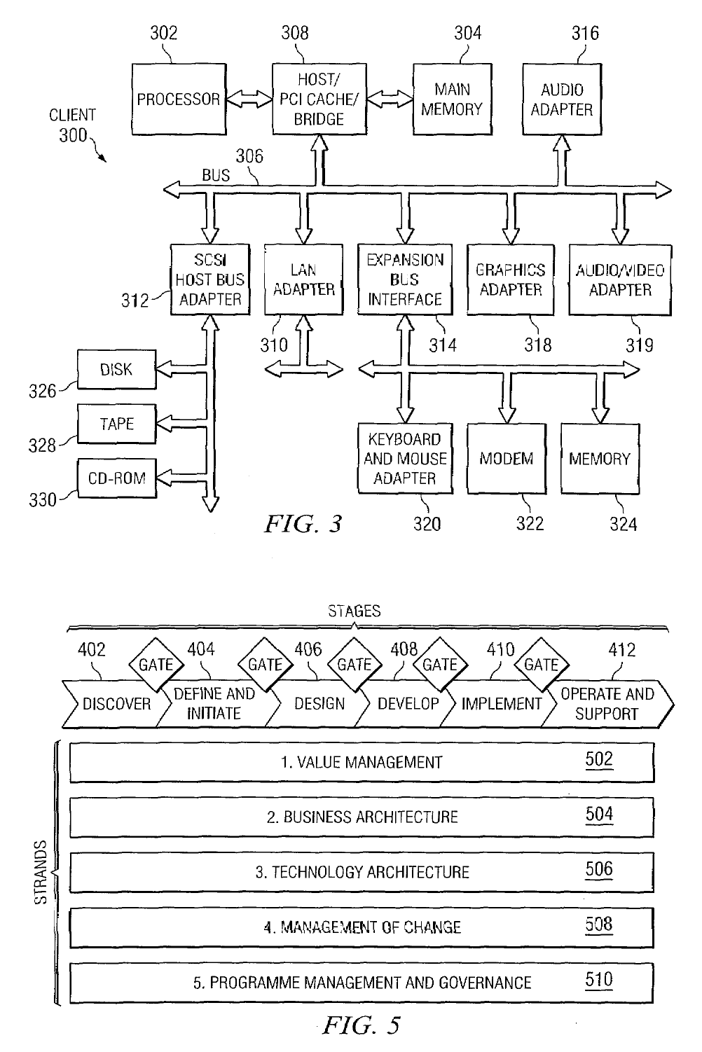

With reference now to FIG. 3, a block diagram of a data processing system in which the present invention may be implemented is illustrated. Data processing system 300 is an example of a client computer. Data processing system 300 employs a peripheral component interconnect (PCI) local bus architecture. Although the depicted example employs a PCI bus, other bus architectures, such as Micro Channel and ISA, may be used. Processor 302 and main memory 304 are connected to PCI local bus 306 through PCI bridge 308. PCI bridge 308 may also include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter (A/V) 319 are connected to PCI local bus 306 by add-in boards inserted into expansion slots. Expansion bus interface 314 provides a connection for a keyboard and mouse adapter 320, modem 322, and additional memory 324. In the depicted example, SCSI host bus adapter 312 provides a connection for hard disk drive 326, tape drive 328, CD-ROM drive 330, and digital video disc read only memory drive (DVD-ROM) 332. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation of Redmond, Wash. “Windows XP” is a trademark of Microsoft Corporation. An object-oriented programming system, such as Java, may run in conjunction with the operating system, providing calls to the operating system from Java programs or applications executing on data processing system 300. Instructions for the operating system, the object-oriented operating system, and applications or programs are located on a storage device, such as hard disk drive 326, and may be loaded into main memory 304 for execution by processor 302.

Data processing system 300 may be used to implement an instance of a BCL framework for a user. In some embodiments, data processing system 300 may be a laptop or other portable data processing system to aid user's such as sale people, who may need to give presentations utilizing the BCL framework of the present invention.

Those of ordinary skill in the art will appreciate that the hardware in FIG. 3 may vary depending on the implementation. For example, other peripheral devices, such as optical disk drives and the like, may be used in addition to or in place of the hardware depicted in FIG. 3. The depicted example is not meant to imply architectural limitations with respect to the various embodiments described herein. For example, the processes of the present invention may be applied to multiprocessor data processing systems.

Turning now to Business Transformation or Business Change Lifecycle, business transformation is a very complex undertaking with a large number of steps—from defining the initial concepts, planning the deployment strategy, developing the required services, implementing new business change, realization of benefits through to ongoing support and continuous improvement. The BCL Framework preferably covers all of these processes, its activities and deliverables.

The BCL Framework divides IT-enabled business transformation into six clearly defined, time-boxed and self-contained “phases”, called “Stages”. These phases are performed sequentially, but may also include some on-going tasks or activities that are executed in an iterative manner. Different projects within the same program may also go through different Stages, independently of each other. Each Stage is further subdivided into “Elements” that group the related activities and deliverables into a smaller program/project sub-phase that is clearly identifiable to the client.

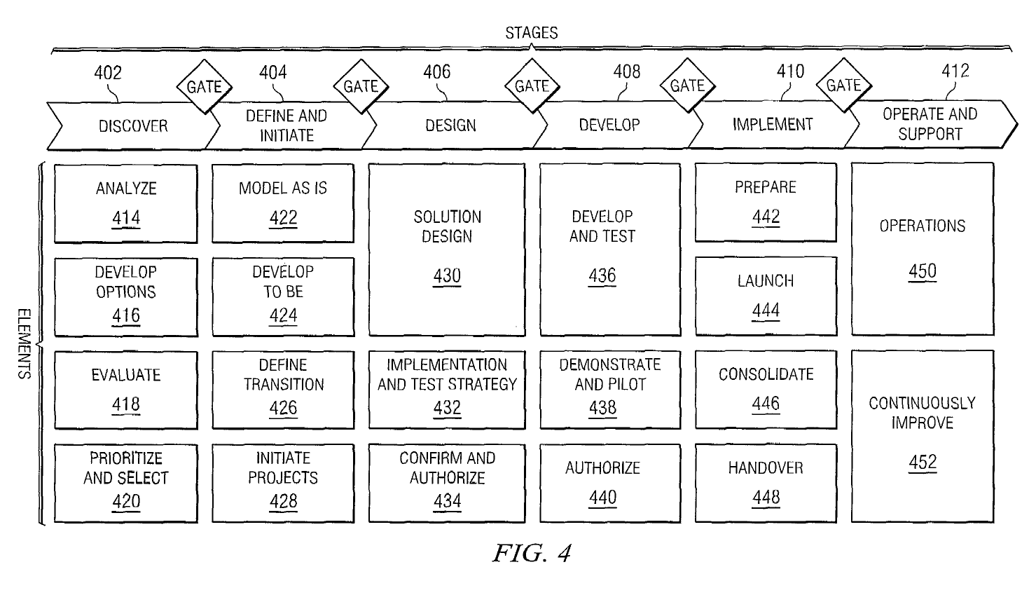

With reference now to FIG. 4, a block diagram illustrating an exemplary BCL Framework Stages and major Elements within each stage is depicted in accordance with one embodiment of the present invention. For presentation convenience, the diagram shows the Stages 402-412 from left to right while the Elements 414-452 are arranged from top to bottom below their appropriate Stage 402-412. In practice, both Stages 402-412 and Elements 414-452 are executed sequentially.

In this example, the stages 402-412 include the Discover stage 402, the Define and Initiate Stage 404, the Design Stage 406, the Develop Stage 408, the Implement Stage 410, and the Operate and Support Stage 412. The elements for the Discover Stage 402 include Analyze 414, Develop Options 416, Evaluate 418, and Prioritize and Select 420. The elements under the Define and Initiate Stage 404 include Model As Is 422, Develop To Be 424, Define Transition 426, and Initiate Projects 428. The elements under the Design Stage 406 include the Solution Design 430, the Implementation and Test Strategy 432, and the Confirm and Authorize 434. The elements under the Develop Stage 408 include the Develop and Test 436 element, the Demonstrate and Pilot 438 element, and the Authorize 440 element. The elements under the Implement Stage 410 include the Prepare 442 element, the Launch 444 element, the Consolidate 446 element, and the Handover 448 element. The elements under the Operate & Support Stage 412 include Operations 450 and Continuously Improve 452.

With reference now to FIG. 5, an block diagram illustrating the concepts of stages and strands is depicted in accordance with one embodiment of the present invention. A fully-integrated change program may cover all transformation aspects and stakeholders (parties that contribute to, have an impact on, or are impacted by the business transformation).

The BCL Framework manages various “dimensions of change” through five “Strands” 502-510, which group the related activities, deliverables and stakeholders, as shown in FIG. 4. The Strands 502-510 run across all of the Stages 402-412 and ensure that the project can properly address all inter-relationships and dependencies to complete the change lifecycle successfully. The strands include Value Management 502, Business Architecture 504, Technology Architecture 506, Management of Change 508, and Program Management and Governance 510.

The BCL Framework “Work Product” is a group of closely related transformation activities that produces a client-recognizable product. Work Products are normally contained within the intersection of a Stage 402-412 and a Strand 502-510, but they can also span more than one Stage 404-412 or Strand 502-510. Each Work Product can have one or more “Work Product Components”. A Work Product Component is a group of closely related tasks that need to be carried out by specific resources. The Work Product Component definitions include all of the information that one would need to complete the tasks in question such as descriptions, dependencies, tools, templates, and examples.

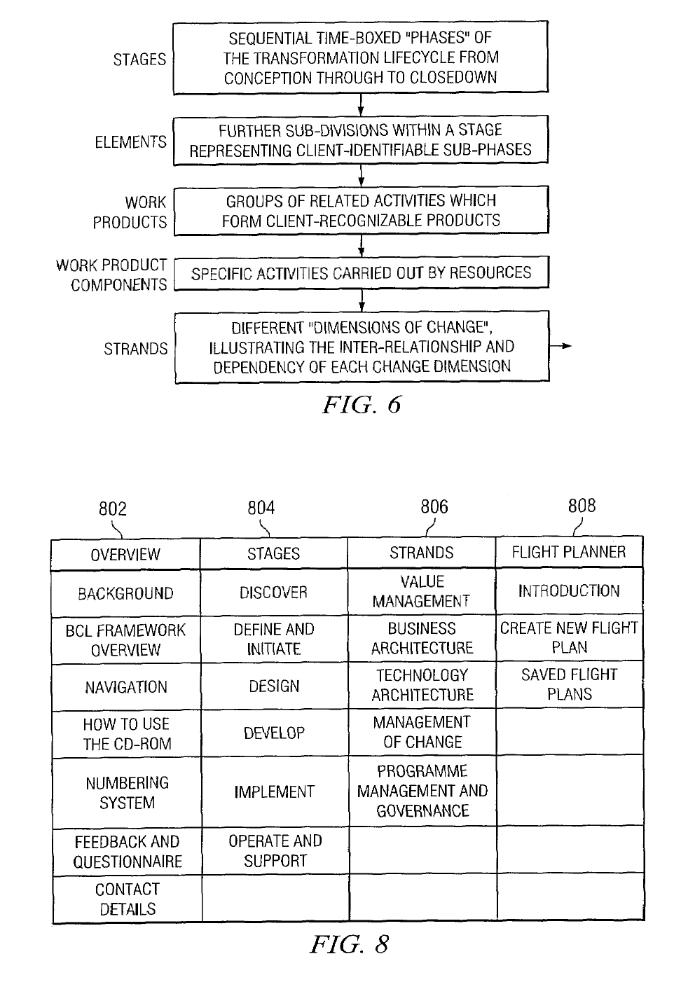

With reference now to FIG. 6, a block diagram illustrates how the Work Products and Work Product Components fit within the overall BCL Framework.

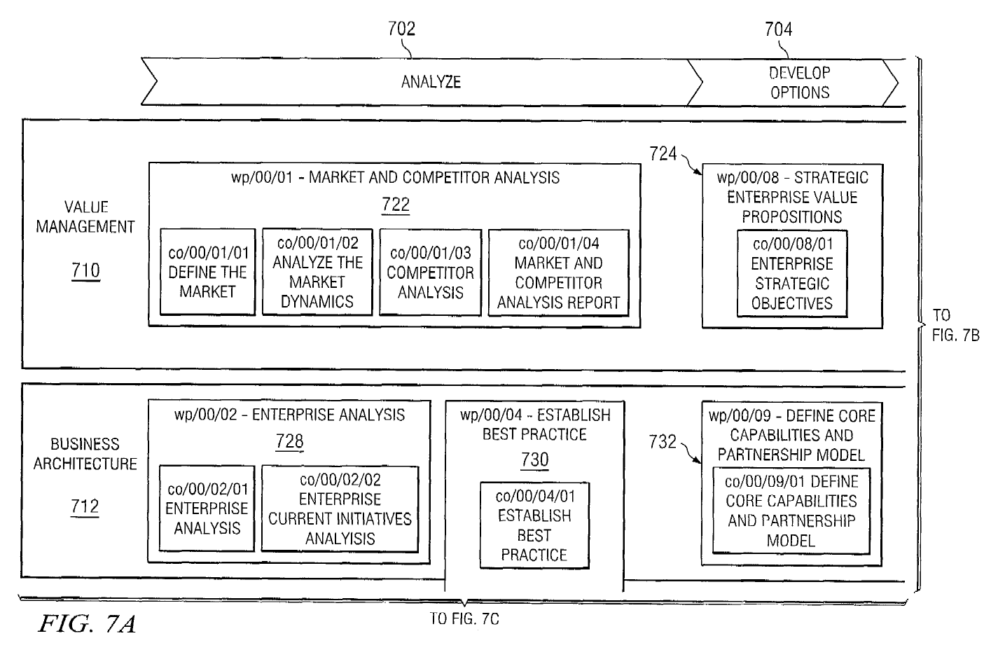

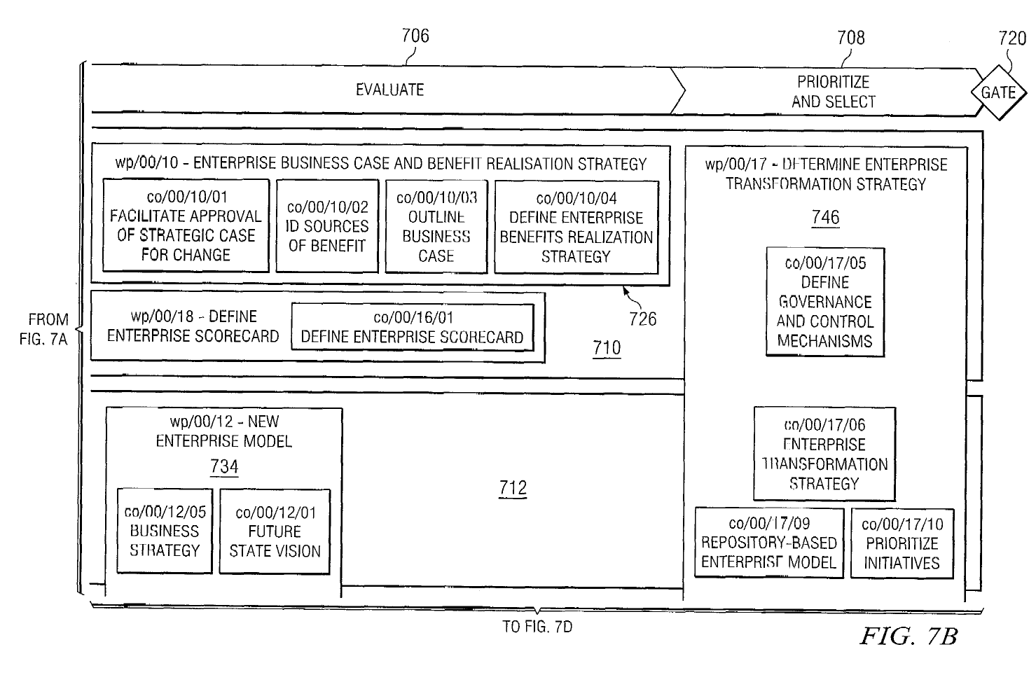

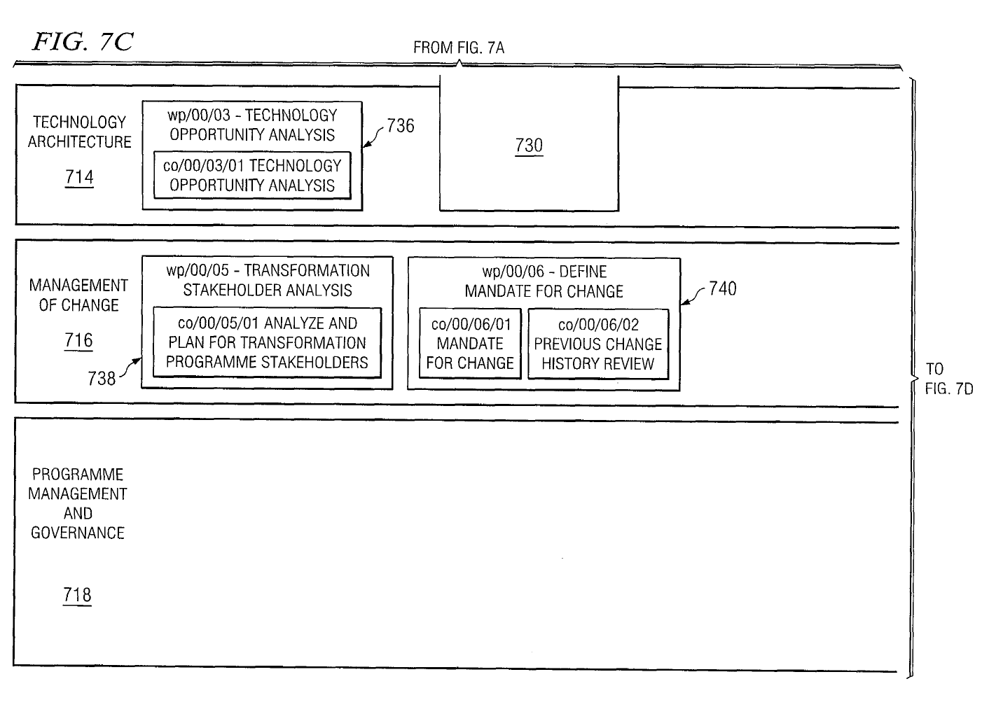

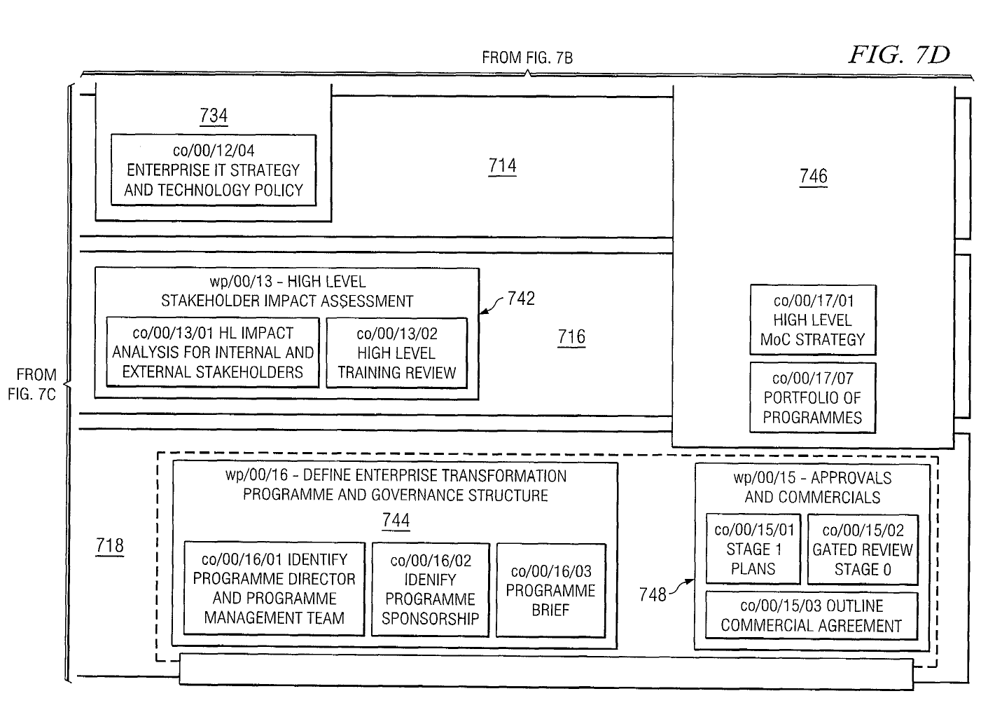

With reference now to FIG. 7, a block diagram gives an example of a program's Work Products and Work Product Components in accordance with one embodiment of the present invention. This example is a typical BCL diagram showing the Elements 702-708 across the top and the program Strands 710-718 on the side. Most of the Work Products 722-748 are contained within a single Element 702-708 and a single Strand 710-718, but some span multiple Elements 702-708 and/or Strands 710-718 (such as, for example, Work Product 746). Within each Work Product 722-748 there is one or more Work Product Components. Each Stage may also include one or more formal reviews (indicated as Gate 720 in the diagram) that serve as the decision points and give the program/project the authority to proceed to the next phase.

A typical approach that can be adopted when using the BCL Framework is as follows:

1. Check the assignment briefing (such as the Statement of Work) and articulate the detailed tasks that need to be accomplished;

2. Review these tasks against the BCL Framework and determine the overall scope in terms of Stages and Strands;

3. Search for and identify relevant Work Products and Work Product Components that could support completing the work or activities;

4. Develop a work plan using the templates provided for relevant Work Products and Work Product Components as a starting point;

5. Identify any gaps in the supporting collateral and the additional work needed to complete the assignment and notify the assignment leader as necessary;

6. Start the work using the guidelines provided within the BCL Framework documents for relevant Work Products and Work Product Components.

In one embodiment, the BCL Framework is provided in electronic format on, for example, a single CD-ROM for use, for example, on a desktop or laptop computer, such as, for example data processing system 300 depicted in FIG. 3 and backed up by a comprehensive selection of online resources maintained as a part of an IT/IS Provider's Intranet, such as, for example, on a server such as server 200 depicted in FIG. 2 integrated into an Intranet such as, for example, Internet 100 depicted in FIG. 1.

With reference now to FIG. 8, a block diagram illustrating an exemplary overall structure to a BCL program is depicted in accordance with one embodiment of the present invention. The BCL Framework software has four sections with the overall structure as presented in FIG. 8. The Overview section 802 contains the guidance material for using the BCL Framework. The Stages 804 and Strands 806 sections provide slightly different access routes to the shared underlying material, consisting of numerous Work Products, Work Product Components and items of supporting information. The Flight Planner section 808 provides a tool for consultants to develop client-specific programs of change.

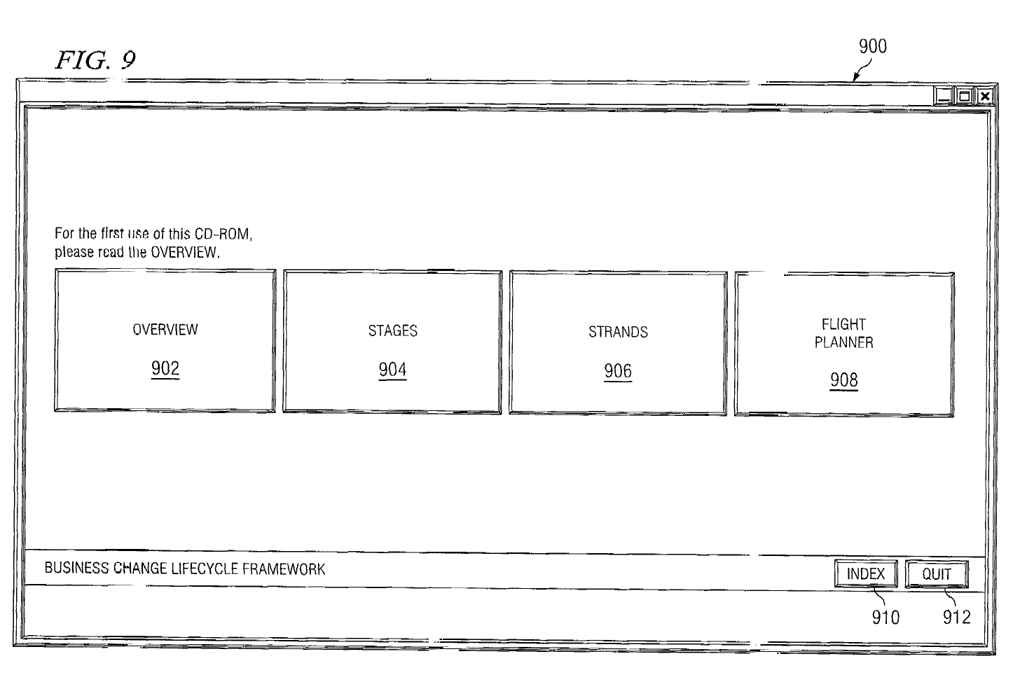

With reference now to FIG. 9, an exemplary main user display is depicted in accordance with one embodiment of the present invention. The Main Menu 900 has several options that lead to the main content sections as mentioned previously:

1. Overview 902—Selecting this option will take you to the introductory menu and further screens that describe the BCL Framework and how to navigate around it.

2. Stages 904—This option will lead to the Stages Menu that will display the BCL Framework by the phases in the change program lifecycle. There is further drill down to the Work Products and Work Product Components associated with each Stage (e.g., selecting an icon or box within one level to bring up more detail at a lower level). Scanning the contents starting with the Discover Stage and progressing through each Stage in turn will showing all of the BCL Framework components. It is recommended that first time users start with the Stages view.

3. Strands 906—This option displays the Strands Menu enabling navigation to a specific Strand or ‘dimensions of change’ in the BCL Framework. Access to the Work Products and Work Product Components for each Strand can be done through the Strands. A Strand view will only display the Work Products for that particular Strand and does not necessarily indicate all of change program dependencies and relationships.

4. Flight Planner 908—This option will display the Flight Planner Menu and the opportunity to create a new Flight Plan, modify and view previously saved Flight Plans; Import and Export flight plans.

The BCL Framework menus and sub-menu screens may also contain the following additional buttons:

1. Index 910—Displays the Work Products and Work Product Components Menu from where a comprehensive list and numbering for all Work Products and Work Product Components can be found. These lists contain hyperlinks that be used to display the detailed information about a Work Product or Work Product Component.

2. Back—Displays the previous screen.

3. Main Menu—Displays the Main Menu.

4. Color Key—Displays the Color Key Tags and allows users to modify these Color Key Tags, for each Flight Plan.

5. Print—Print command to print the current view/screen.

6. Quit 912—Allows the user to quit the program.

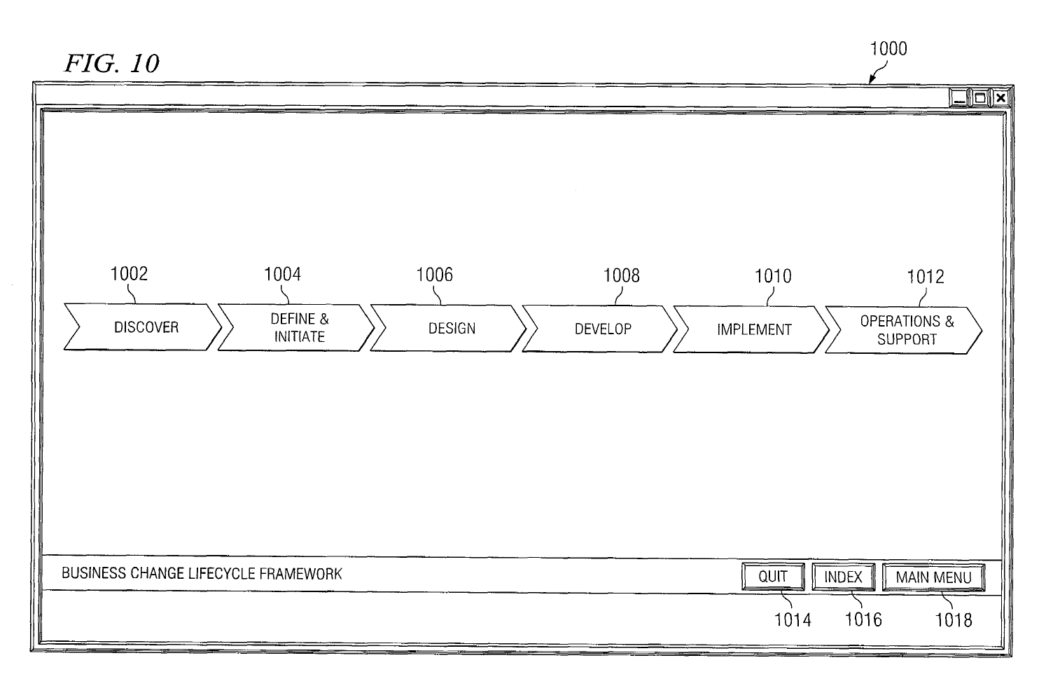

With reference now to FIG. 10, an exemplary Graphical User Interface (GUI) presented to a user upon selection of the stages icon 904 depicted in FIG. 9 is depicted in accordance with one embodiment of the present invention. GUI 1000 includes selection options 1002-1012 allowing a user to select from various stages in a BCL framework. In this embodiment, the options 1002-1012 include Discover 1002, Define and Initiate 1004, Design 1006, Develop 1008, Implement 1010, and Operations & Support 1012. GUI 1000 also includes selectable icons or buttons 1014-1018 that allow a user to quit, retrieve an index, or return to the main menu depicted in FIG. 9.

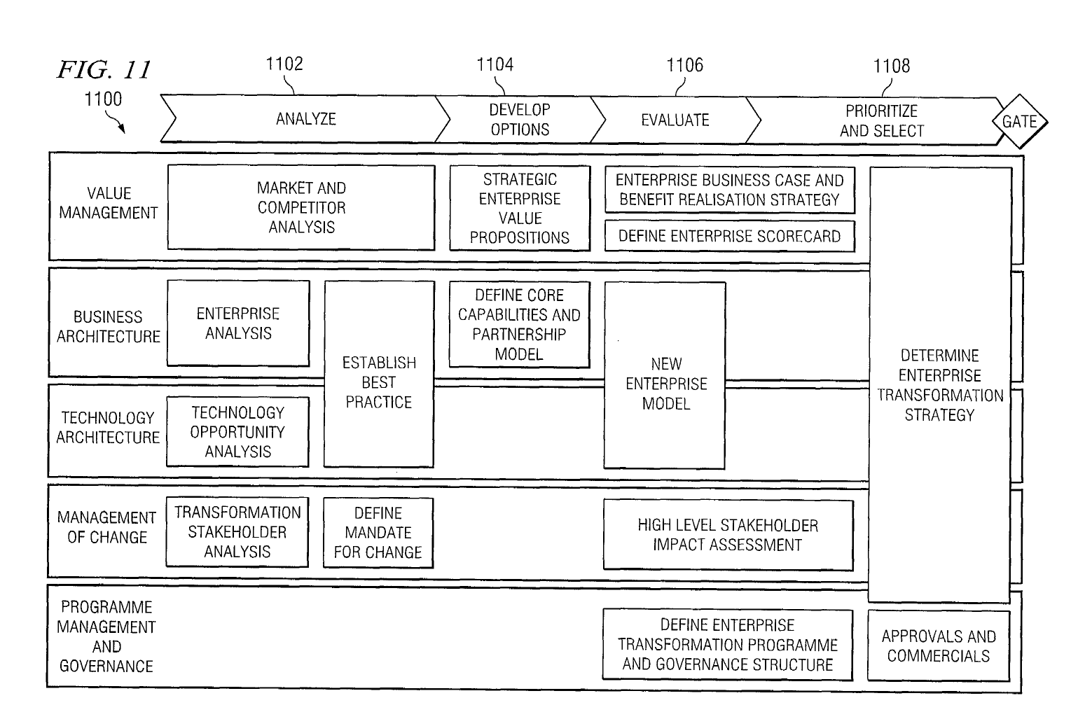

With reference now to FIG. 11, a block diagram illustrating an exemplary set of components for the Discovery Stage 1002 is depicted in accordance with one embodiment of the present invention. This set of components in block diagram 1100 for the Discovery Stage 1002 may be presented to the user in a manner similar to that depicted in FIG. 11 upon selection of the Discovery Stage 1002.

The Discover Stage 1002 of the BCL Framework addresses the needs of the enterprise. The IT/IS provider collaborates with clients' Executives (CEO/CFO/CIO/CTO levels) to scope and define the transformation program of work.

This Stage 1002 is subdivided into four Elements 1102-1108:

1. Analyze 1102—Obtain all the necessary information about the client's business and the current state of the enterprise from an internal and external perspective.

2. Develop Options 1104—Identify and develop potential business transformation options based on the analysis performed in the previous Element.

3. Evaluate 1106—Once the options are developed, evaluate them jointly with the client and determine their suitability for IT enabled business transformation.

4. Prioritize and Select 1108—Prioritize the options according to the benefits they bring to the enterprise and consider all other relevant factors. Create the initial, high-level business case for the chosen options and review with the client for approval.

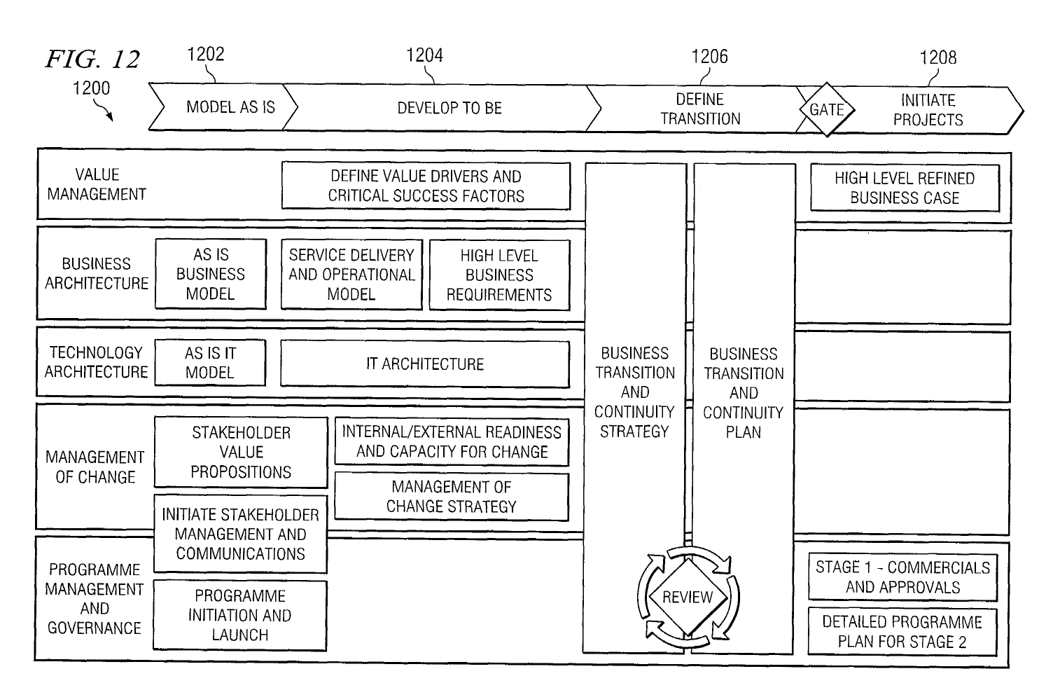

With reference now to FIG. 12, a block diagram illustrating an exemplary set of components for the Define and Initiate Stage 1004 is depicted in accordance with one embodiment of the present invention. This set of components in block diagram 1200 for the Define and Initiate Stage 1004 may be presented to the user in a manner similar to that depicted in FIG. 12 upon selection of the Define and Initiate Stage 1004.

The Define and Initiate Stage 1004 defines the required changes in more detail with the appropriate impact analysis. This ensures that the changes fit with the enterprise's strategic direction and that the organization has the need, willingness and ability to make the transition. These activities typically operate at the enterprise or program level, but focus on the detailed aspects and potential individual projects, within a program.

This Stage 1004 is subdivided into four Elements 1202-1208:

1. Model As Is 1202—Perform an in-depth analysis of the current enterprise, including the areas that may not be affected by the transformation.

2. Develop To Be 1204—Develop the model of what the enterprise will look like after the transformation.

3. Define Transition 1206—Define how the enterprise moves from the “As Is” state to the “To Be” state.

4. Initiate Projects 1208—Start the individual projects that are part of the overall enterprise transformation program.

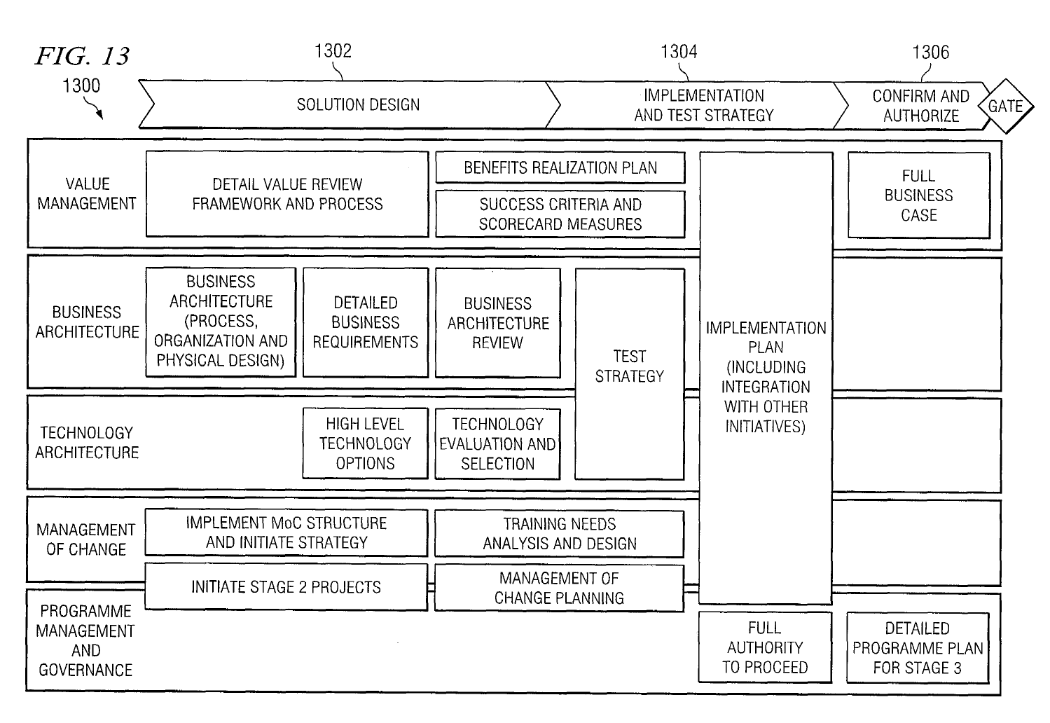

With reference now to FIG. 13, a block diagram illustrating an exemplary set of components for the Design Stage 1006 is depicted in accordance with one embodiment of the present invention. This set of components in block diagram 1200 for the Design Stage 1006 may be presented to the user in a manner similar to that depicted in FIG. 13 upon selection of the Define and Initiate Stage 1006.

The Design Stage 1006 activities involve analyzing potential options, designing solutions and collaborating on the implementation strategy. The enterprise transformation program usually consists of multiple design projects that are aligned with the strategic vision defined in Stages 1002 and 1004. The primary deliverables of this Stage 1006 are the components' blueprints for the “To Be” enterprise, as well as the detailed plans for their development and implementation.

This Stage 1006 is subdivided into three Elements 1302-1306:

1. Solution Design 1302—Define a full business and technology solution based upon the findings from the previous Stages 1002 and 1004.

2. Implementation and Test Strategy 1304—Formulate the strategy and plans for the development, implementation and testing of the proposed designs.

3. Confirm and Authorize 1306—Present a full business case to the client's executives and proceed only when granted a formal “authority to proceed”.

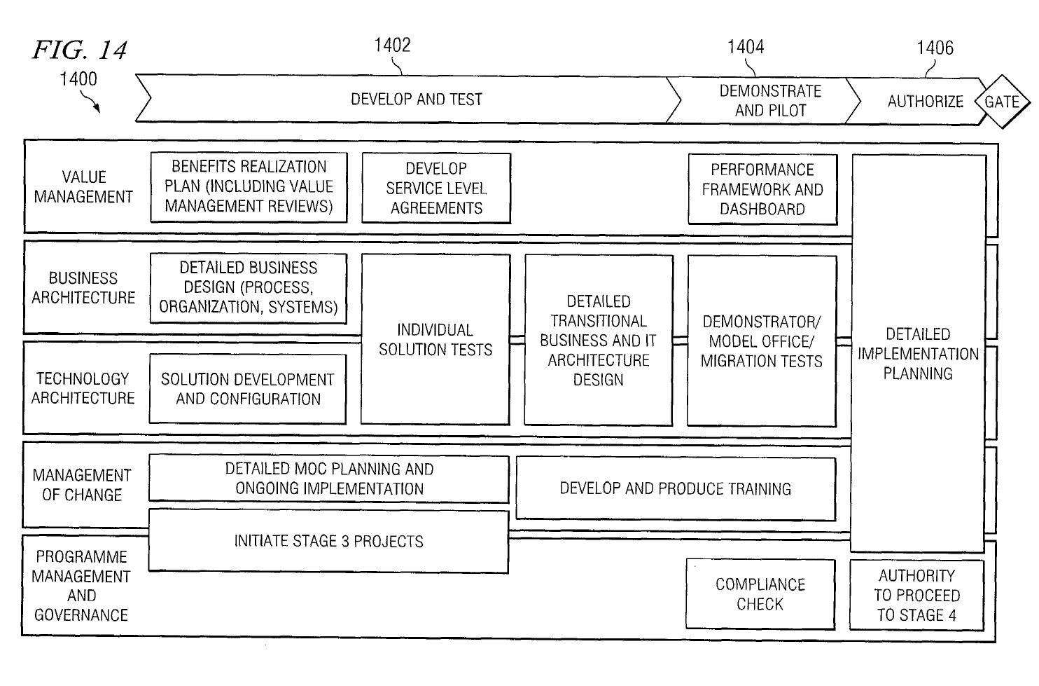

With reference now to FIG. 14, a block diagram illustrating an exemplary set of components for the Develop Stage 1008 is depicted in accordance with one embodiment of the present invention. This set of components in block diagram 1400 for the Develop Stage 1008 may be presented to the user in a manner similar to that depicted in FIG. 14 upon selection of the Develop Stage 1008.

Entering the Develop Stage 1008, the strategic direction has been defined and the vision has been designed, developed and finalized with the client's collaboration. With this preparation complete, development of the transformation solution can begin.

The development and testing of the solution occupies most of the effort during this Stage. The work includes preparing and collaborating on the detailed implementation plans and acceptance criteria. Block diagram 1400 depicts the Work Products as executed sequentially, but the work may often be performed iteratively in an effort to produce the optimal solution that meets all of the client's requirements. Furthermore, some Elements 1402-1406 of this Stage 1008 may need to be revisited several times throughout the lifecycle of the program.

This Stage 1008 is subdivided into three Elements 1402-1406:

1. Develop and Test 1402—Produce the solution components according to the design from Stage 2 and test the individual parts to ensure that they conform to the program objectives.

2. Demonstrate and Pilot 1404—Integrate all of the constituent components into the final solution and prove that it functions meet the client's requirements. The client's stakeholders should participate in the final phases of testing in preparation for its implementation.

3. Authorize 1406—This Element covers the development of the detailed implementation plans.

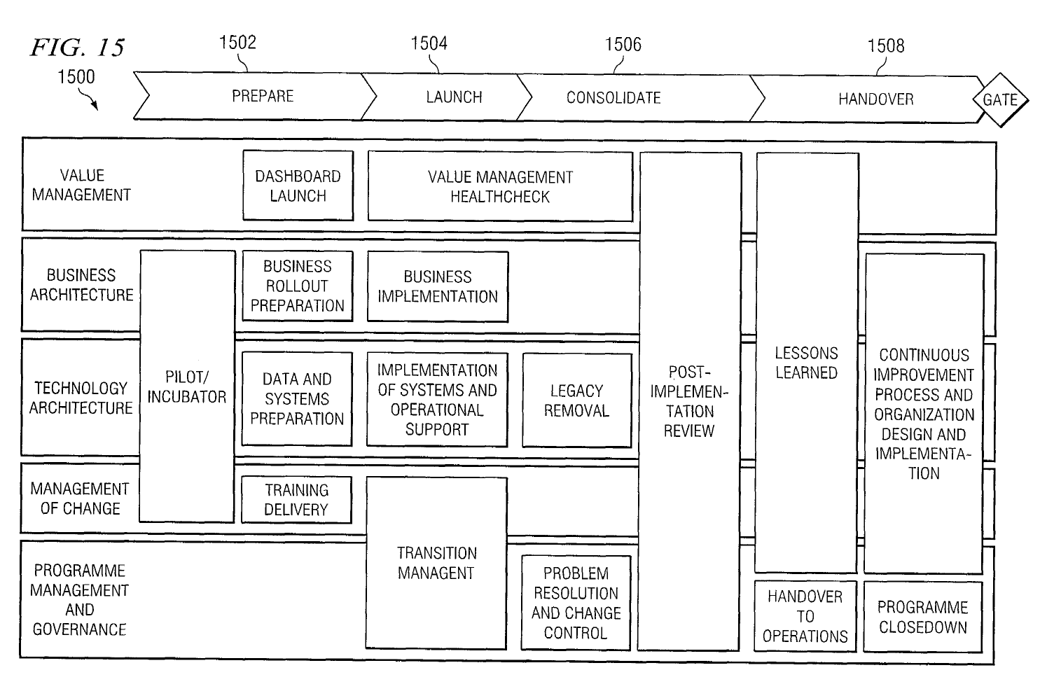

With reference now to FIG. 15, a block diagram illustrating an exemplary set of components for the Implement Stage 1010 is depicted in accordance with one embodiment of the present invention. This set of components in block diagram 1500 for the Implement Stage 1010 may be presented to the user in a manner similar to that depicted in FIG. 15 upon selection of the Implement Stage 1010.

During the Implement Stage 1010 the business transformation is realized; the enterprise is transformed and aligned with the strategic objectives and vision. This Stage 1010 often involves a great deal of intensive delivery work. This stage 1010 also includes the delivery of training, the migration of old to the new, the reorganization of the enterprise (if needed) and the preparation required to handover the solution to daily operations.

This Stage 1010 is subdivided into four Elements 1502-1508:

1. Prepare 1502—All preparatory work is completed and the organization is prepared for the launch of the transformation.

2. Launch 1504—This is the actual implementation of the solution and transformation of the enterprise from its ‘old state’ to the ‘new state’.

3. Consolidate 1506—This Element identifies and resolves any problems and issues uncovered during and following the launch.

4. Handover 1508—Includes the preparations to roll-out the solution into the production environment and handing over the day-to-day support to the responsible organization.

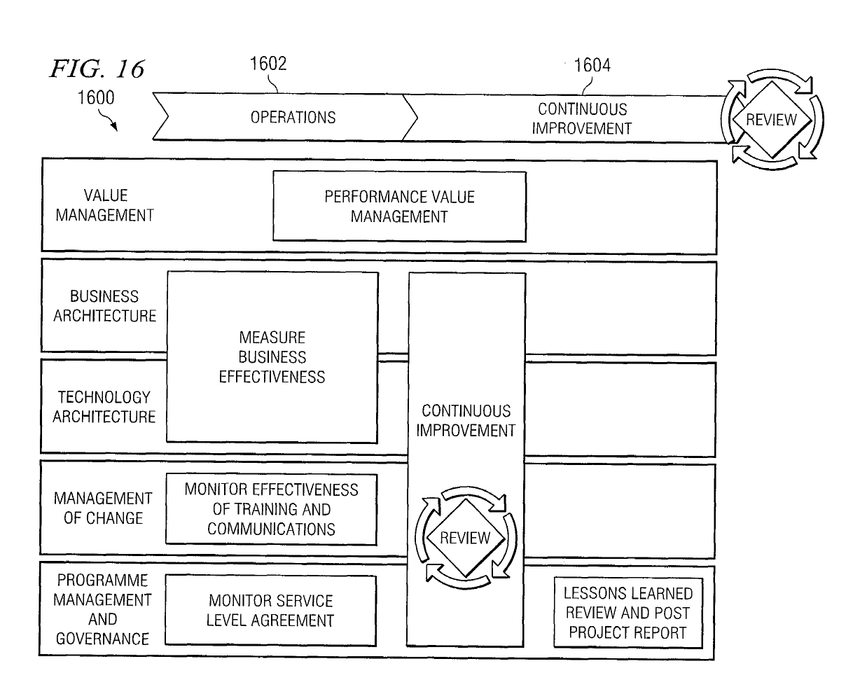

With reference now to FIG. 16, a block diagram illustrating an exemplary set of components for the Operate and Support Stage 1012 is depicted in accordance with one embodiment of the present invention. This set of components in block diagram 1600 for the Operate and Support Stage 1012 may be presented to the user in a manner similar to that depicted in FIG. 16 upon selection of the Operate and Support Stage 1012.

The Operate and Support Stage 1012 is a significant and important part of a transformation program and is critical to the overall success of the change. Failure to properly manage and control the new enterprise may undermine the benefits of the transformation and the organization may very quickly revert to the old practices.

This Stage 1012 is subdivided into two Elements 1602-1604:

1. Operations 1602—The day-to-day management of the enterprise.

2. Continuous Improvement 1604—Enterprise transformation does not end as changes continually occur and the enterprise searches for new ways of business optimization through increasing efficiency and reducing costs. The change lifecycle will start all over again.

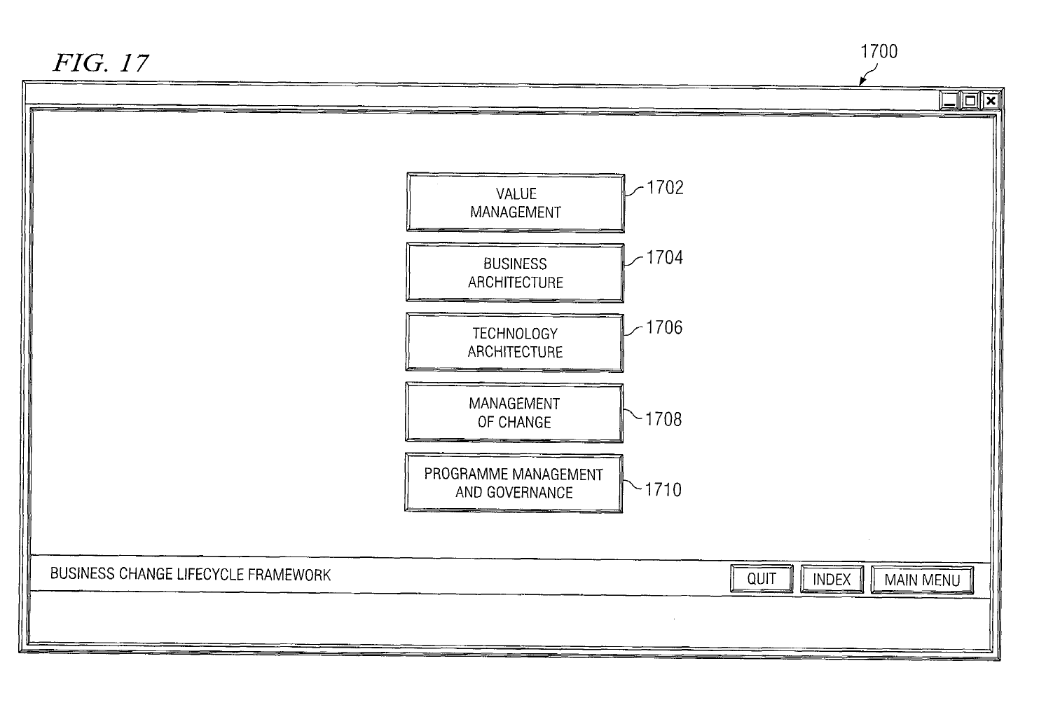

With reference now to FIG. 17, a pictorial diagram illustrating an exemplary display 1700 that may be presented to a user upon selection of the Strands area 906 in FIG. 9 is depicted in accordance with one embodiment of the present invention. The BCL Framework Strands are “dimensions of change” that group related activities and facilitate the management of all dependencies within a program in order to meet business objectives.

In order for a change program to succeed, it must address all transformation aspects and stakeholders. The BCL Framework manages various “dimensions of change” through five Strands (represented in FIG. 17 by Strand Selection buttons 1702-1710), which group the related activities, deliverables and stakeholders. The Strands 1702-1710 run across all of the Stages 1002-1012 and ensures that projects can properly address all inter-relationships and dependencies to complete the change lifecycle successfully.

By using Strands 1702-1710 to organize activities, an IT/IS provider is able to map its key capabilities and service delivery activities into client-focused functional groupings. Additionally, Strands 1702-1710 ensure that our clients recognize these activities as being important to enterprise transformation.

The composition of the various Strands 1702-1710 uses the practical experience gained through IT/IS provider engagements and ensures that they easily align with the way a typical client manages their business. As with the rest of the BCL Framework, the aim is to keep the approach as simple and jargon-free as possible. The five Strands 1702-1710, aligned to a typical client structure, allow an IT/IS provider to deliver the coverage needed without unnecessary complexity.

The Value Management Strand 1702 defines the activities associated with the assessment, monitoring and delivery of value and the management of risk. This value-driven approach underpins the BCL Framework, as it ensures that the required savings and benefits are defined early in the project so that all subsequent work can be focused on achieving the desired outcome.

Recent surveys indicate that 70% of major IT-enabled change programs are unable to prove that they had delivered the promised benefits. Of course, this does not necessarily mean that seven out of every ten projects failed. However, the lack of a clear audit trail between the desired outcome and the actually delivered results can only reduce senior management confidence in such projects. This research, demonstrates the importance of implementing and maintaining a transparent value management process.

Risk management is an important aspect of this Strand 1702. Change programs, by their very nature, are running in times of uncertainty or market challenge. A robust risk management approach is essential if the program is to remain on track.

The Business Architecture Strand 1704 addresses the activities associated with the definition, design and implementation of changes to the organization, processes, facilities, policies and regulations. This is an important Strand 1704 and should be managed with considerable care, as it covers many areas that may require long lead times or can cause a significant impact to business operations and employees.

A project may focus on the Business Process Re-engineering requirements, overlooking the wider aspects for this area of work. It is important to remember that it is of little use re-engineering a process unless the organization and facilities are re-aligned to support it effectively. The BCL Framework's emphasis on Value Management ensures that the gated reviews will highlight areas within the Business Architecture that will need to be changed in order to deliver the required benefits.

The Technology Architecture Strand 1706 addresses the definition, design and implementation of the technical infrastructure, applications and information (data) architecture. This work is at the very heart of an IT-enabled change program. However, to be successful, it is essential to examine this work in the context of the overall program objectives. The BCL Framework ensures this happens by defining the desired outcome of the project and then, via the gated reviews, continues to ensure that the technology aspects of the project remain tightly aligned with the overall project aims.

The Management of Change Strand 1708 addresses the activities associated with achieving the necessary behavioral and attitudinal changes across the organization and its extended network (customers and suppliers) to underpin the overall business transformation.

Many organizations (and their employees) are uncertain about change. Many projects fail because the right people are not involved, there is poor communication or there is inadequate training for the affected individuals. The BCL Framework defines an approach that ensures that all Strands are aware of the importance of the Management of Change and work together to give the “people” aspects the priority needed for successful delivery.

The Program Management and Governance Strand 1710 addresses all those activities, which ensure that the transformation program is managed in a way that delivers the required outcome. At its simplest, this ensures that all interested parties are aware of, and working according to a single, formally agreed program plan. This Strand 1710 goes well beyond merely a planning function. It addresses aspects such as defining the governance structure to ensure that there are clearly defined management and reporting processes so that funding is made available when it is needed and that there is a process in place to resolve the (often inevitable) disagreements arising during a change project. In practice, this Strand 1710 is the “glue” that ties the whole program together. It 1710 ensures that, however big the team, everyone has a clear view as to how his or her work is contributing to the overall success of the project.

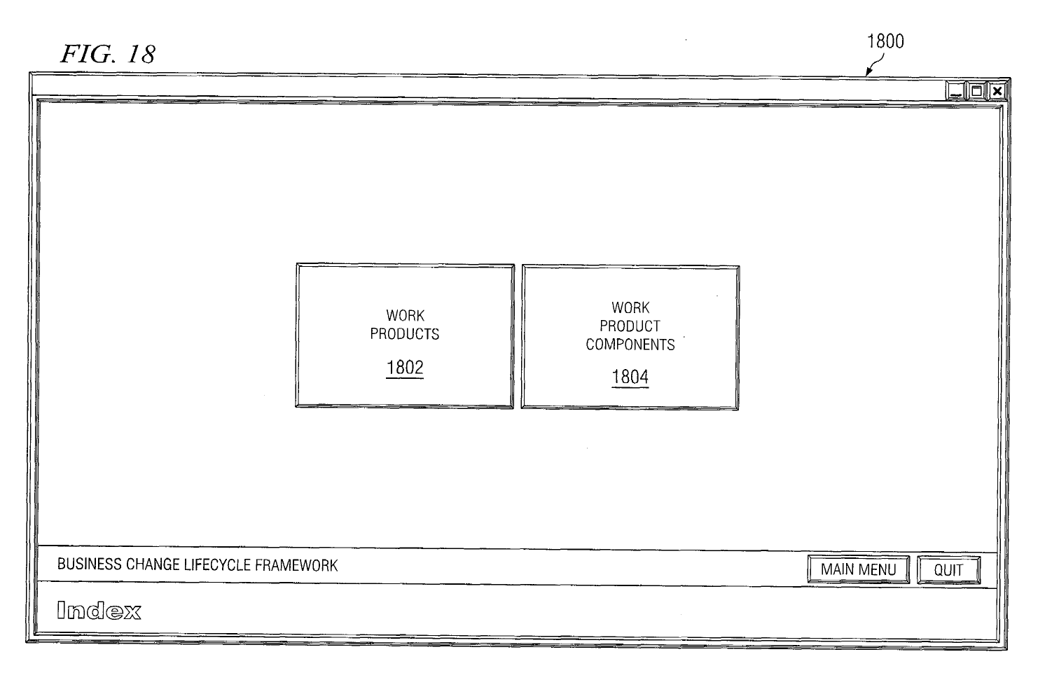

With reference now to FIG. 18, a pictorial diagram illustrating an exemplary display 1800 that may be presented to a user upon selection of the Index area 910 in FIG. 9 is depicted in accordance with one embodiment of the present invention. Each of the BCL Framework Work Products (represented by Work Product selectable icon 1802) and Work Product Components (represented by Work Product Components selectable icon 1804) is fully documented within its own stand-alone document. The BCL Framework CD-ROM contains an edited version of this information and will present a different level of detail, depending on the intended audience:

The marketing view (known as Level 3) includes the details for the BCL Framework Work Products, as well as overview information about all of the Work Product Components.

The practitioners' view (known as Level 4) provides fully comprehensive information about both the Work Products and Work Product Components. It also allows access to the BCL Framework collateral information, such as templates, examples, sample projects deliverables and links to up-to-date, secure online content.

The BCL Framework detailed content includes the following information for each Work Product Component 1804:

1. Workproduct—Identifies where the Work Product Component fits within the overall BCL Framework structure, indicating the appropriate Strand, Stage and Work Product.

2. Component Description—Describes the component and explains how it should be used.

3. Activities to Produce This Component—Details the constituent activities and tasks that should be completed to produce the component deliverables and achieve the client value.

4. Inputs From—Lists the BCL Framework Work Product Components that provide input to this component.

5. Outputs To—Lists the BCL Framework Work Product Components that require or would benefit from this component's deliverables.

6. Roles/Skills Involved—Identifies the skills and expertise needed to complete the work addressed by this component. Where appropriate, the BCL Framework may identify the required roles or provide relevant job descriptions (without referring to specific posts, organizations or individual practitioners).

7. Tools—Lists any templates, example deliverables, corporate tools or best practices that are recommended or may be helpful to complete the work involved.

8. Other References—Identifies any additional sources of detailed information, such as books, articles, web sites and so forth.

9. Quality Exit Checkpoints—Lists the evaluation criteria and any metrics that may help to determine whether the component activities have been completed successfully.

10. Hints and Tips—Offers any additional guidance and particularly any specific lessons learned that may be of help to the BCL Framework practitioners.

11. Why Is This Component Needed—Identifies the circumstances where this Work Product Component may be applicable and lists some common criteria that justify its use.

12. What Are the Risks of Not Doing It—Looks at the risks and potential consequences if a project does not properly complete the work covered by this Work Product Component.

In one embodiment, the BCL Framework identifies and catalogues the information using a Stage-based numbering system.

The BCL Framework Stages, in one embodiment, are numbered as follows: TABLE-US-00001 0 Discover 1 Define and Initiate 2 Design 3 Develop 4 Implement 5 Operate and Support.

Work Product identifiers are in the format WP/xx/yy where: TABLE-US-00002 WP Indicates a Work Product xx Is the Stage number yy Is the Work Product sequence number within the Stage.

Work Product Component identifiers are in the format CO/xx/yy/zz where: TABLE-US-00003 CO Indicates a Work Product Component xx Is the Stage number yy Is the Work Product sequence number within the Stage zz Is the Work Product Component sequence number.

The BCL Framework may contain collateral information to support a Work Product or a Work Product Component. These items have an identifier starting with the related Work Product or Work Product Component identifier followed by: TABLE-US-00004 SC Indicates a supporting collateral xx Sequence number within the Work Product or Work Product Component.

Example: CO/00/03/04/SC02 identifies the second item of supporting collateral for the fourth Work Product Component that is a part of the third Work Product within Stage 0 (Discovery).

Note, that in this embodiment, all sequence numbers have at least two digits.

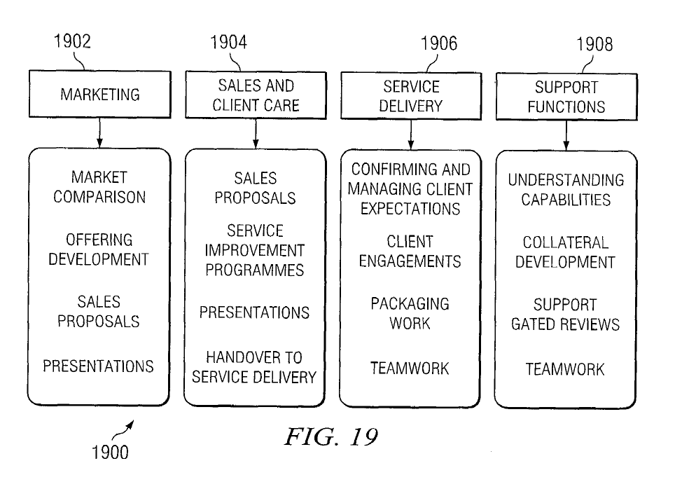

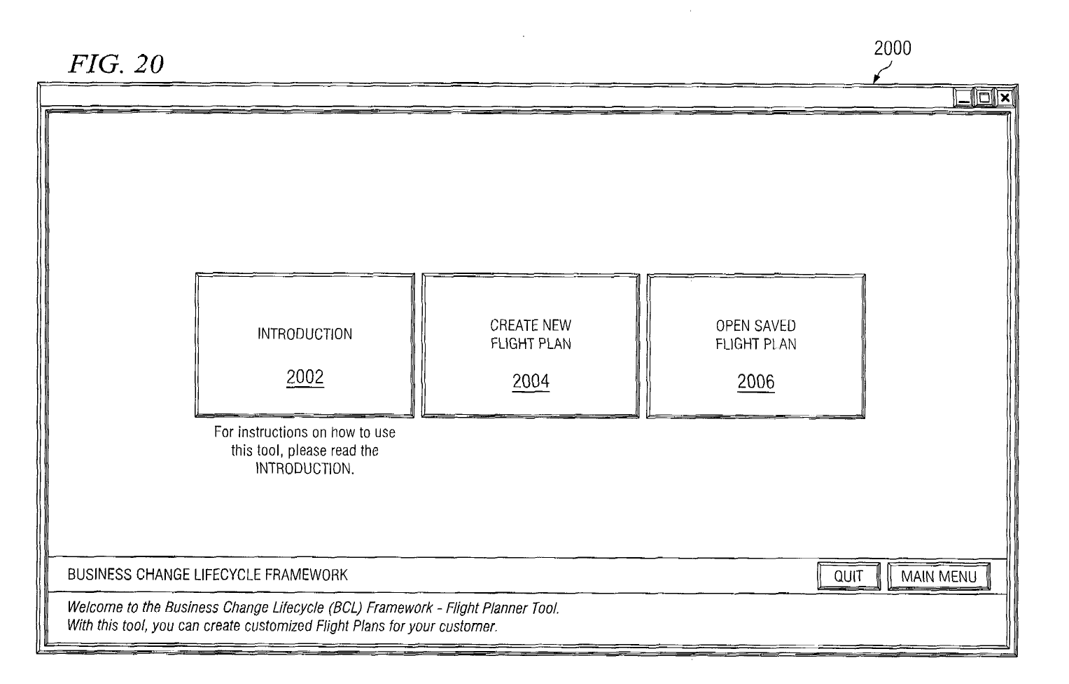

With reference now to FIG. 19, a pictorial diagram illustrating exemplary ways in which the BCL Framework may be utilized by differing groups of people is depicted in accordance with one embodiment of the present invention. Specifically, diagram 1900 illustrates potential uses by four groups of individuals identified by their job roles: Marketing 1902, Sales and Client Care 1904, Service Delivery 1906, and Support Functions 1908.

The BCL Framework's main aim is to assist an IT/IS provider's client engagements and should prove valuable across the overall IT/IS organization and much wider user community.

This section, with reference to FIG. 19, identifies how various aspects of the BCL Framework could be applied to assist in performing the relevant tasks within key business areas and by a broader spectrum of roles.

The BCL Framework will endeavor to address typical organization challenges within all key business areas: Marketing 1902, Sales and Client Care 1904, Service Delivery 1906, and Support Functions 1908, as depicted in FIG. 19.

The BCL Framework enables the Marketing 1902 team to perform a review and analysis of the client's private sector competitors and/or public sector peers in their particular market space. For example, the Marketing 1902 team could benefit from the deliverables of the Work Product Component “Market and Competitor Analysis”. The BCL Framework is adaptive to Marketing's needs, as it can support how to cover the market dynamics in terms of size, demographic customer grouping, finances, entry requirements, trends, risks, issues and competitors.

The BCL Framework can also support the marketing 1902 activities during marketing and business development by assisting with specifics, such as identifying competitors (for market comparison), peer improvement activities, supporting the client's own SWOT analysis, market offering development, marketing proposals and presentations.

The BCL Framework enables the Sales 1904 team to take the information from the “Market and Competitor Analysis” component and establish the strategic intent of the transformation. It can also support the development of innovative propositions for change and verify that goals are realistic and attainable given the marketplace and current enterprise maturity.

The BCL Framework can help define the factors that could determine the success of the transformation program. This can be achieved, for example, by using the BCL Framework to develop and evaluate options. These options can support the sales and client care approach with the customer, in the areas cost, risk and benefit measures and existing management systems (both automated and manual).

The BCL Framework can also support the sales 1904 activities with the preparation of proposals, service improvement programs, presentations and the handover of responsibility to service delivery groups.

The BCL Framework supports the Service Delivery 1906 team to define and design the future client organization in terms of the organizational design, business processes, IT, facilities and relationships with customers, suppliers and employees.

The BCL Framework can support the development of a holistic approach to a customer change program, including the ‘future state’ of the customer organization, often including customer experience, changed business processes, tasks, behaviors, IT and facilities. The BCL Framework will help to define a program of work, combining input from several perspectives, describing the impact on the client organization at specific service levels.

The BCL Framework will assist Service Delivery groups in confirming and managing client expectations, client engagements, packaging work and developing client-specific change programs.

The BCL Framework can assist the Operational Support 1908 team to identify the key operational support activities required to maintain a system once it is in production or under maintenance. As a supporting framework, it can also assist with understanding capabilities, developing collateral, supporting gated reviews and facilitating teamwork.

With reference now to FIG. 20, a pictorial diagram illustrating an exemplary user Flight Plan Menu display 2000 that may be presented to a user upon selection of the Flight Plan area 908 in FIG. 9 is depicted in accordance with one embodiment of the present invention.

The BCL Flight Planner is an online tool, available, for example, a network such as distributed data processing system 100 depicted in FIG. 1, that enables an IT/IS provider to develop client or offering specific, electronic “flight plans” which illustrate how the BCL Framework can be deployed. In addition to the Online Flight Planner, flight plans can be created in, for example, PowerPoint or Word format using predefined templates. Both the BCL PowerPoint and Word Flight Plan templates are stored in the BCL Framework CD. PowerPoint® and Word are products and trademarks and/or registered trademarks of Microsoft Corporation of Redmond, Wash.

The BCL Flight Planner tool associated with menu 2000 has multiple uses and benefits. It can support and enhance: Sales-related discussions with the client. It is an invaluable way of reinforcing the message that the IT/IS provider has the capability to deliver end-to-end lifecycle transformation solutions. Program planning phases. The tool 2000 can assist with the identification of activities, facilitate assignment of activity responsibility and plan activity completion deadline dates.

Program monitoring. For instance, the tool's color assignment functionality can be used to illustrate completed, in progress and outstanding activity.

Development of new service offerings, which encompass the entire lifecycle of the transformation and not merely the technical elements of the offering.

After program completion, the Flight Planner can facilitate the identification of lessons learned and improvement actions. For instance, reviews of the actual program flight plan using the color functionality may reveal gaps in activity, inconsistency in activity ownership or lack of stakeholder involvement.

To access the BCL Flight Planner tool, select the Flight Planner option 908 in the Main Menu 900 of the BCL Framework depicted in FIG. 9.

Click on Introduction 2002 to view information and detailed instructions on how to use the Flight Planner tool. Click on any introduction segments or Next to view further information.

Click on the Flight Planner Menu button to return to the main Flight Planner menu 2000.

To create a new flight plan, click on the Create New Flight Plan menu option 2004.

The tool will prompt the user to enter a net id when the Flight Planner is opened for the first time.

Click on Continue to proceed.

This information will facilitate tracking of flight plan owners after they have been distributed.

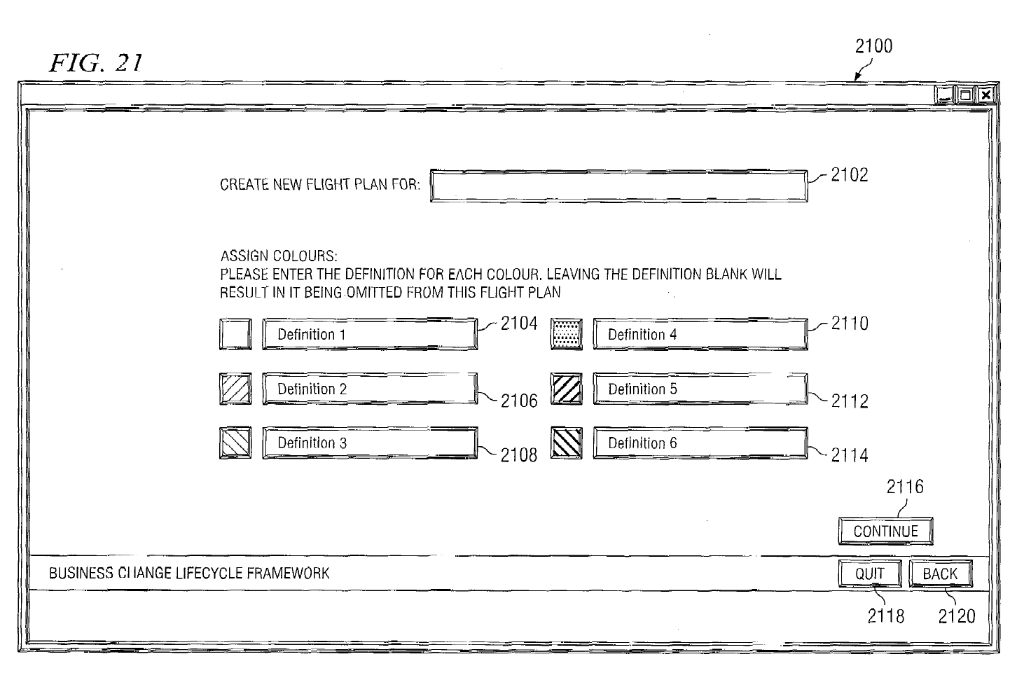

With reference now to FIG. 21, a pictorial diagram illustrating an exemplary graphical user interface presented to a user top facilitate the creation of a flight plan by the user is depicted in accordance with one embodiment of the present invention.

Enter the flight plan name into the first field 2102 in this screen 2100.

If the name already exists, a window will appear prompting the user to either Cancel or Open the existing Flight Plan.

Open will retrieve the existing Flight Plan.

Cancel will return the user to the Create New Flight Plan screen 2100.

Once a unique flight plan name is entered, the user is directed to the assign color options 2104-2114.

Up to six different colors (as illustrated in the screen 2100 depicted in FIG. 21) can be used to reflect specific information about a highlighted Work Products in the flight plan.

The following table illustrates the different ways in which BCL practitioners can use these color options. TABLE-US-00005 Different colors can by assigned to reflect: Work Product Activity Status: Importance: Stakeholder input: Activity Core Critical complete Activity in Optional Optional progress Activity not Out of Scope Not required started Work Product Work Product Dashboard: Owner: Completion Date: Work on EDS Q1 2005 target (Green) Client Q2 2005 Work EDS & Client Q3 2005 behind target Partner No. 1 Q4 2005 (Amber) No progress Partner No. 2 made (Red)

Enter a definition for the number of colors required. If only one color is required, enter one definition.

Click on the Continue button 2116 to proceed to the BCL Flight Planner. Click on the quit button 2118 to quit the creation of a new flight plan and click on the back button 2120 to return to the previous screen 2000.

The following are examples of features that can be included in some embodiments of a BCL framework and accessed for each Stage:

Hover over a Work Product to view a description

Click on a Work Product to select it. If the color assignment option has been selected, continue to click on the Work Product until the appropriate color appears.

Click on a selected Work Product to deselect it. If the color functionality is being used, continue to click on the Work Product until the original color returns.

Move to the next Stage by clicking the Next button (at the bottom of the page).

Move to any Stage by clicking that Stage arrow (at the top of the page).

To print the flight plan, select the Print button (select the landscape mode in the print dialog box for best output). To view colored Work Products, print the flight plan on a color printer.

To copy a flight plan screen into a document, select Print Screen on the computer and copy into Word or PowerPoint. For best results, copy the screen print into the MS Paint Program, crop the screen as required before inserting into Word or PowerPoint.

Work Products selected in each BCL Stage are automatically saved in the flight plan once selected. Note the Flight Planner has the functionality to store multiple flight plans.

On completion of the flight plan, close the application.

If the application is closed and opened again, the following options are available in some embodiments:

Select Create New Flight Plan to create another flight plan.

Select Saved Flight Plans to view a created flight plan. Scroll down through the drop down list illustrated to select the correct flight plan.

To open an existing flight plan:

Select Saved Flight Plan to view all flight plans created.

Scroll down through the list to identify the correct flight plan. All created flight plans are illustrated on screen with the following details (filename, date created, last date modified).

Once the flight plan is selected from the list, click on Open.

The selected flight plan will be retrieved to the screen.

Revise and edit the retrieved flight plan as required.

To delete a flight plan:

Select Saved Flight Plans to view all saved flight plans. Scroll down through the list to select the correct flight plan.

Once the flight plan is selected from the list, click on delete.

The selected flight plan will be deleted from the tool.

Flight plans can be shared electronically between BCL Framework Practitioners by following the steps outlined below.

Note: IN some embodiments, the user may need to Save an electronic version of the BCL Framework from the user's CD to the user's local hard drive, before attempting to use the following functionality. To do this, create a BCL folder on the user's hard-drive. Then, select all of the BCL Framework folders in the CD, and copy to a local hard-drive in the newly created BCL folder.

Exporting Saved Flight Plans

To export a created flight plan from the BCL Flight planner tool, select the relevant flight plan and click on Export in the Open Save Flight Plan screen.

To export all Flight Plans, leave all flight plans unselected and click Export.

When Export is selected, a ‘browse for folder’ window will appear.

Select the folder into which the flight plan is to be saved and click OK. This folder location can be located in any data storage media. The Flight Plan(s) will be moved to this folder.

Once the flight plan(s) have been exported, a confirmation screen will appear displaying the number of files exported.

Click the Back button on this screen to return to the Open Save Flight Plan Screen.

The exported flight plan can be identified in the designated folder because it will have the following characteristics: The net id of the original flight plan creator will appear at the front of the flight plan file name, with the extension ‘.sol’.

Notify the relevant BCL practitioner of the exported flight plan folder location to enable them to import it into their tool.

Importing Saved Flight Plans:

Receive a notification from a fellow BCL practitioner where an exported BCL flight plan has been saved.

Locate and save the flight plan to a specific folder on the user' local hard drive. Note the location.

To add the received flight plan to the BCL Flight Planner tool, click on Import in the Open Saved Flight Plan screen.

On selection of this button, a ‘browse for folder’ window will appear.

Select the folder location in which the received flight plan has been saved and click OK. If a flight plan already exists in the framework, the user will be prompted whether the user wishes to replace this file.

Once the saved flight plan has been imported, a confirmation screen will display how many files were exported.

Click the Back button to restart the BCL Framework.

The imported flight plan now appears in the saved flight plans log. All imported flight plans will contain the net id of the original creator in their file name Open, review and edit as required.

For presentation purposes, flight plans can be transferred, for example, to an MS PowerPoint version of the BCL Framework. This template may available on the BCL Framework CD in {folder name}. The template can be revised as required by using the shading option within the relevant Work Products.

BCL Flight Planner—MS Word or other Word processor version may be used to generate more detailed content once the high level PowerPoint or electronic flight plan has been created. The BCL Flight Planner MS Word template recommends that the following information is collated for each Work Product selected:

Stage

Stand

Work Product

Need: Identify which of the selected Work Products can be classified as mandatory, value adding or optional within the context of this flight plan.

Ownership: Identify which group will be involved with this Work Product. For example, in the case of EDS, this may be any of the following: TABLE-US-00006 Diamond—CSE, SE—Sales CE, CDE, CIE Enablement CS—Consulting AD—Apps Services Delivery BPO—Business PM—Program Process Ops Management.

Using the RACI ownership framework identify which of the identified groups should be responsible, accountable, consulted, and or informed for each selected Work Product.

R=Responsible—People who will actually do the tasks associated with the activity.

A=Accountable—One, and only one, of the Rs is designated as the A. This person will serve as the point of contact and often as the task coordinator for the group of Rs.

C=Consulted—The Cs do not do the task or activity, but have information, ideas, and resources that may be of assistance. They should be consulted before starting an activity or reviewed during the activity, so their input can be leveraged.

I=Informed—People who need or want to be informed as to the status of the activity, perhaps by being included on an e-mail update list. An I may be the R for another upcoming activity that is dependent on this one.

Work Product Description: Document a high level description of what specific activities will be completed in each Work Product. The BCL Framework Work Product description should be used as the starting point for creating this description.

To aid in understanding the present invention, consider this Flight Planner Case Study which helps to illustrate how to apply the BCL Framework to address typical business challenges during a client engagement opportunity. This case study also demonstrates how different components of the BCL Framework could be used to assist an IT/IS provider project team during an assignment.

The client is a UK Government organization that supports people to find jobs, and assists employers to fill Job Vacancies, and provide additional services and support functions for people of working age.

The organization was formed when a number of Government agencies and bodies amalgamated. It is now a part of one of the largest UK Government departments.

This client has over 1,100 offices and a number of call cent centers throughout the UK.

For years, this organization distributed and displayed job vacancies on physical printed cards, which were arranged on various job-boards across the UK. Job seekers would browse these boards to find job-postings for suitable work opportunities.

This was limited in a number of ways:

There was not always enough room to display all of the cards.

It was difficult for job seekers to sort through all of the cards to find a suitable opportunity.

It took considerable time and effort to update the boards manually.

In an attempt to provide improved services to job seekers, the client organization undertook a reviewed its existing processes and operations to identify ways of improving its services. Following this review, the organization agreed to initiate a transformation program to deploy touch screen kiosks, and to replace the existing display boards and cards in all of its existing job-seeker's offices.

The organization commissioned an IT/IS provider to assist in the design and implementation of this solution.

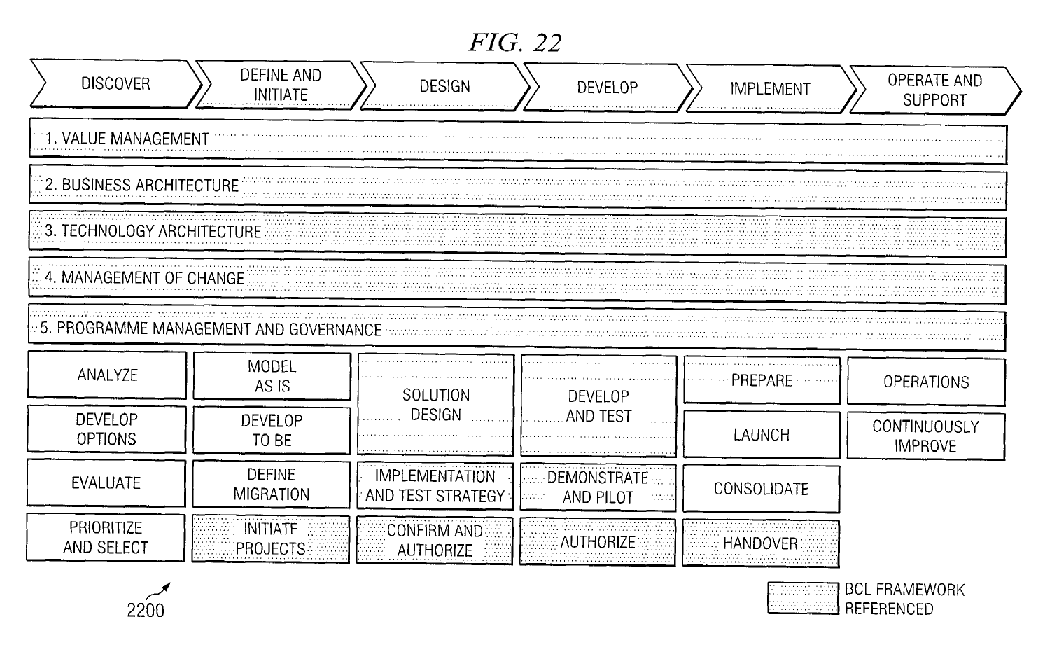

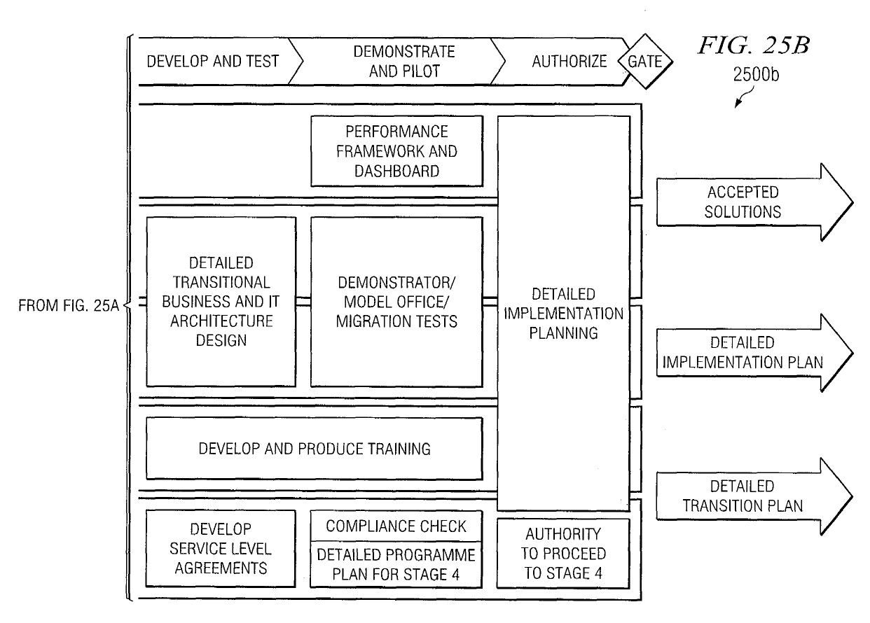

With reference now to FIGS. 22-26, diagrams 2200, 2300, 2400, 2500, 2600 illustrate an exemplary BCL framework and its use to aid the hypothetical client are depicted in accordance with one embodiment of the present invention in order to aid in understanding how the BCL framework can be applied to solving the hypothetical client's problems.

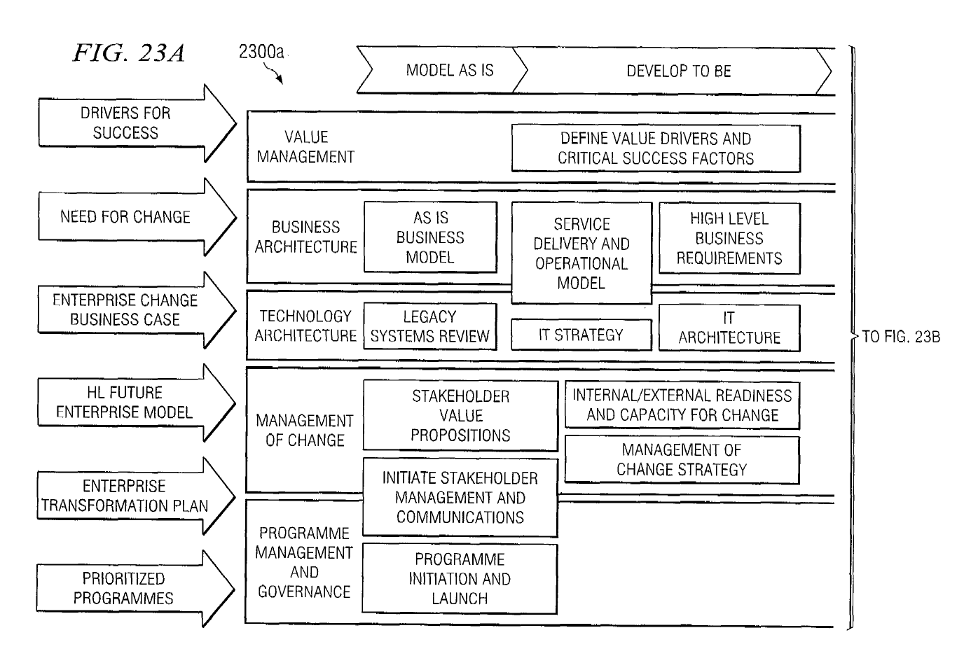

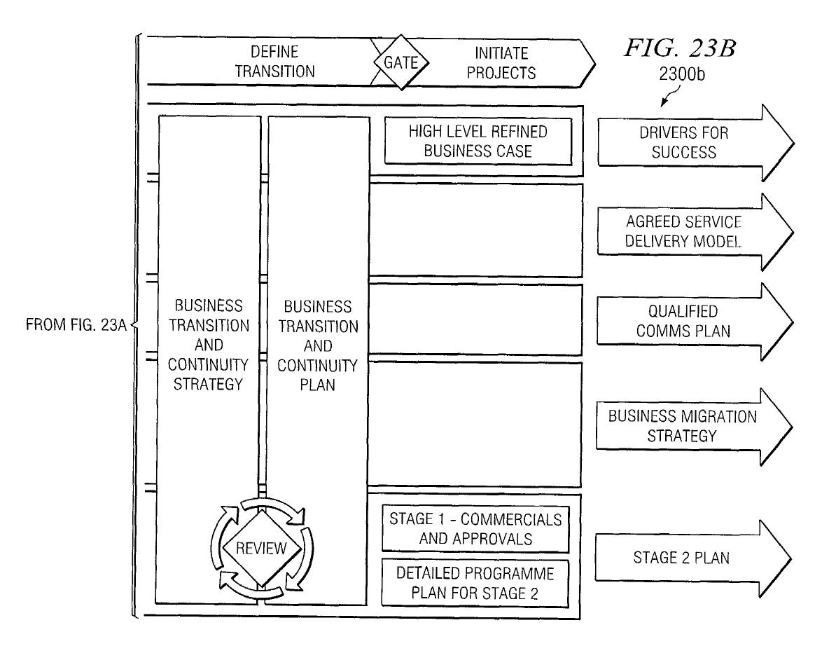

Initiate Projects Element (Refer to FIG. 23)

Work Product 01/14: High Level Refined Business Case

During the Discover and Define & Initiate Stages, the client produced a detailed business case. At the start of this project, the IT/IS provider team reassessed this business case to validate the strategic fit of the proposed solution, the estimated costs for the development and the anticipated business benefits that the IT/IS provider were expected to deliver from this change program.

In completing this activity, the project team leveraged existing financial data sources to maximize efficiency.

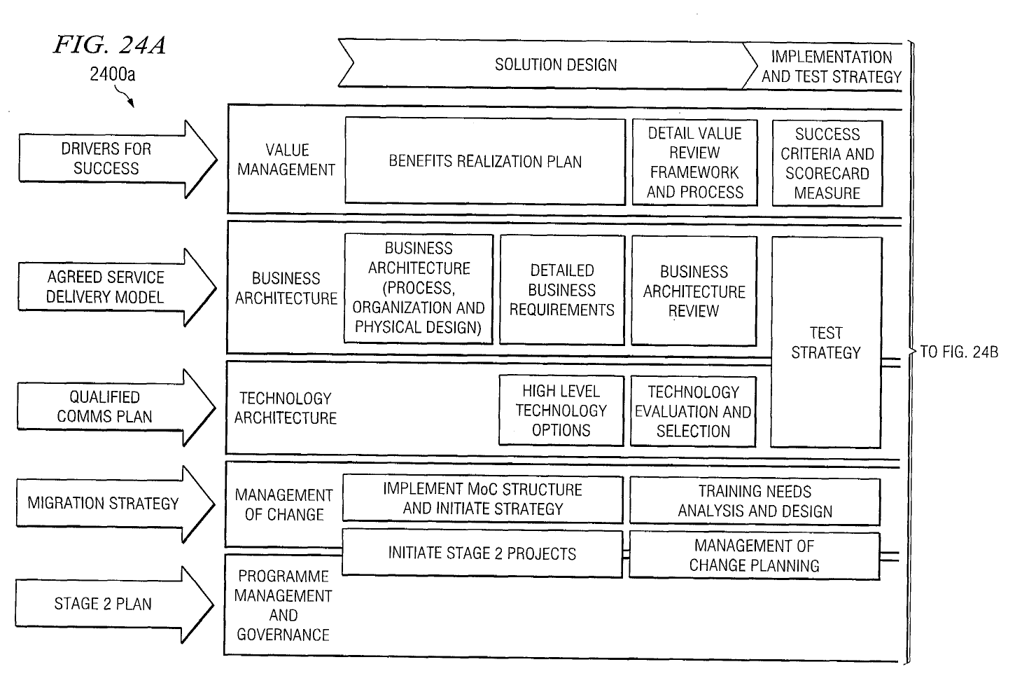

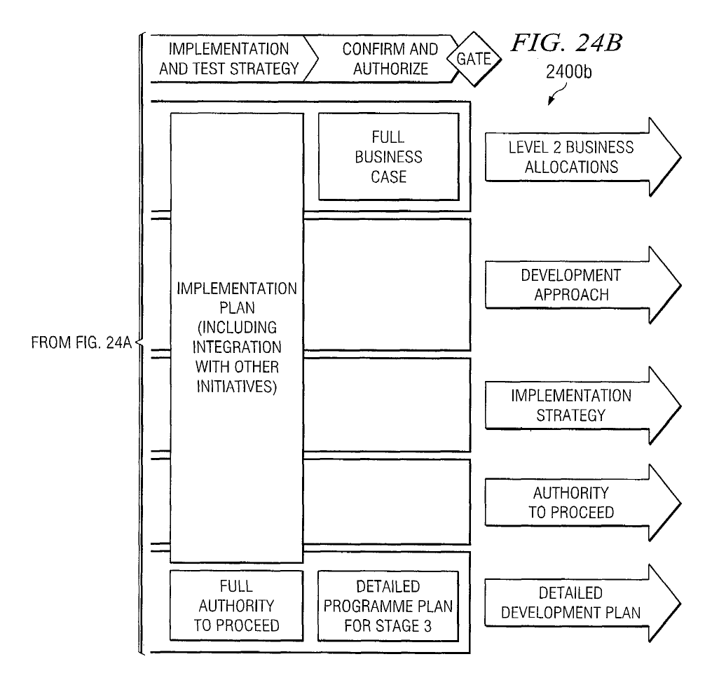

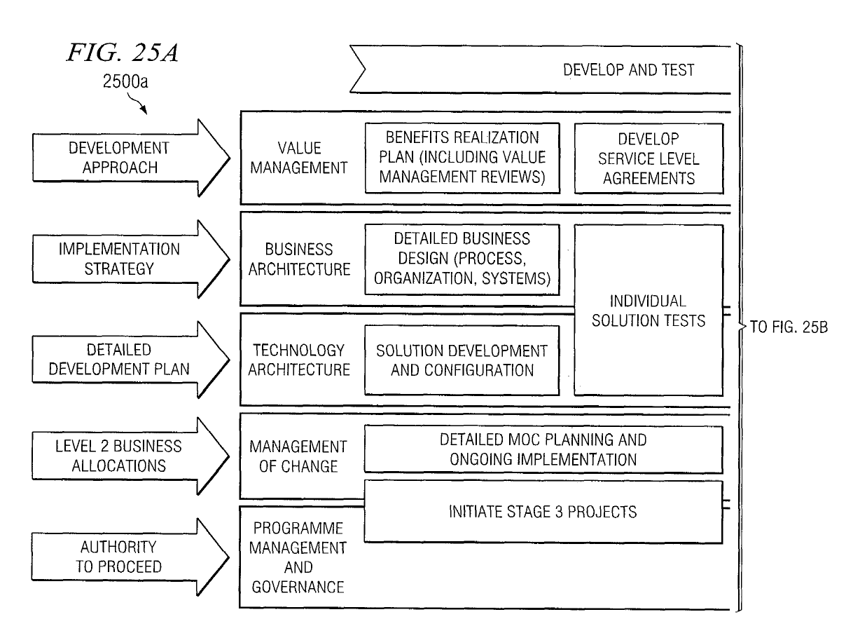

Solution Design Element (Refer to FIG. 24)

Work Product 02/04: Detailed Business Requirements

As suggested by the BCL Framework, the project team documented the client's business requirements in detail. This work was built upon the previous work completed during the Discover and Define Stage and Initiate Stage that originally identified high-level business requirements. In completing this activity, IT/IS provider addressed the following issue: the end users of this solution are predominantly the “general public” and not the client's employees.

Work Product 02/06: High Level Technology Options

The project team produced a high-level solution design, which addressed the identified detailed business requirements.

Significant investment was put into the design of the user interface to ensure that the system was intuitive, easy-to-use and effective. Rather than deploying a standard Web site interface, the IT/IS team proposed an interface design and structured information map tailored for a touch screen, and aimed at the unique user population.

Work Product 02/07: Technology Evaluation and Selection

Although the high-level solution design has been defined, the IT/IS provider team developed and presented a pilot version of the solution to the client to ensure it was aligned with the requirements, before proceeding any further into the program. The advantages of this activity are as follows:

Opportunity for the client to see the solution EDS proposes to implement and buy into it.

Opportunity to identify any further requirements before starting the actual build.

Obtaining stakeholders' involvement and commitment.

Reducing the risk of implementing a solution that would later require additional development.

A major output is the detailed report with the analysis, costs and benefits associated with this solution.

Work Product 02/09: Management of Change Planning

The BCL Framework highlighted the importance of addressing change issues as early as possible in the project lifecycle. As this project was a “front end” solution, the IT/IS provider built on previous stakeholder analyses to develop detailed transition plans for the various stakeholders (client staff and public users).

A key focus of this activity is the definition of detailed migration plans outlining how to transition the “general public” users from the previous bulletin boards experience to the new touch screens experience. In order to obtain feedback and encourage support for the change, IT/IS provider held workshops throughout the UK to pilot solution to the public.

Implementation and Test Strategy Element

Work Product 02/12: Success Criteria and Scorecard Measures

Before proceeding to the next phase, EDS needed to clarify and work with the client to define the criteria for measuring the successful delivery of the solution. This activity involved the definition of Key Performance Indicators and agreement as to how they will be measured.

EDS implemented the balanced scorecard method of performance evaluation. The BCL Framework illustrates how the output from this activity fed directly into the full business case.

Work Product 02/14: Implementation Strategy and Plan

Based on work completed to date, EDS developed an implementation strategy and high-level plan for the entire program that became subject to further iterations and elaboration in subsequent Stages. This plan covered all activities that are needed to achieve the benefits anticipated from the program.

Confirm and Authorize Element

Work Product 02/15: Full Business Case

Building on the outputs produced from the previous activities (such as success measures, detailed business and IT requirements) the EDS team presented the Full Business Case to the client for review and approval. This document detailed the final evaluation of solution fit, costs, benefits and delivery risks.

Work Product 02/16: Full Authority to Proceed

This is an important step in the governance process of the project and allowed for any further clarifications of outstanding issues or concerns. The Client's Executive Group endorsed the program and officially authorized EDS to proceed on the basis of what was contained in the business case. At this point, the team and the client also finalized any contractual agreements and other business arrangements.

Work Product 02/17: Detailed Program Plan for Stage 3

Once the client approved the full Business Case, EDS created a high-level program schedule for the next Stage, Develop. This documentation outlined all constituent projects, the schedules showing project start and end dates, key milestones, the required resources, system test dates, go/no go decision points, communications with key stakeholders (internal and external), and any externally imposed deadlines.

Develop and Test Element

Work Product 03/01: Benefits Realization Plan

The IT/IS provider built upon the existing realization plan to structure the actions necessary to realize the identified benefits across the organization. The two main factors the team had to address were the impact of this solution on the organization's headcount and potential improvements in service levels.

Work Product 03/02: Develop Service Level Agreements

The IT/IS provider defined the Service Level Agreements (SLA) and validated them against the Business and IT Architectures to ensure they were measurable and achievable. SLAs were developed in collaboration with the client to ensure they provided the expected business benefits.

Work Product 03/03: Detailed Business Design

The project team looked at facilities design. The new solution required changes to the existing physical environment, such as removing bulletin boards and replacing with touch screens. Working with external partners, the IT/IS provider developed an ergonomic design that allowed for differences in height and wheelchair access.

Although the solution is “front-end” focused (the public being the end user) it still required changes to the job roles and responsibilities going forward. Therefore, the project team needed to define the detailed business organization design requirements to enable the client organization to operate effectively in the future model of operations.

Work Product 03/04: Solution Development and Configuration

In parallel with the above activity, the IT/IS provider completed the following tasks:

Detailed design—Created detailed technical design blueprints for systems and applications (development, test, model office, production).

System development—Built hardware and software components.

Technical infrastructure—Phased build and installation of the IT infrastructure (systems, networks, applications, databases).

Work Product 03/05: User Acceptance Testing

The final test of the business and technology architecture solution ensures the proposed solution meets the requirements of the client. Given that the ‘end-users’ were members of the public, this proved a challenged for the IT/IS provider project team, when they looked at conducting end-user testing. As a result, the project team held a series of workshops, conference room pilots, and one-on-one assessments to ensure that the look and feel, usability and general system design satisfied the agreed requirements. Usability was an important component to the change program, which required extensive testing. The testing needed to ensure that the system met the demands of the ‘public’ user community.

Demonstrate and Pilot Element

Work Product 03/11: Model Office Test

At this point in the project, the project team carried out detailed tests of the touch screen solution to ensure it worked effectively and all aspects of the transformation have been accounted for. User experience pilot and testing, model office testing and operations acceptance testing are all completed at this point in the project.

Authorize Element

Work Product 03/15: Authority to Proceed to Stage 4

A gated review is a critical component of any assignment. In this case, a major review was held at the end of the development phase. Progression to the Implementation stage required significant funding and this gated review provided the following checks:

Ensure the client is satisfied with the solution and identify any amendments.

Resolve any implementation risks.

Get the approval to proceed.

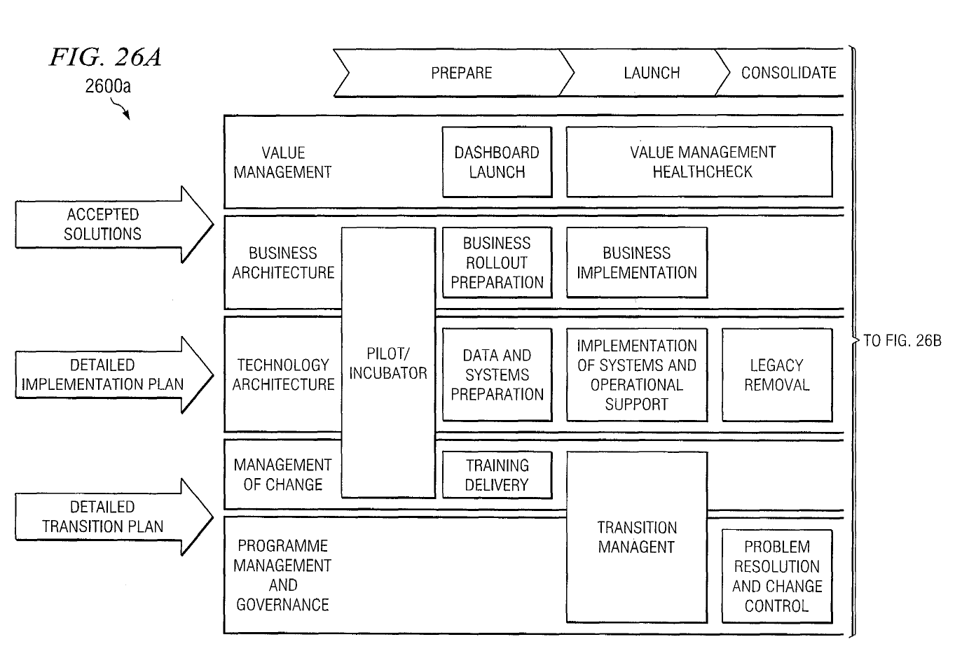

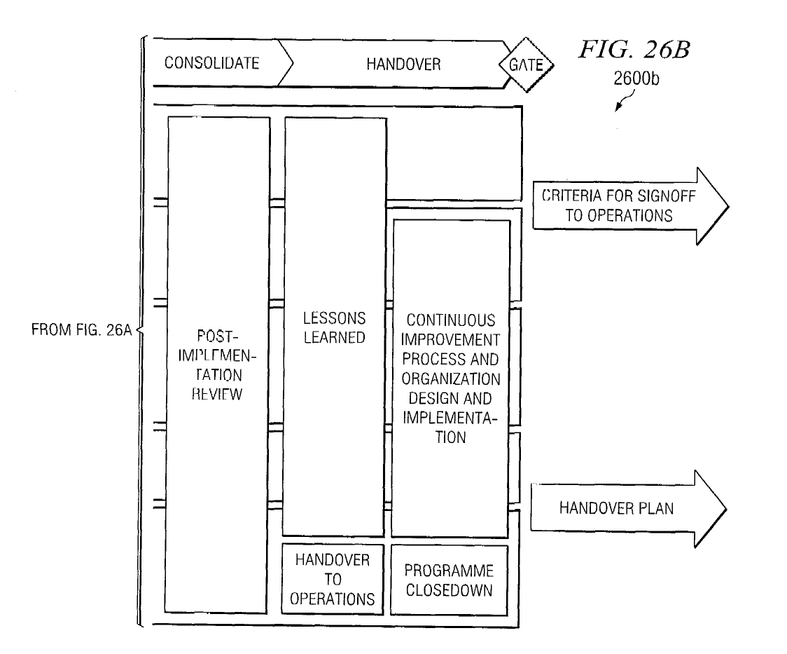

Re-confirm the success criteria. Prepare (Refer to FIG. 26)

Work Products were used as a reference.

Launch Element

Work Product 04/07: Business Implementation

Once the client gives the authorization to proceed, the EDS team developed the detailed business implementation plans. This work took place in parallel with Systems and Operations Support Development. The types of activities addressed included implementation of all agreed processes and procedures, and management of modifications to the work environments.

Consolidate Element

Work Products were used as a reference.

Handover Element

Work Product 04/14: Lessons Learned

Lessons learned exercise towards the end of implementation was used to identify any improvements that could be made before closing-down the project. In this case, there was a limited rollout of the solution to determine whether the solution works effectively. The output from this exercise fed into the lesson learned analysis to identify what went well and what could have been improved. This activity confirmed that the product delivery assumptions made in the design were correct and supported the continuous improvement process approach. After completing any modifications arising from this activity, the solution was given the green light to proceed to full operation.

Work Product 04/16: Handover to Operations

During this activity the responsibility for the new processes and systems, and for further benefits realization, was handed over from IT/IS provider to the client organization. This was done in accordance with the acceptance criteria and post-handover support arrangements as defined in the Transition Plan.

A formal Handover Plan was finalized and agreed. This specified the criteria and arrangements for the program to transfer formal responsibility for the changed business processes and systems to the client. The IT/IS provider ensured that all actions are carried out to meet the criteria for formal handover and allowed the program to be closed down.

Work Product 04/17: Program Closedown

The IT/IS provider team agreed with the executive sponsors that the criteria for closing down the program were met. Program documentation was archived, any formal contracts were finalized and the Program Management Team and support functions were disbanded.

Thus, the BCL Framework aims to assist in planning, managing and delivering business transformation programs and projects. Among other benefits, the BCL Framework is practical, pragmatic, and results driven; based on best practices; modular and adaptive to client needs; fully integrated; links business objectives to all deliverables; supports marketing and business development; supports skills transfer internally and to an IT/IS provider's clients; leverages existing intellectual capital within an IT/IS provider; and is structured for intellectual capital and knowledge management capture, development and dissemination.

In order to provide these benefits, the BCL Framework should, in some embodiments, achieve and maintain at least some of the following characteristics:

Practical and Pragmatic

The BCL Framework is linked to real business objectives and focused on achieving value for clients. It includes comprehensive, yet simple and effective (tried and tested) tools such as plans, checklists, spreadsheets, diagrams and so forth.

Comprehensive, Consistent and Integrated

The BCL Framework processes and tools provide the full coverage of all business transformation activities (“top to bottom”) and across the full lifecycle (“cradle to grave”). It helps remove any ambiguities, omissions, duplication or overlaps by proper integration of constituent methodologies.

Modular and Adaptable

The BCL Framework is based on identified/existing best practices and EDS′ capabilities. It provides clarity and control for enhancing the underlying methodologies in line with a clear strategic vision. The BCL Framework also remains adaptable to the widest possible range of clients and engagements.

Generic

The BCL Framework's aim is not to target any specific type of business transformation, but instead to provide a broad set of properly documented and flexible tools that can fit any client or change program. The BCL Framework can also be adapted to any new trends in an industry that is constantly changing.

Easy to Use

The BCL Framework includes a structure to help intellectual capital development and knowledge management, as well as providing easy access for sharing of best practice and improved learning.

Thus, a salesperson can use the BCL framework in a presentation mode to guide the discussion with executives of a client as to what problems need to be addressed. The BCL framework ensures that all aspects of Business change or discussed and that nothing is overlooked. Furthermore, because members of the project team that implement the solutions that the sales people agreed upon with the client also utilize the BCL framework to see what things need to be implemented, a consistent terminology is enforced across the IT/IS provider thereby ensuring that the client receives the products and services that the client believed it contracted for.

Although the present invention has been describe primarily in terms of IT and IS providers, the present invention is not limited to such entities, but may be applied, for example, by any business internally or by a business process outsourcing entity. Also, it should be noted that the BCL process is structured such that one need not be an engineer or technologies in order to utilize the invention. The BCL process may be utilized, and in many instances, will be utilized primarily, by non-technologically savvy individuals, such as, for example, sales persons.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

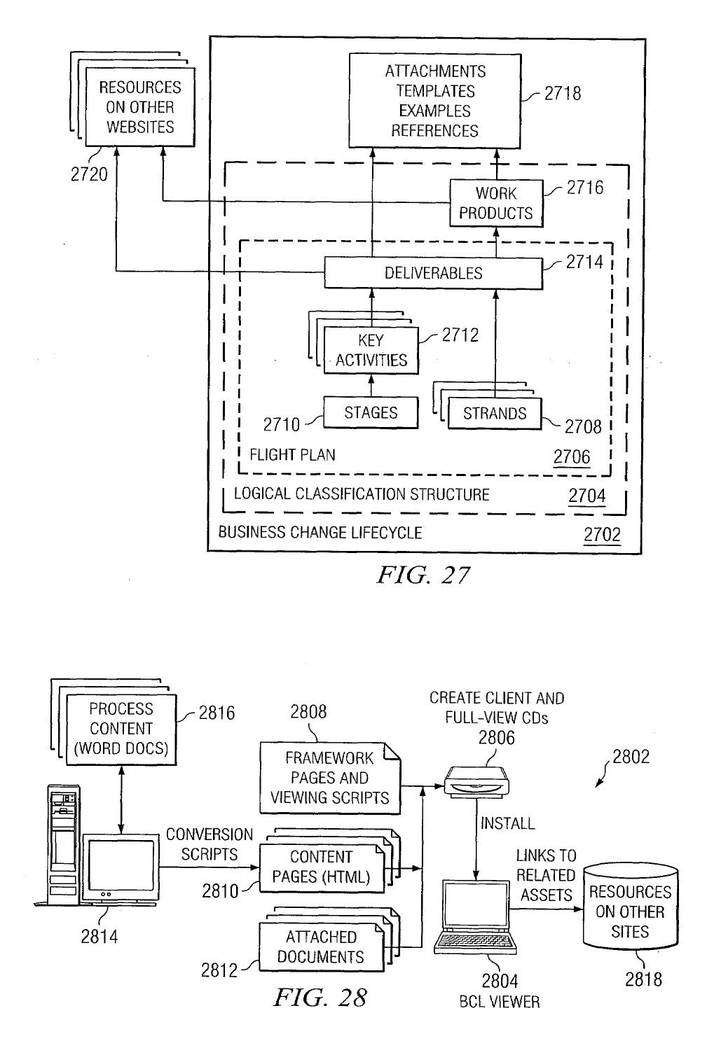

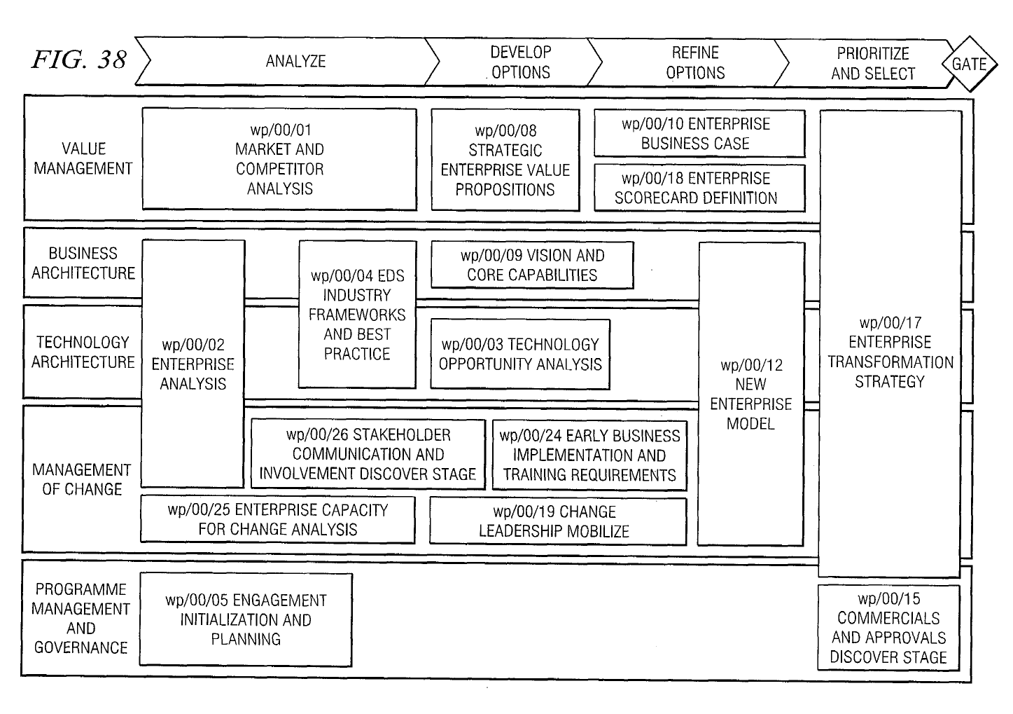

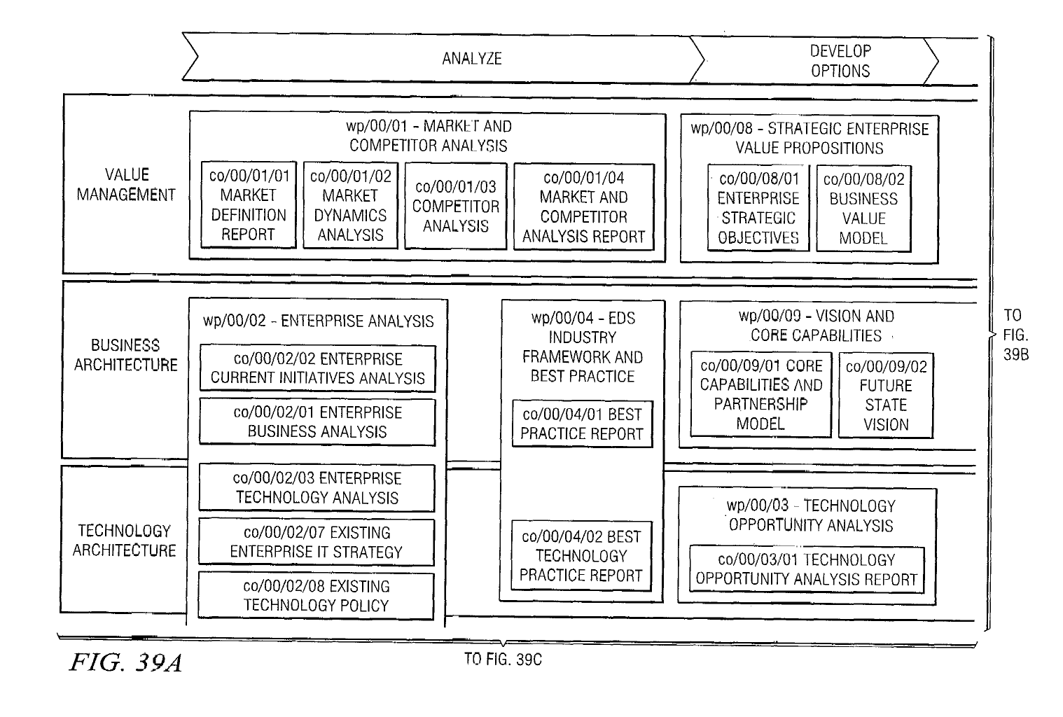

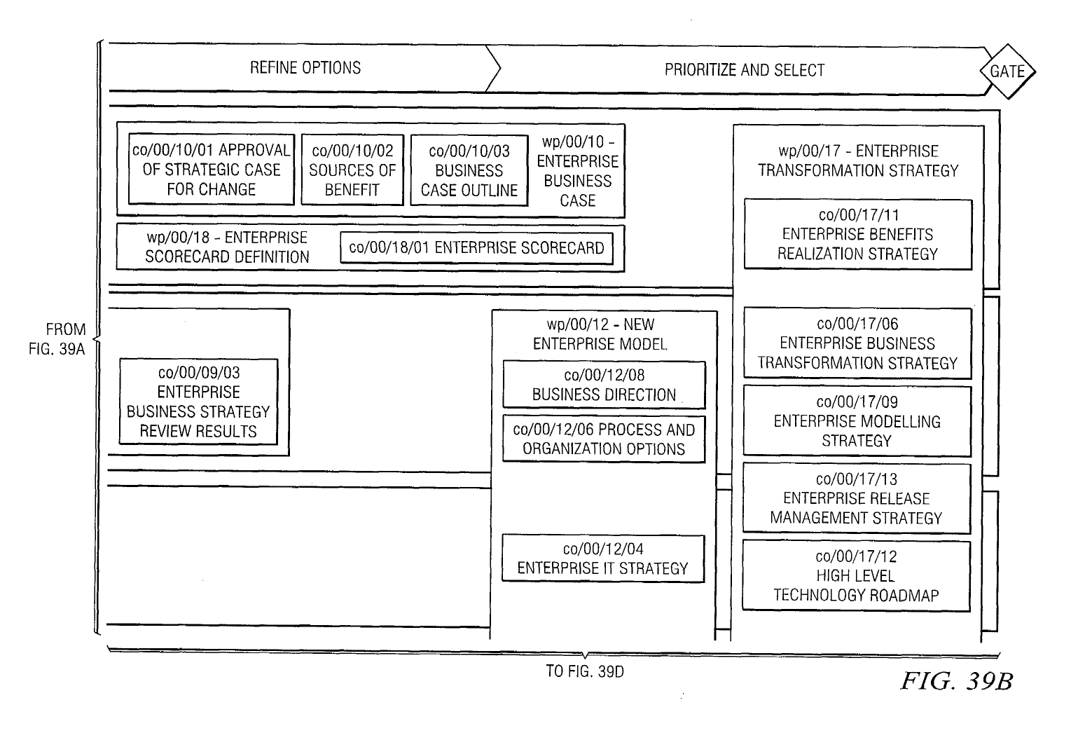

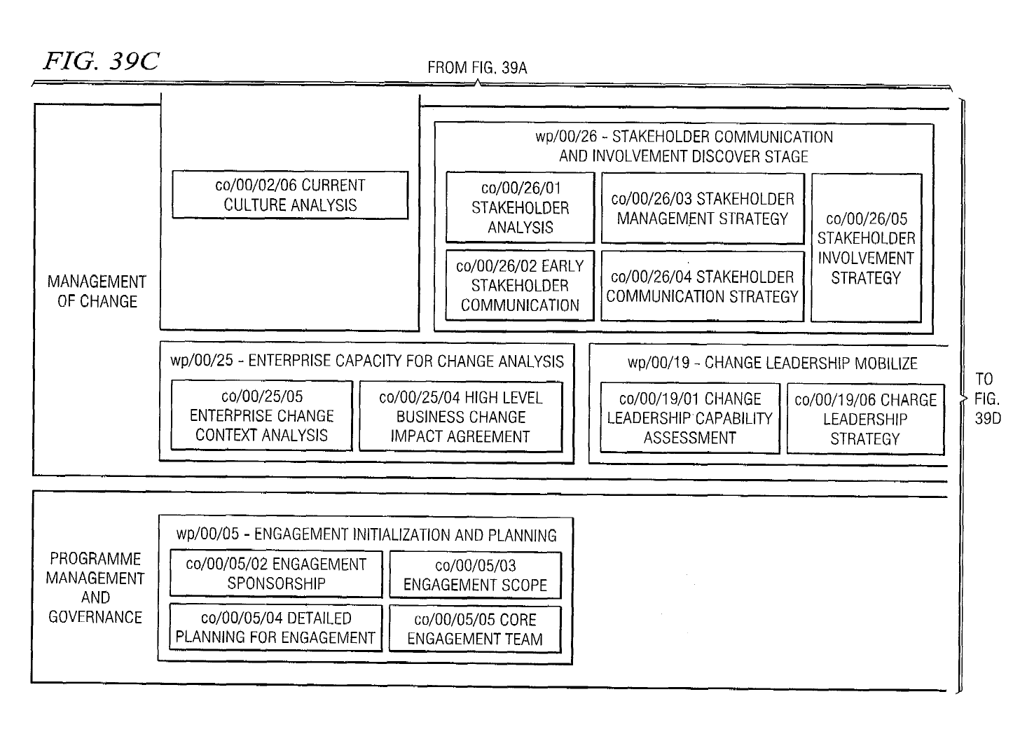

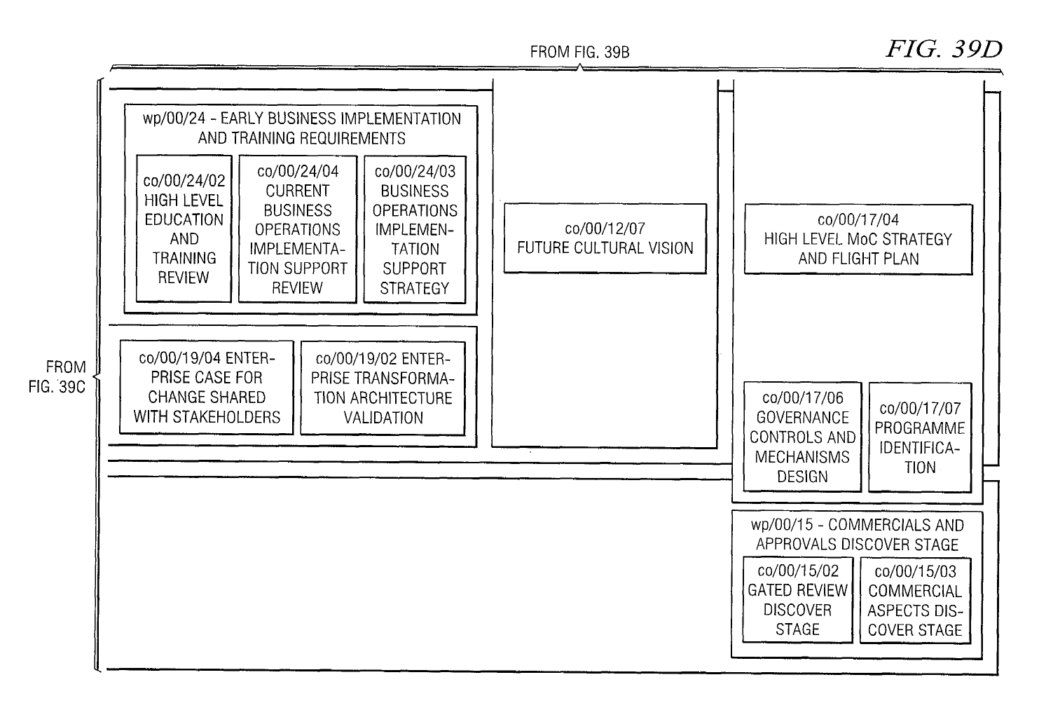

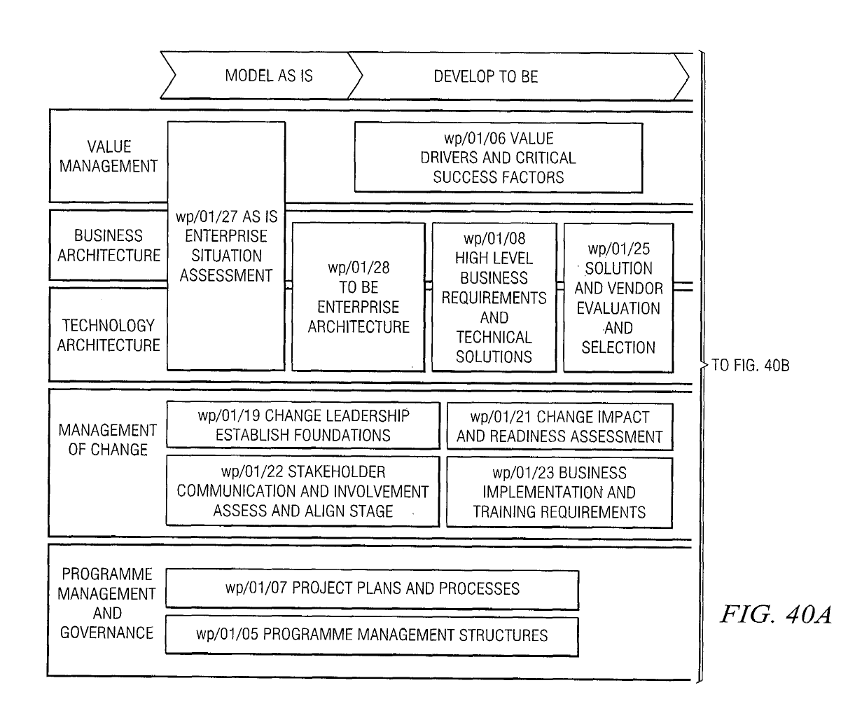

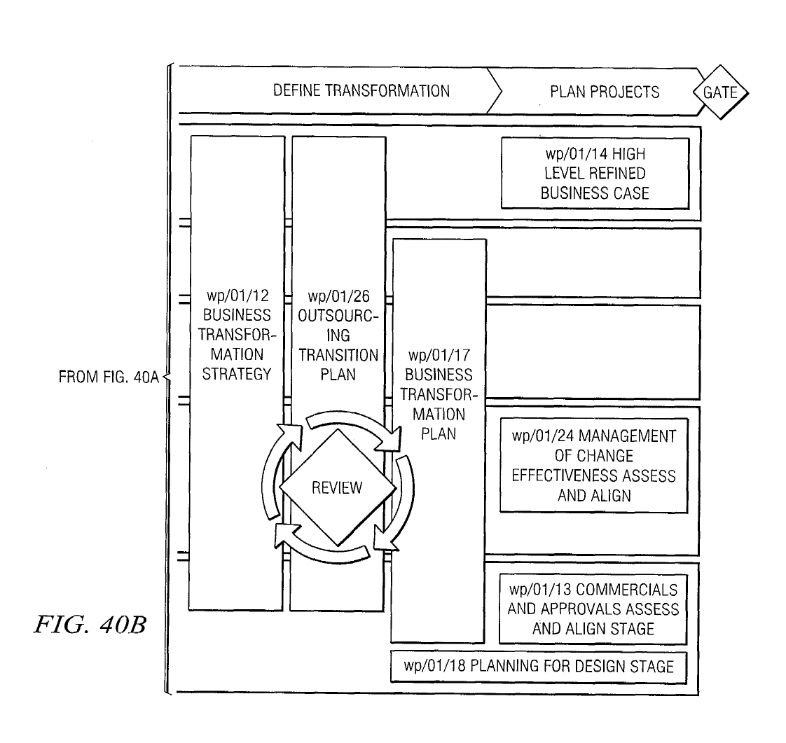

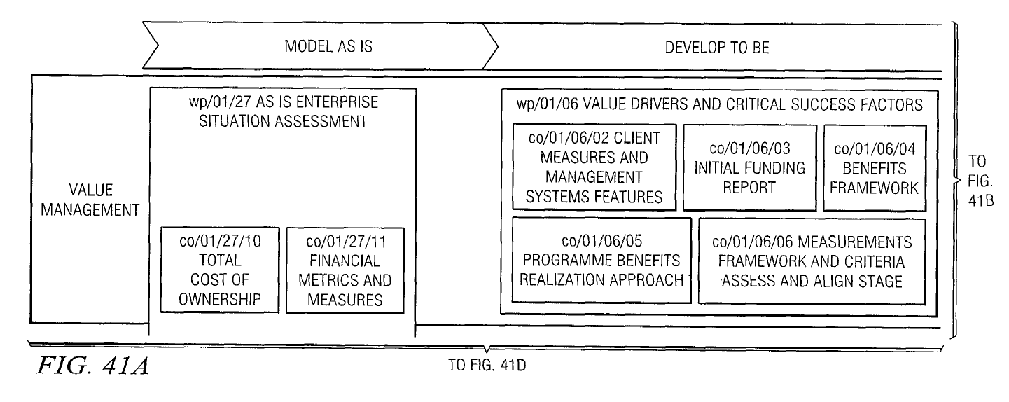

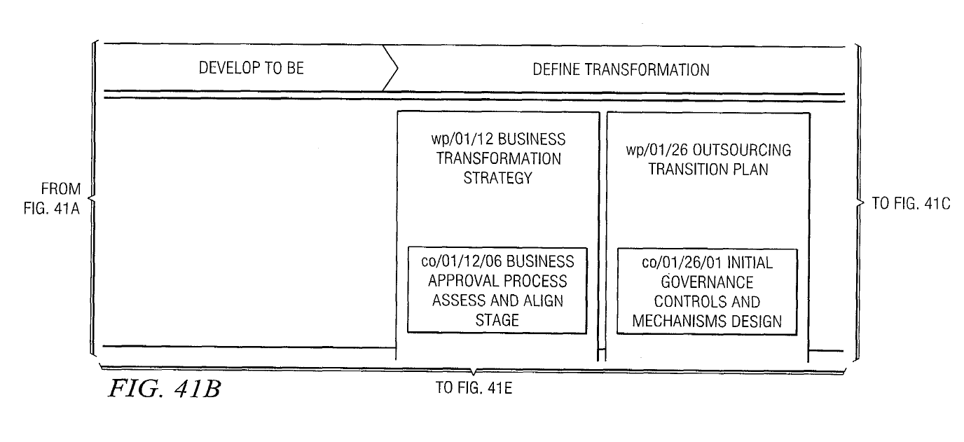

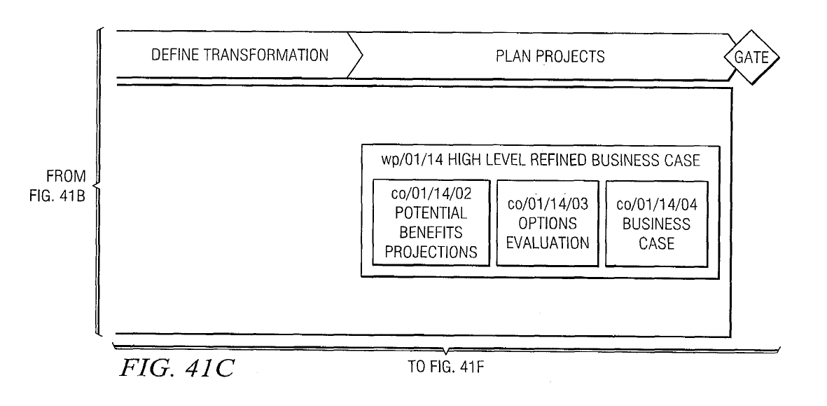

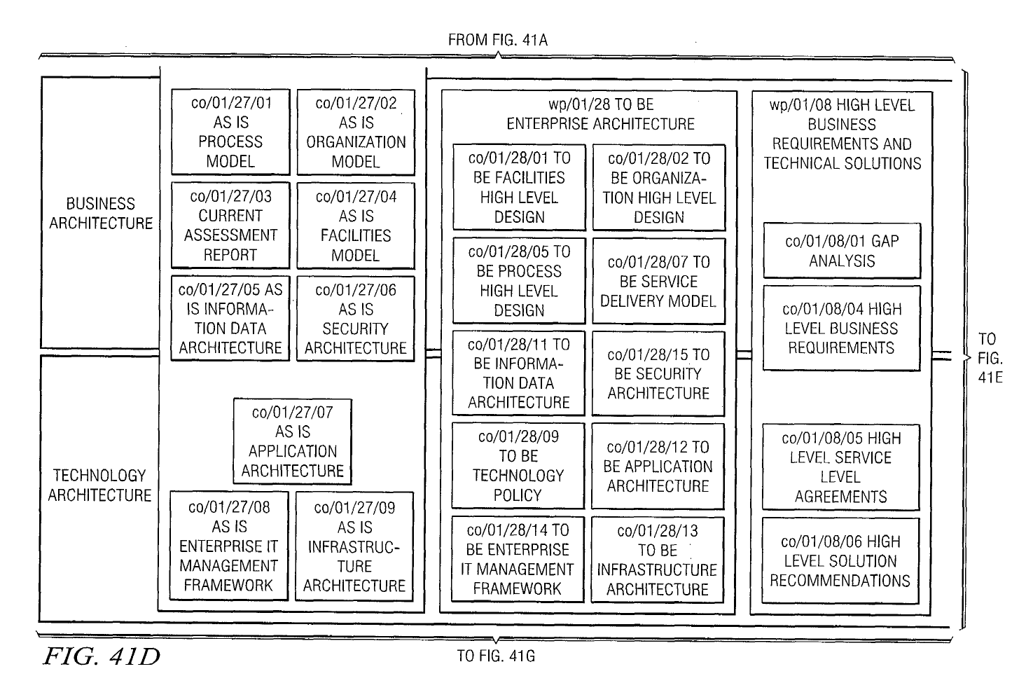

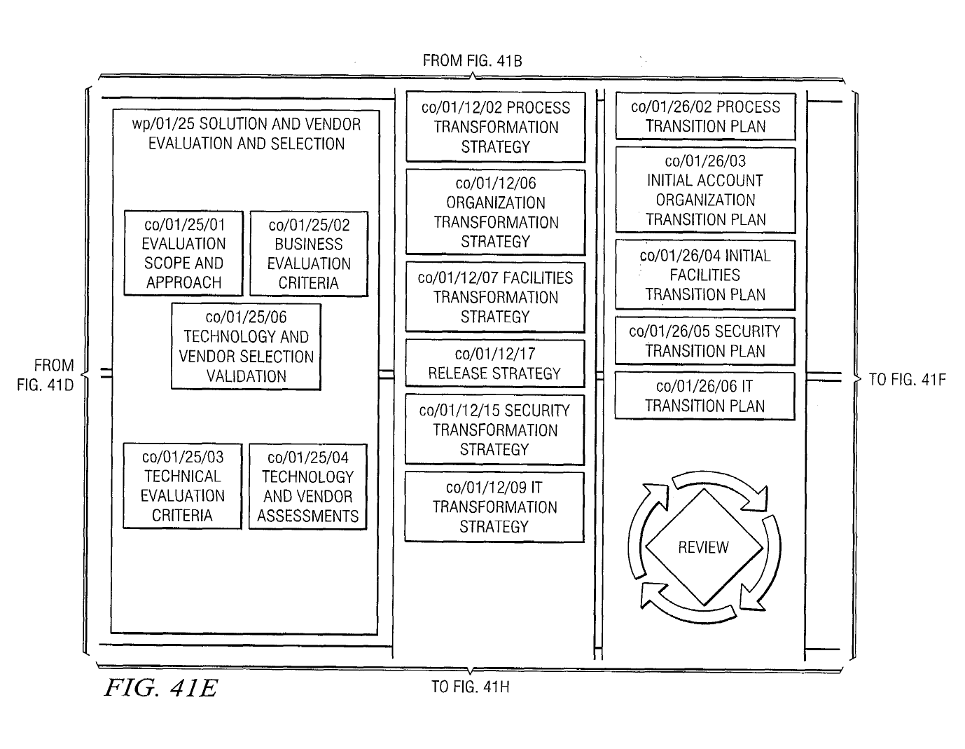

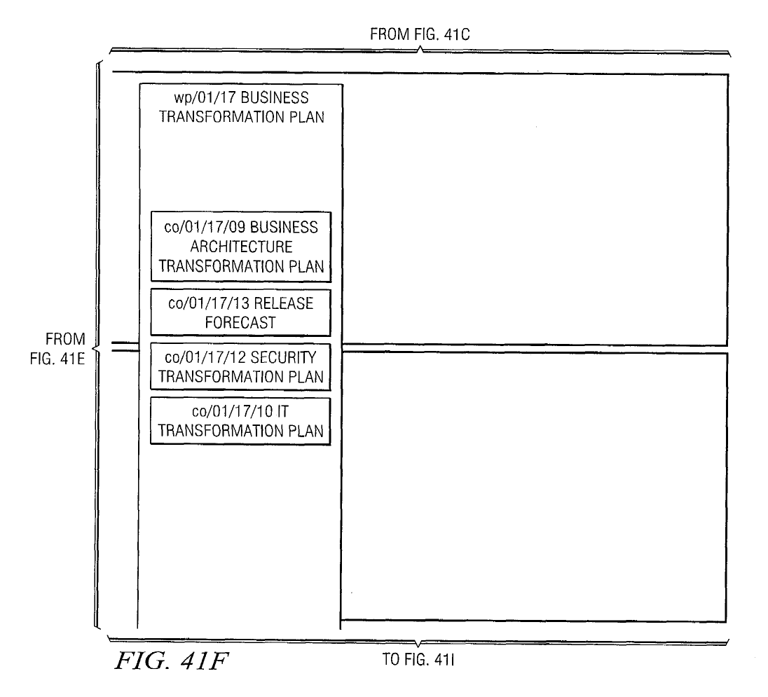

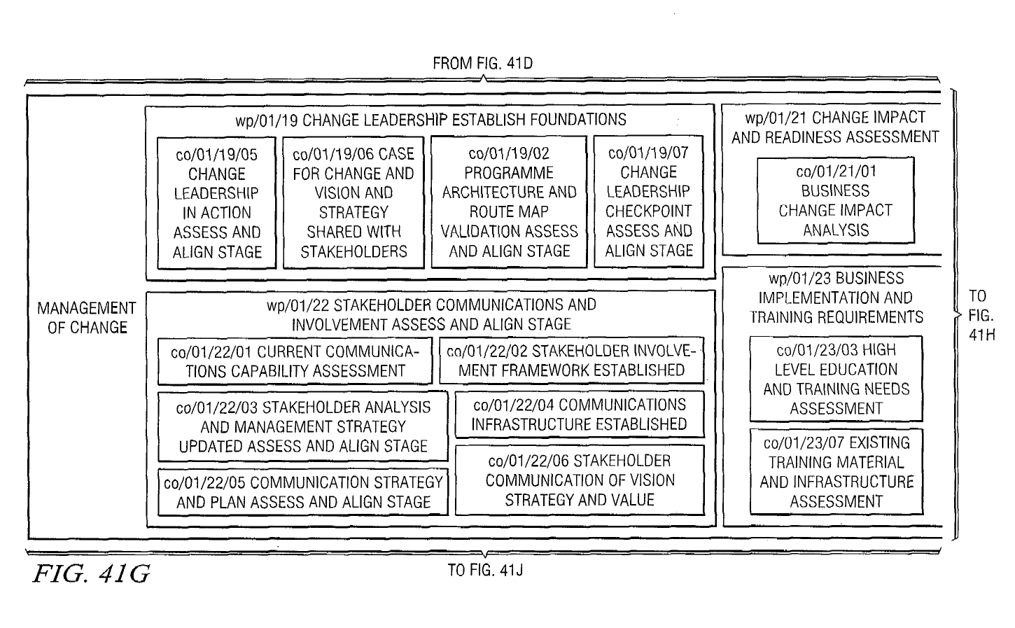

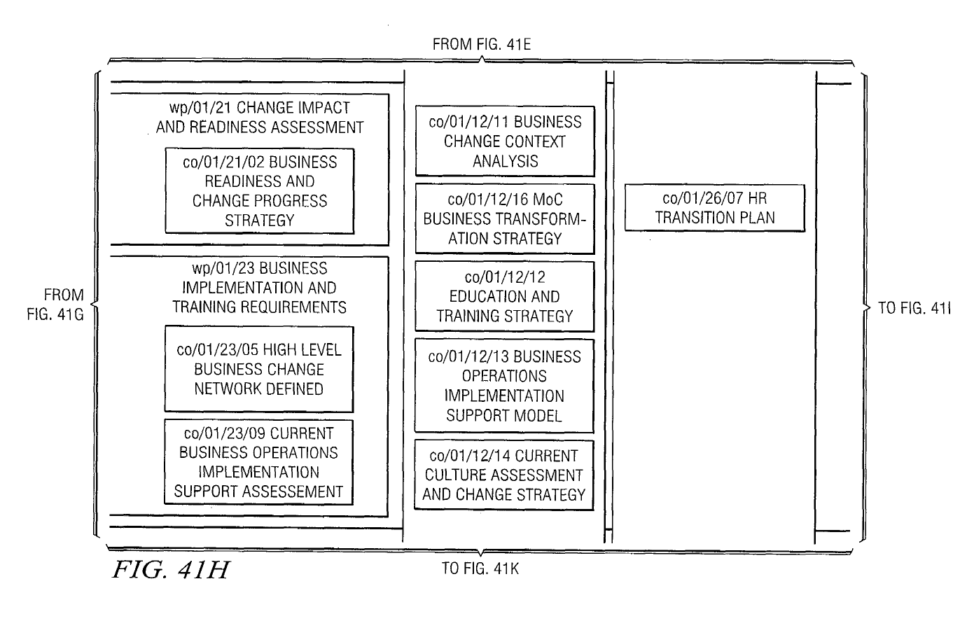

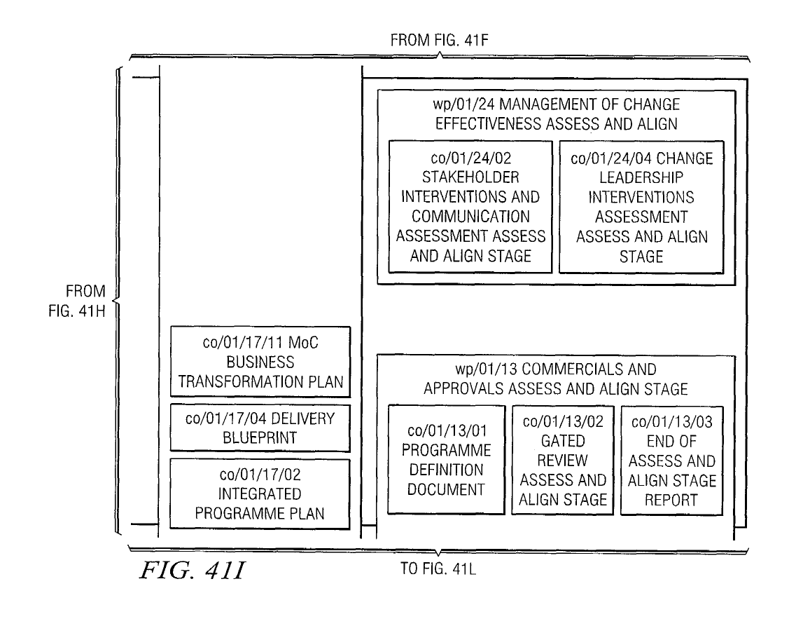

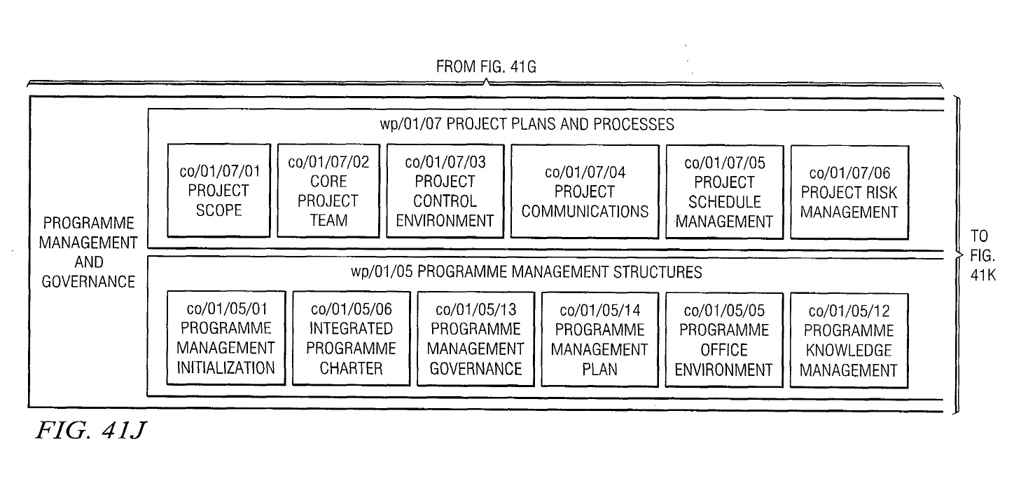

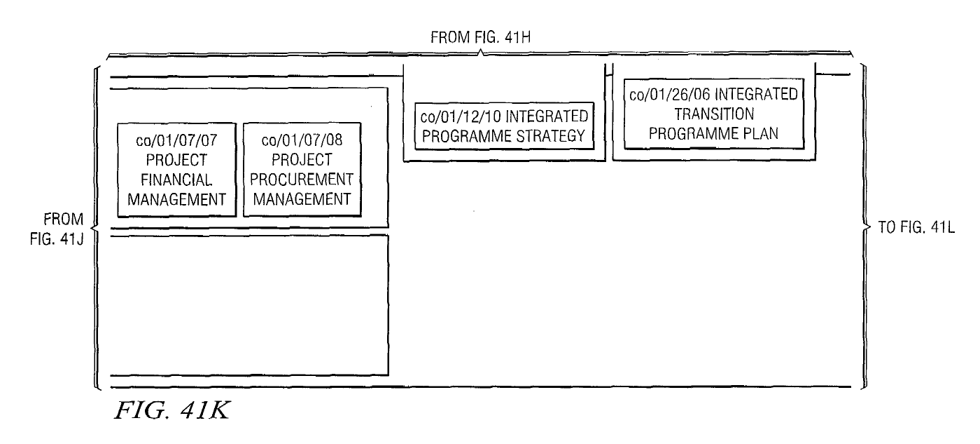

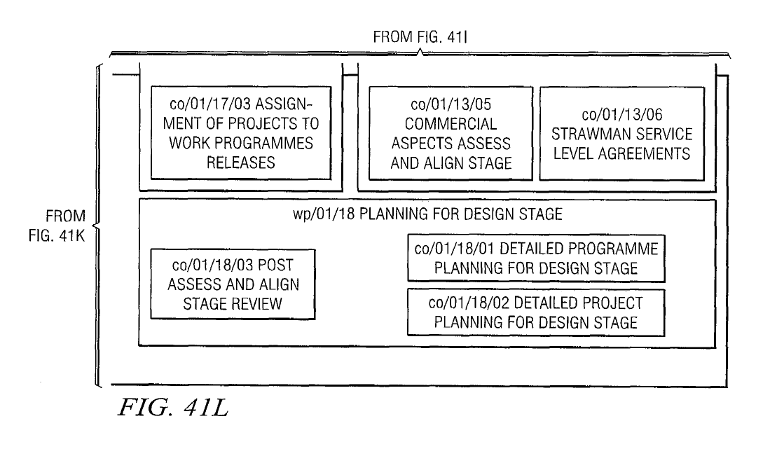

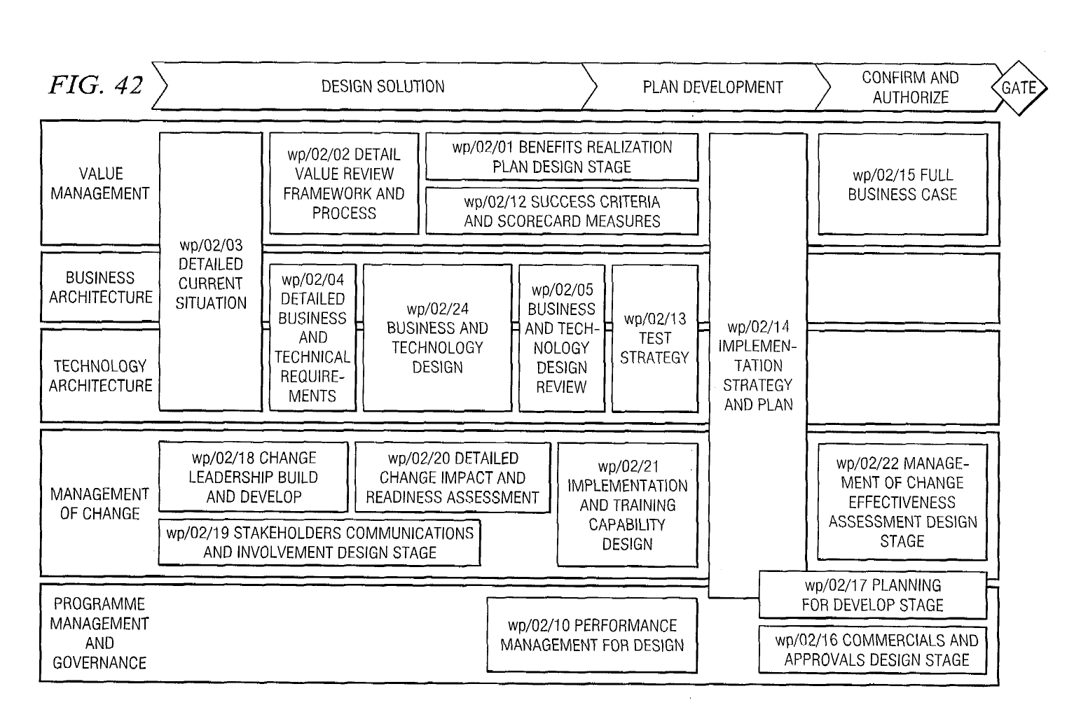

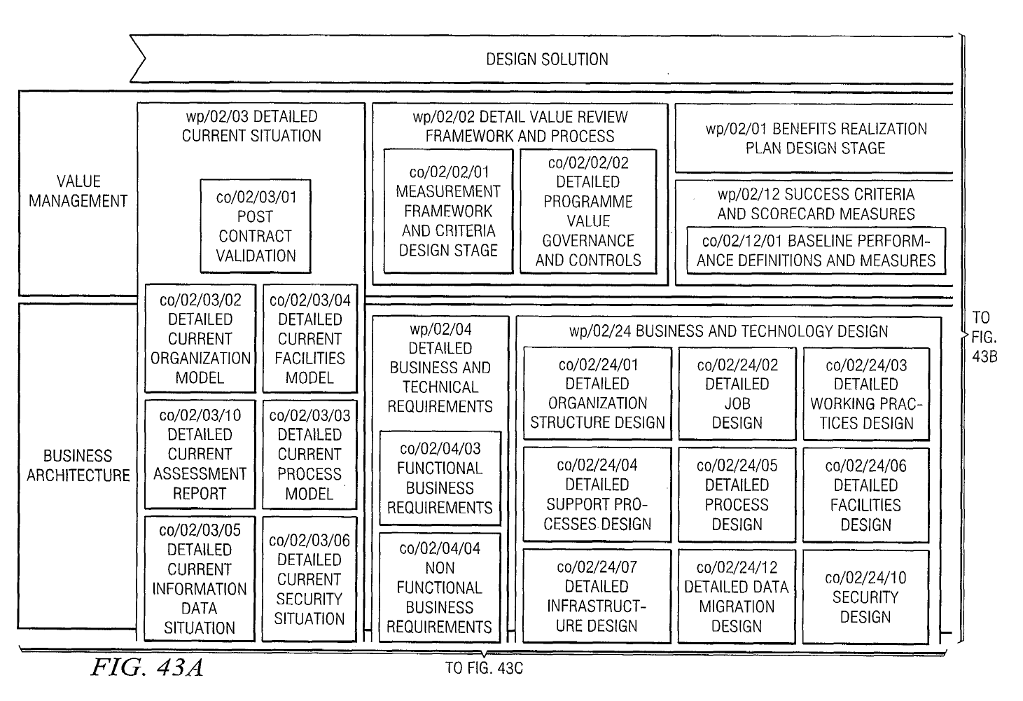

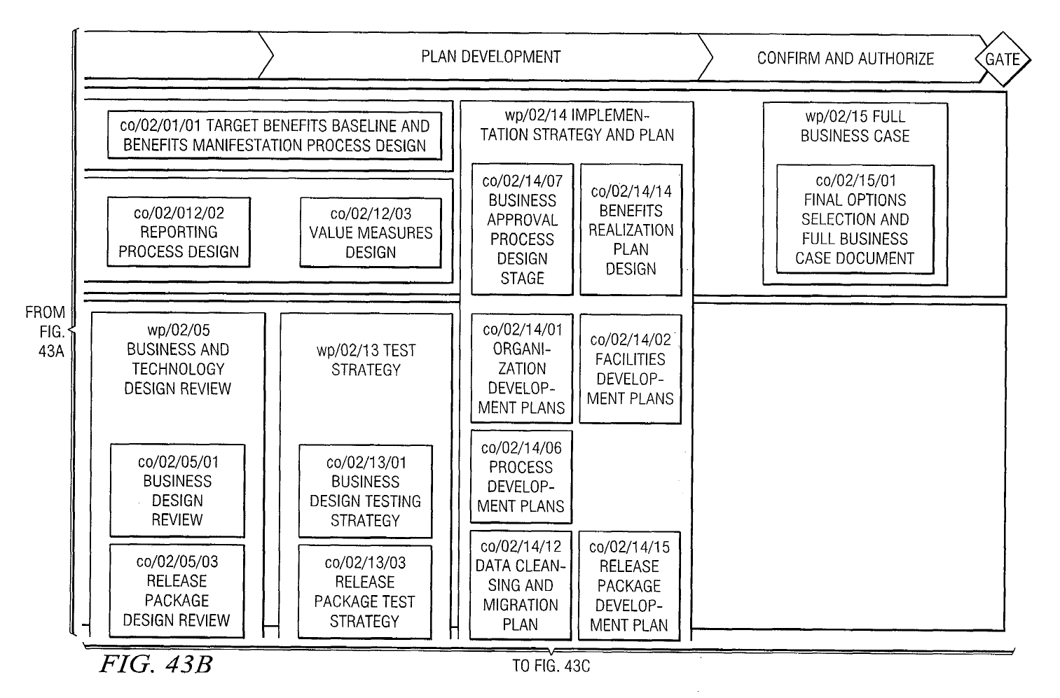

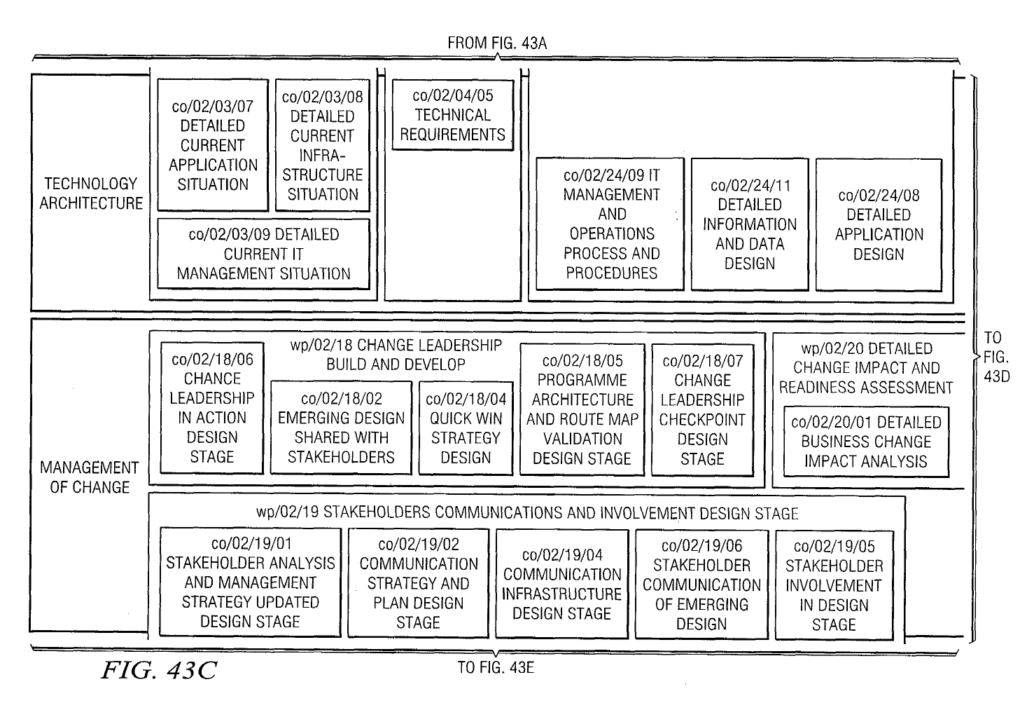

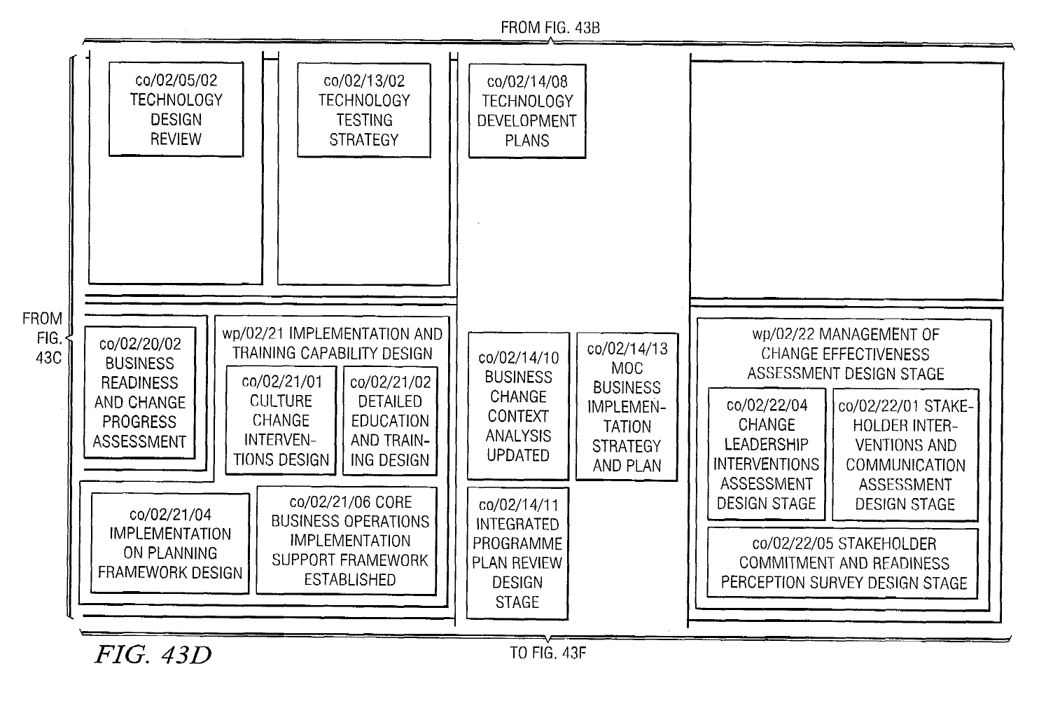

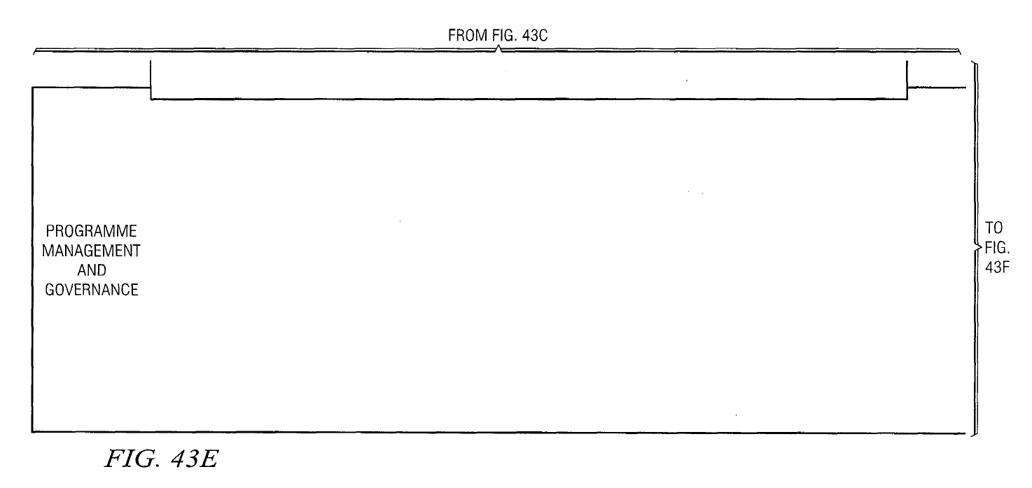

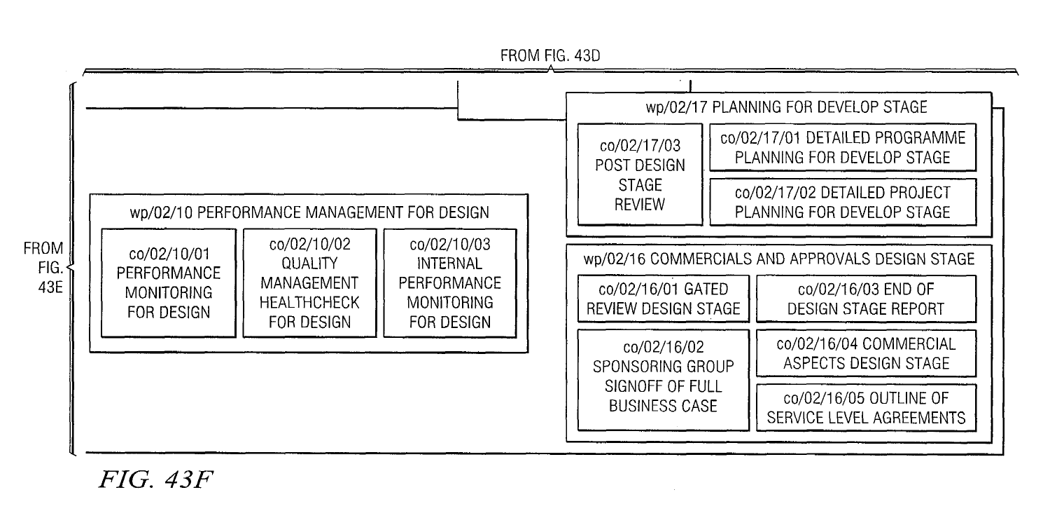

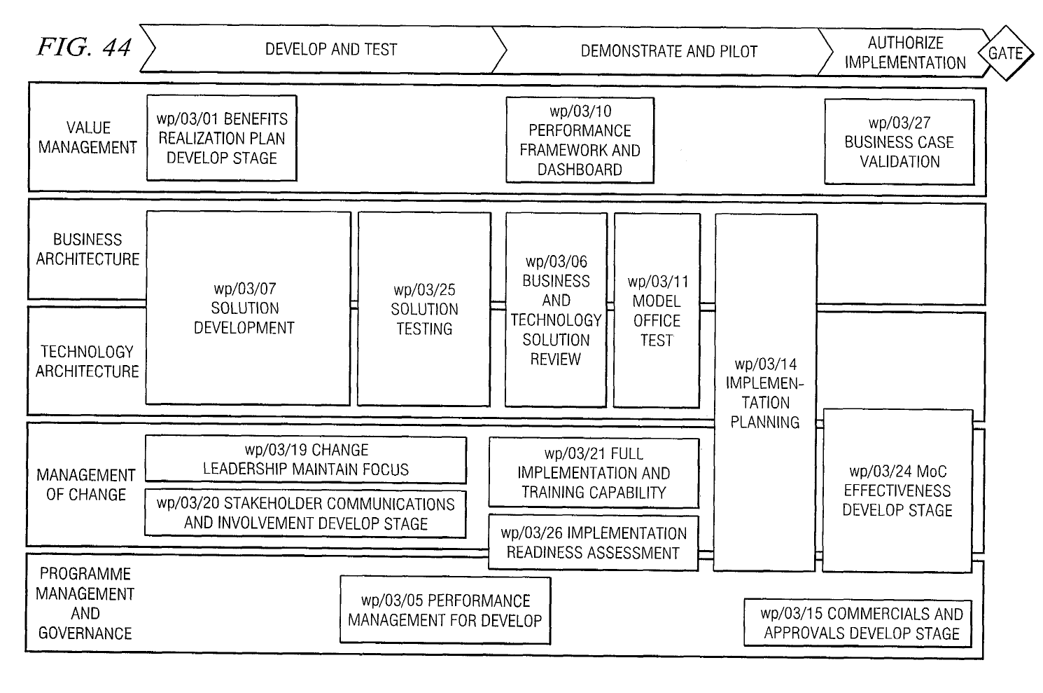

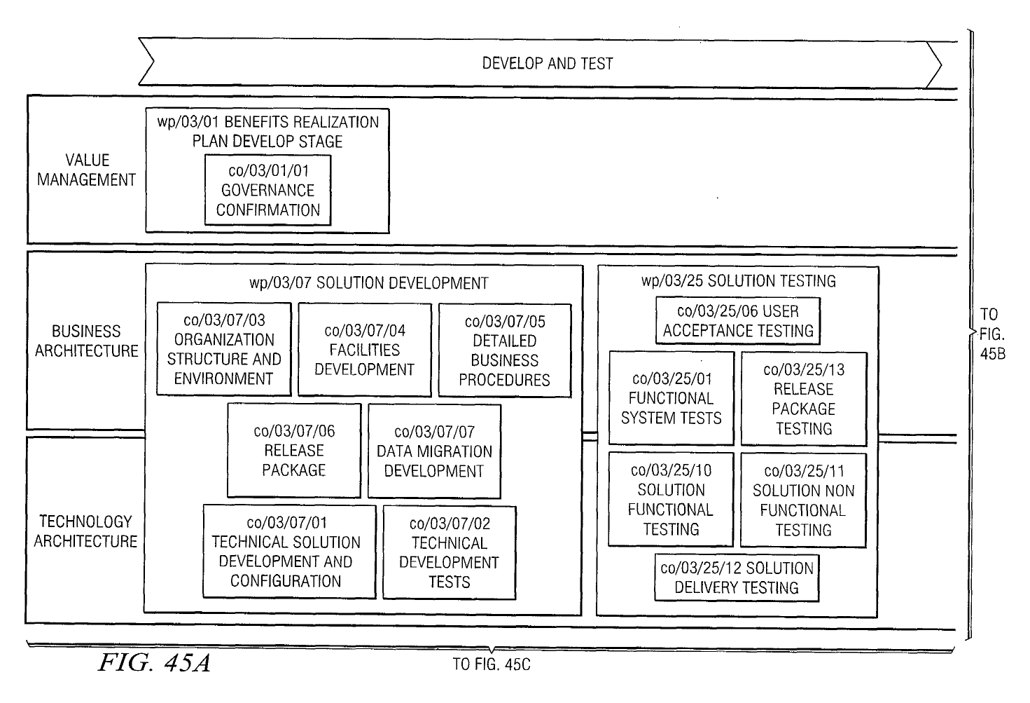

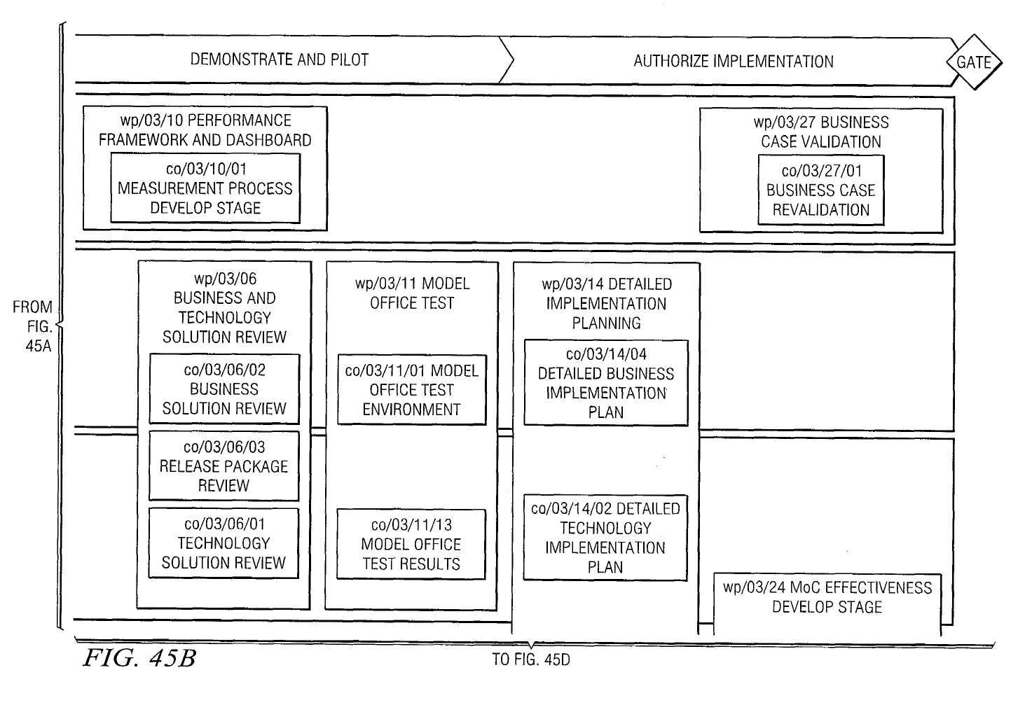

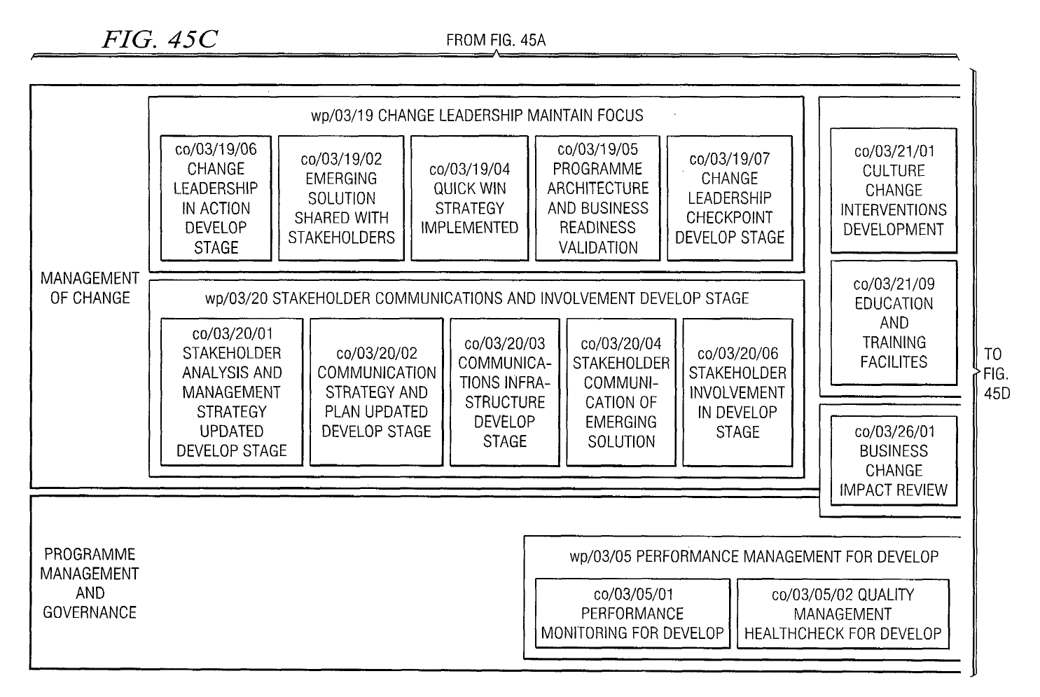

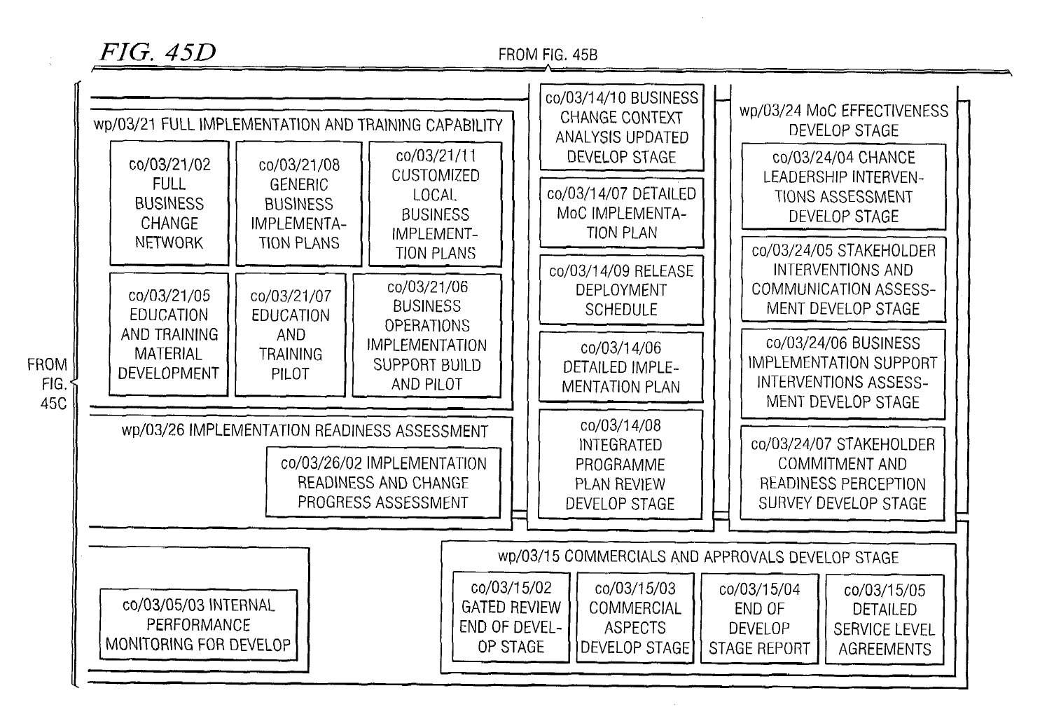

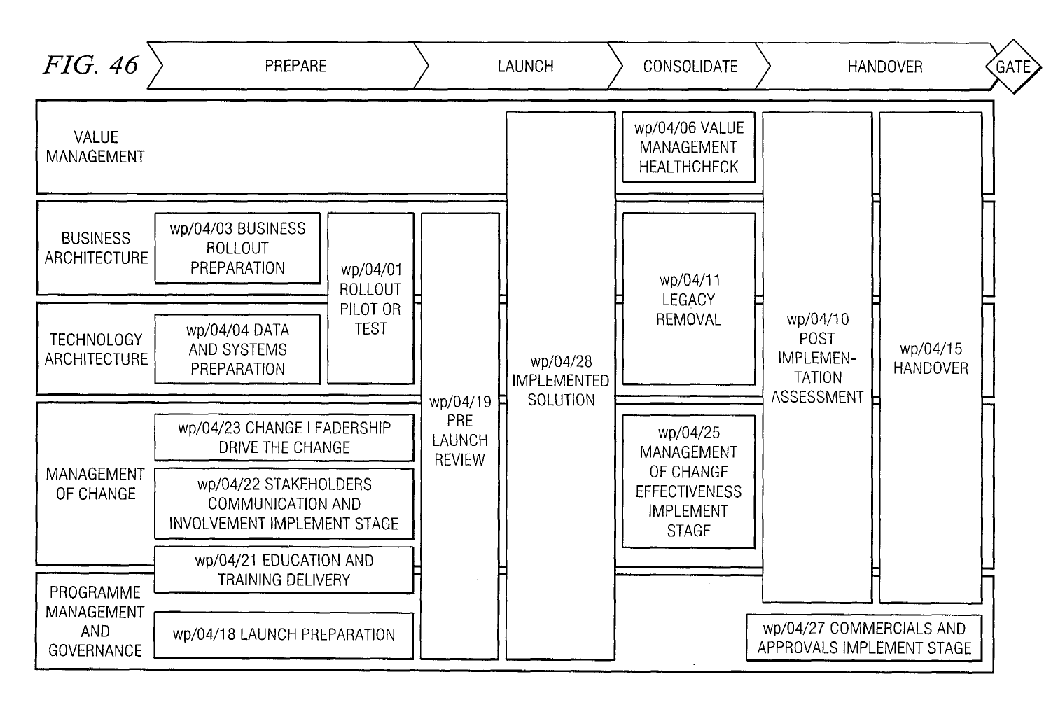

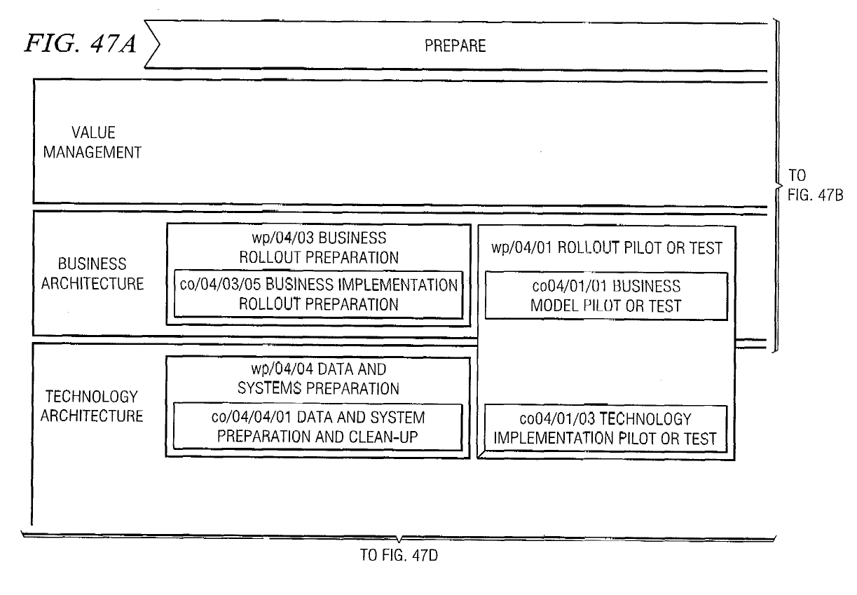

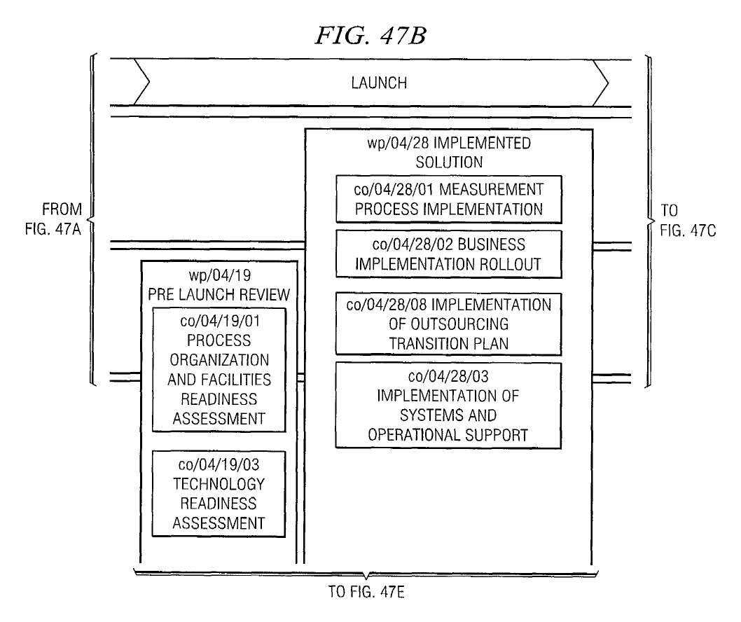

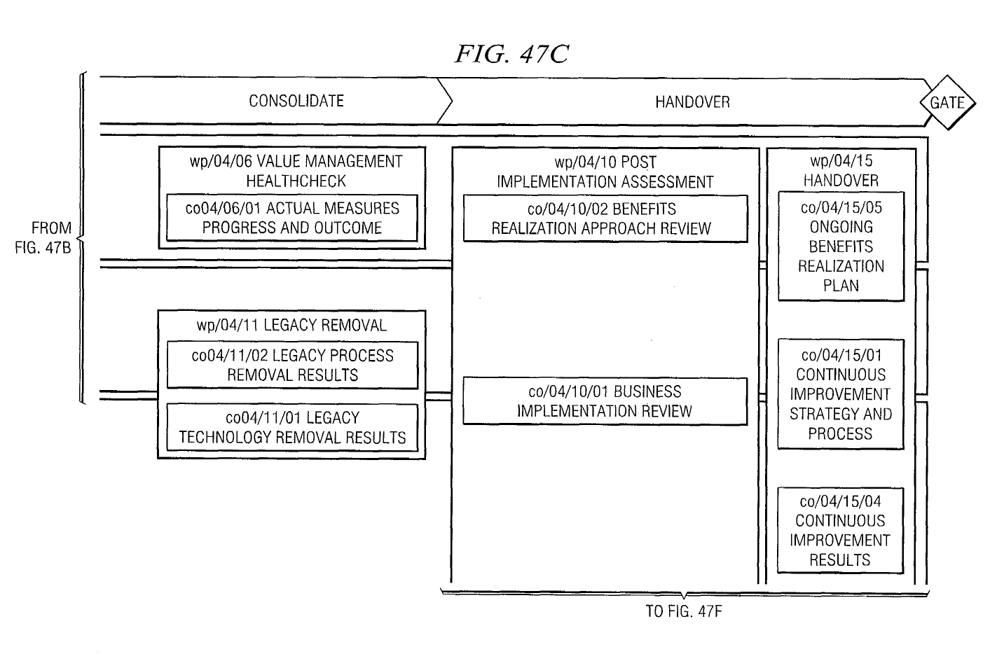

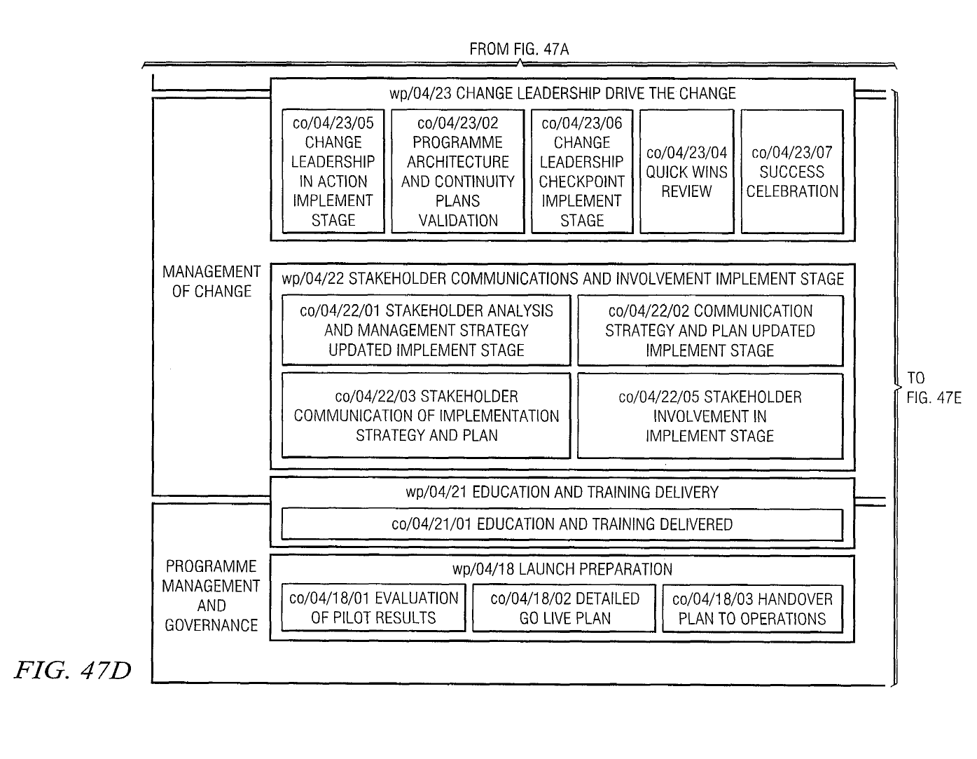

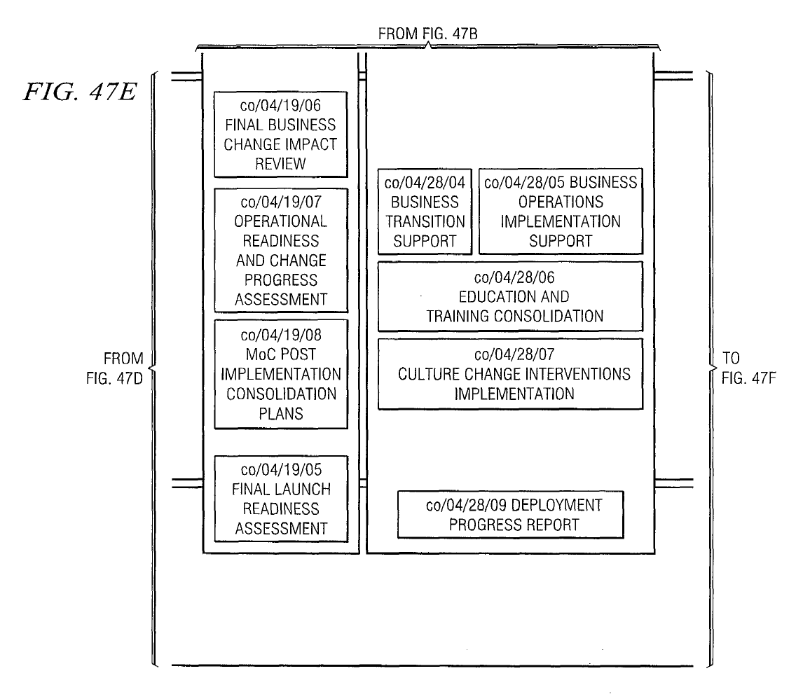

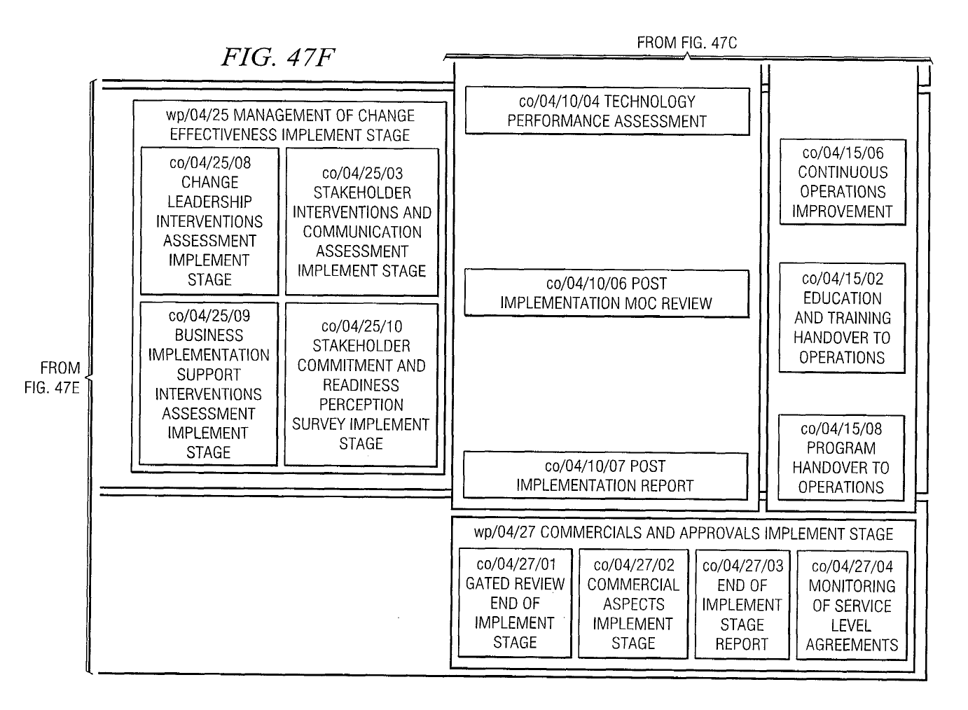

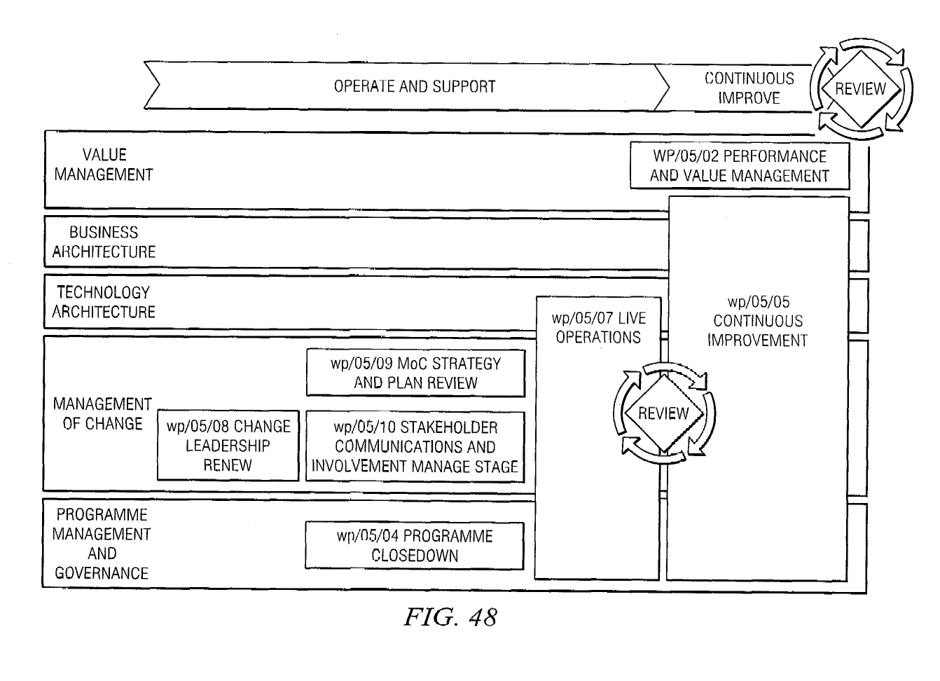

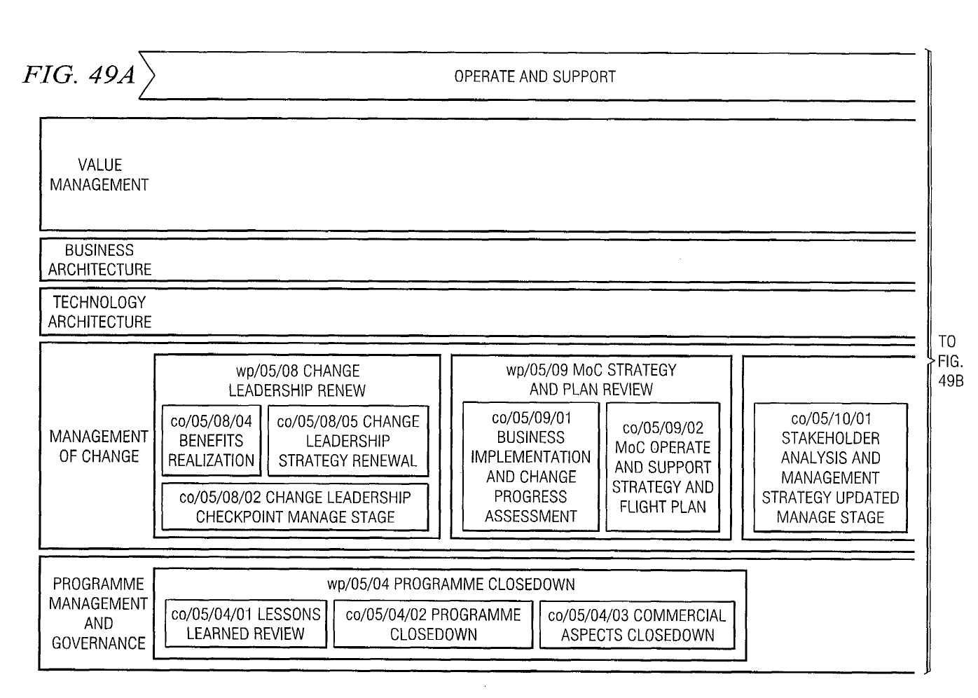

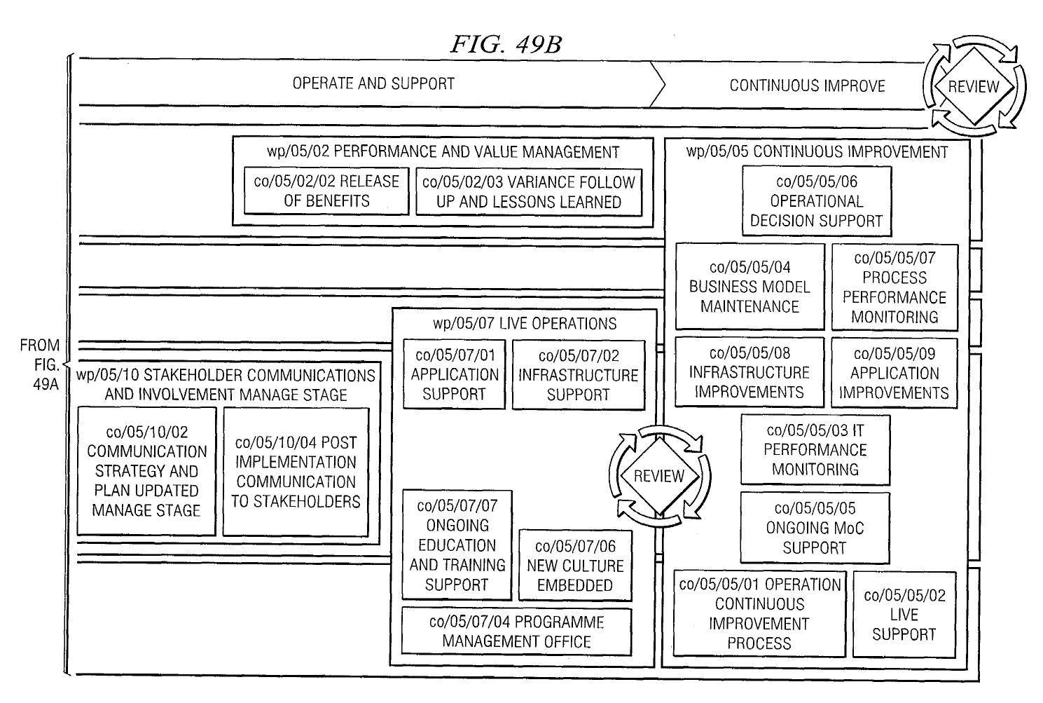

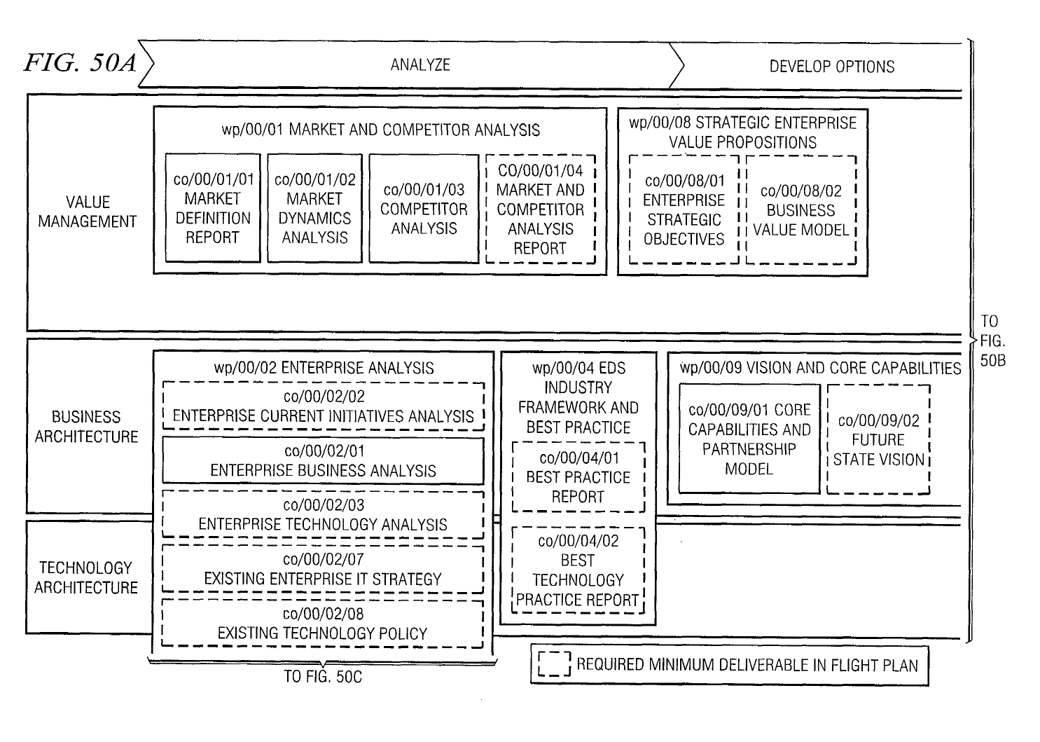

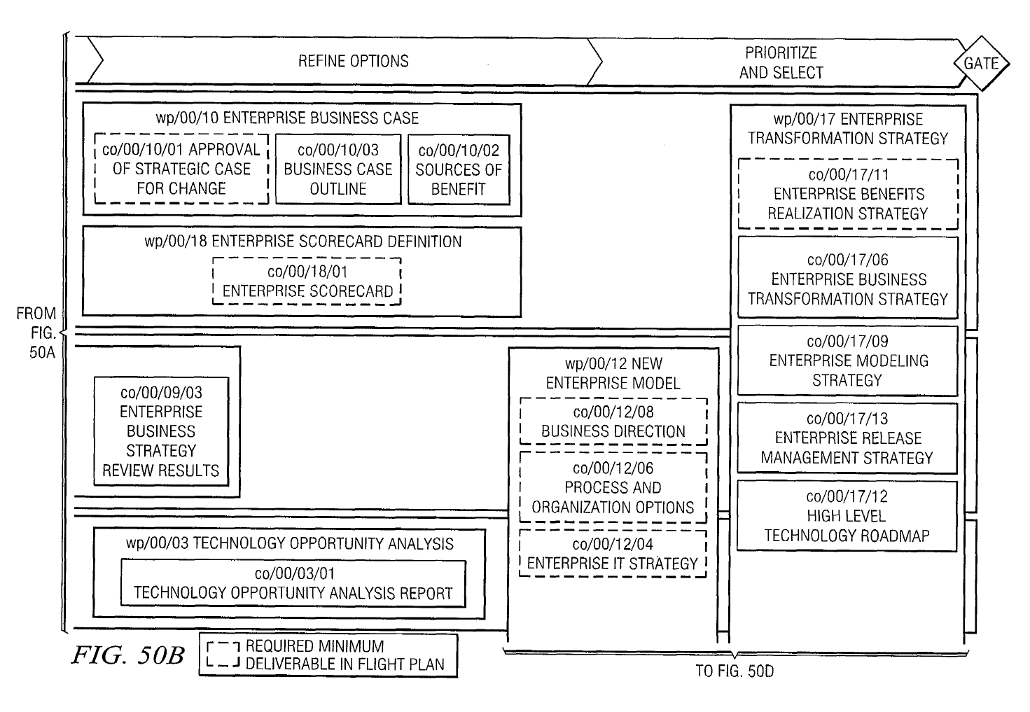

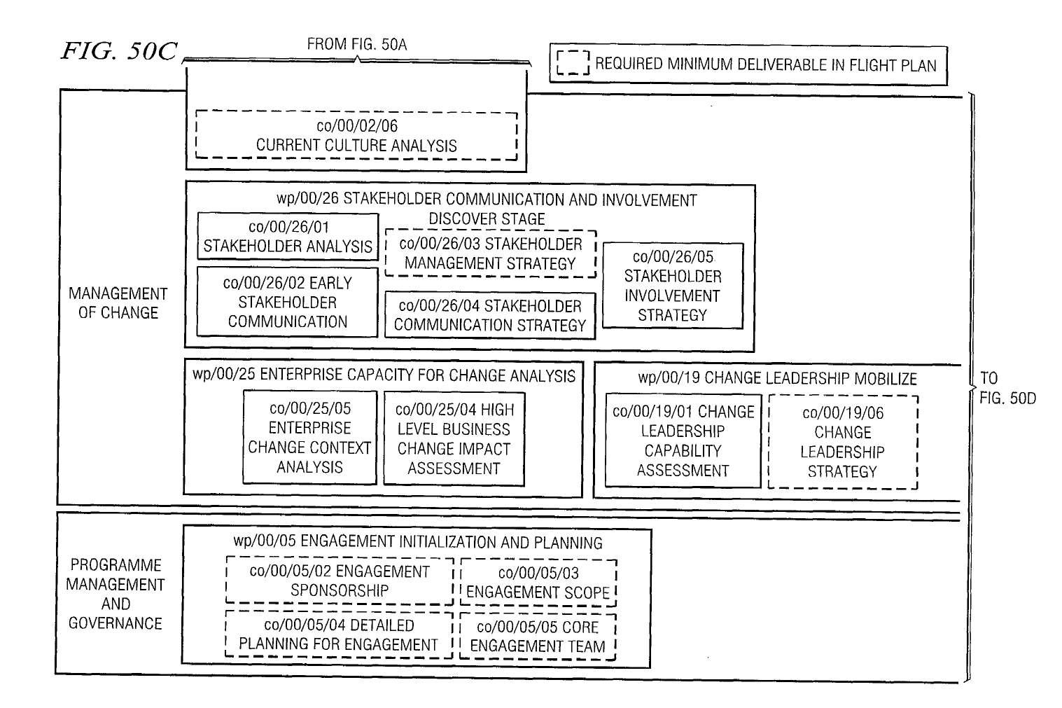

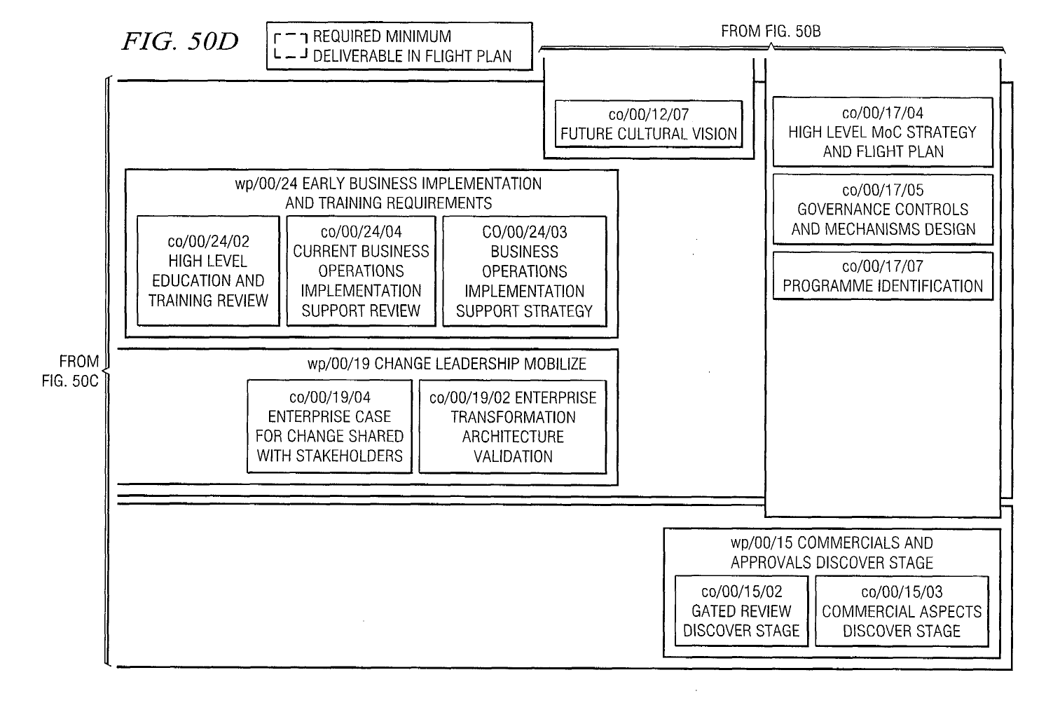

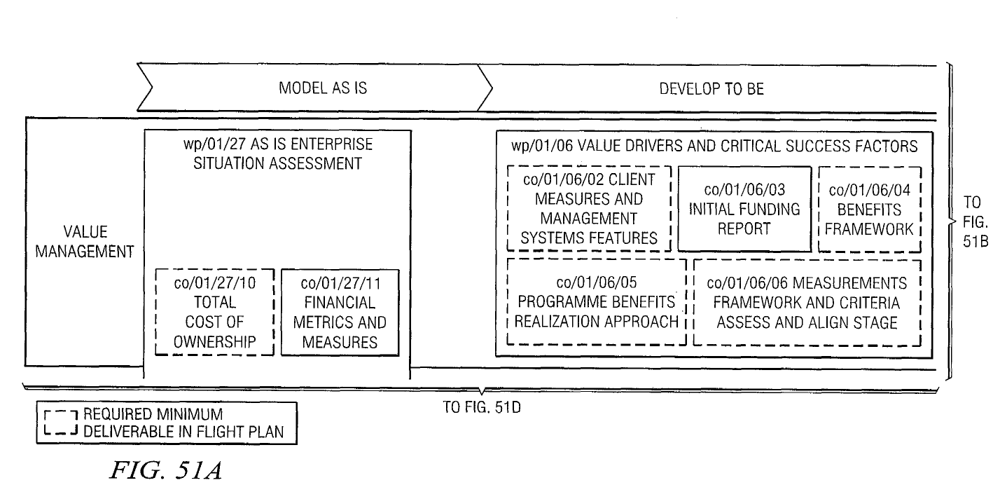

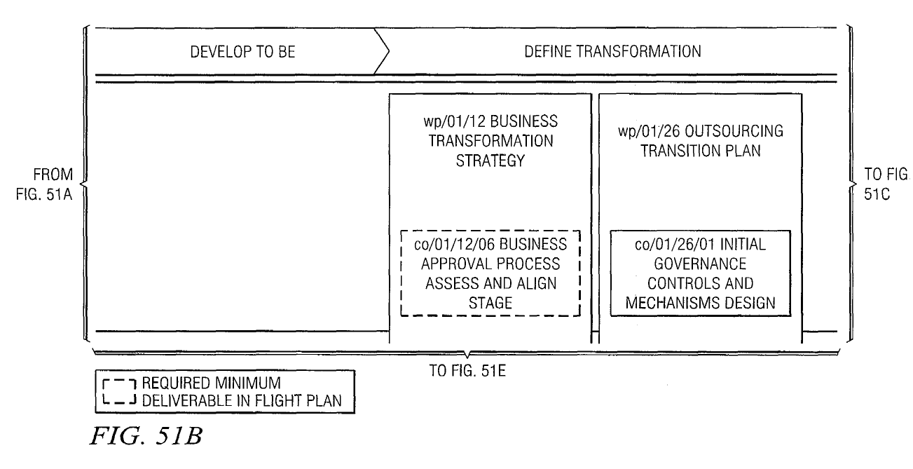

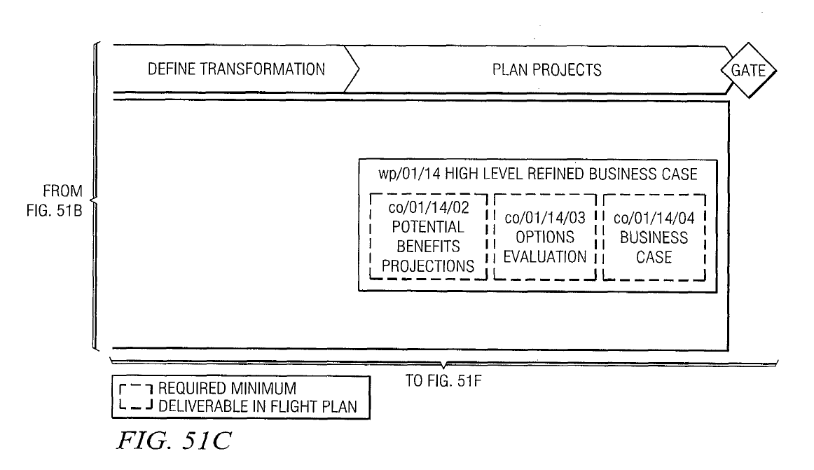

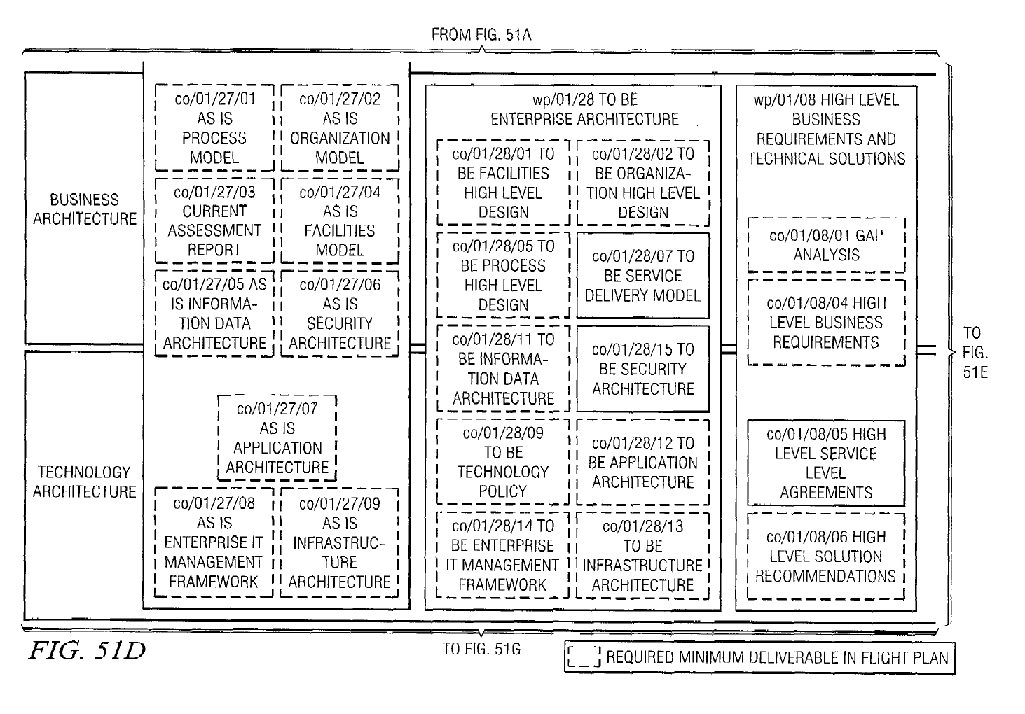

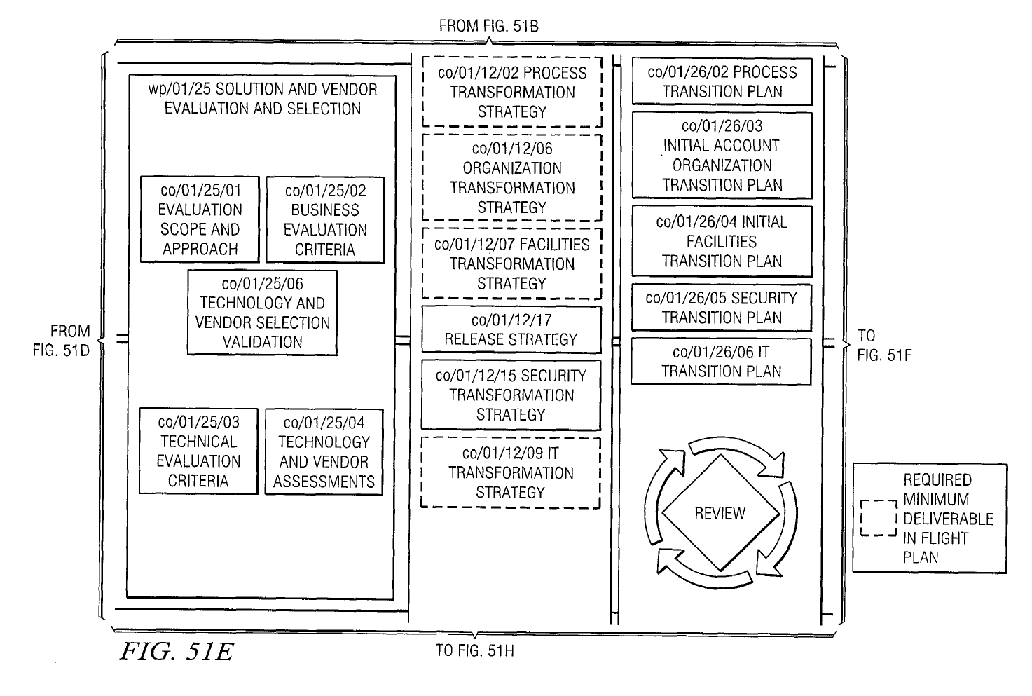

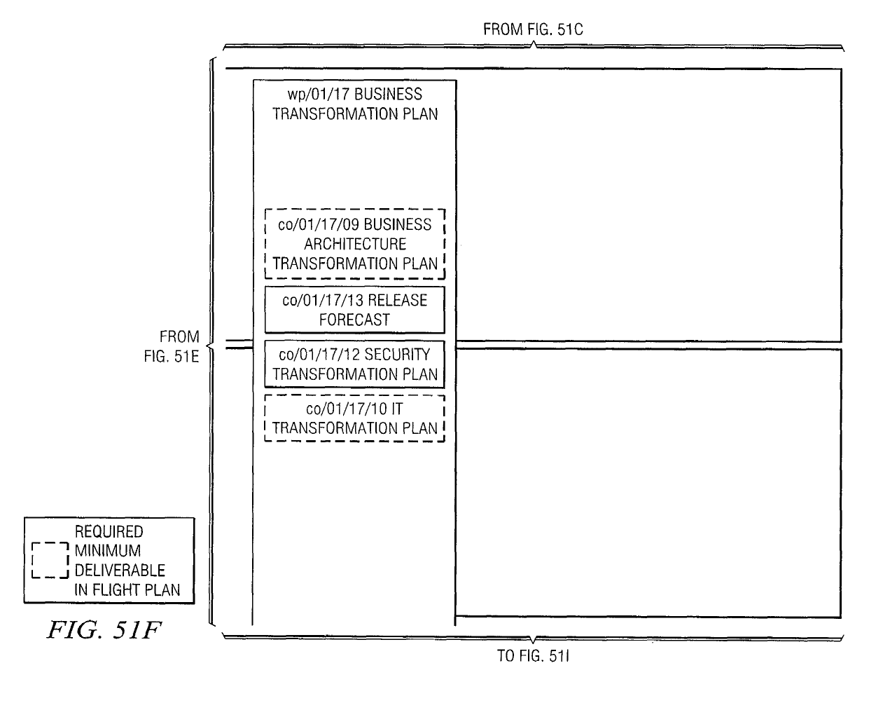

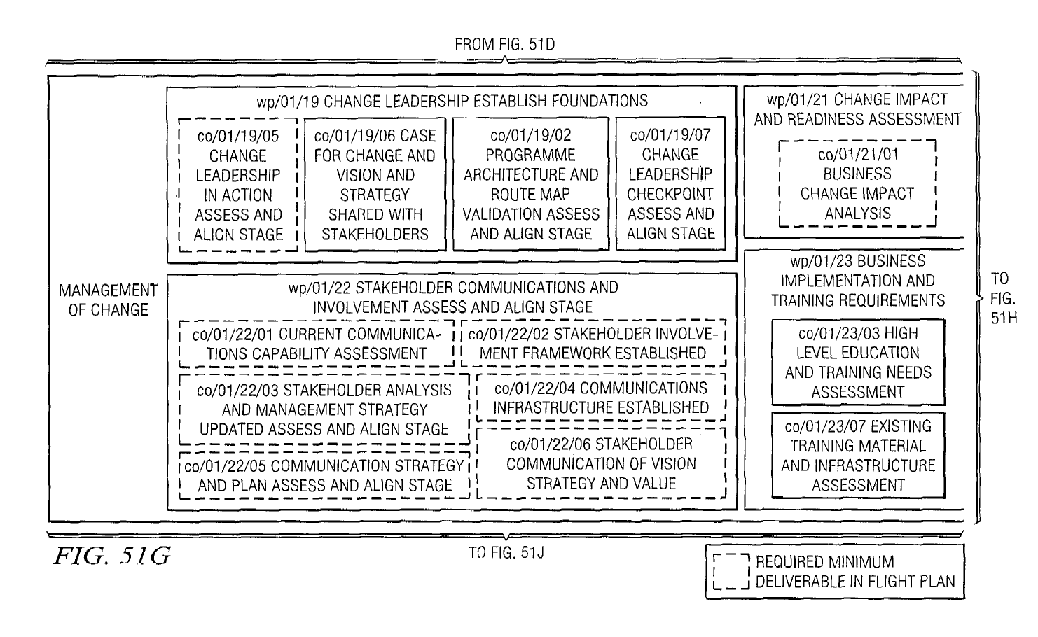

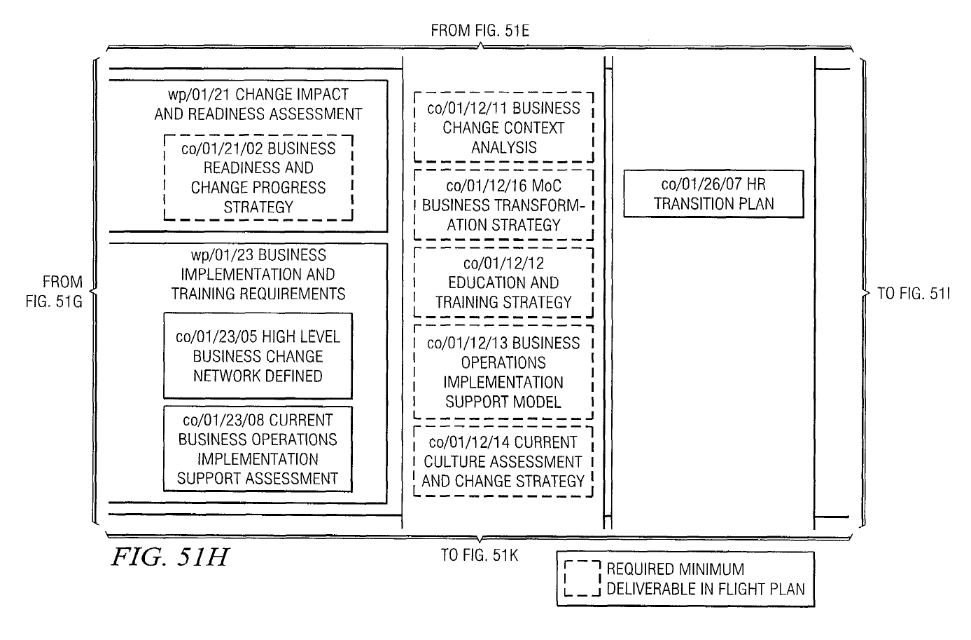

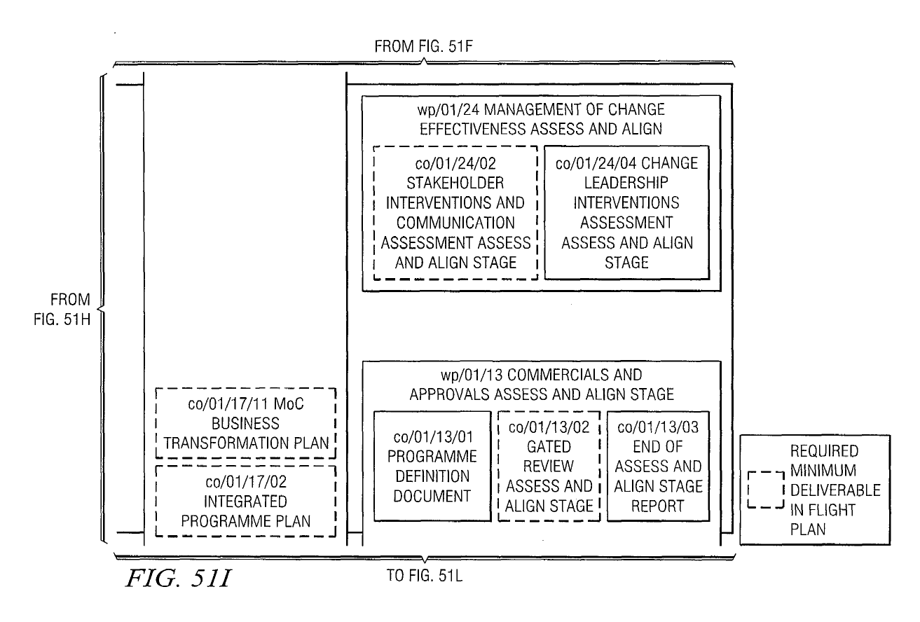

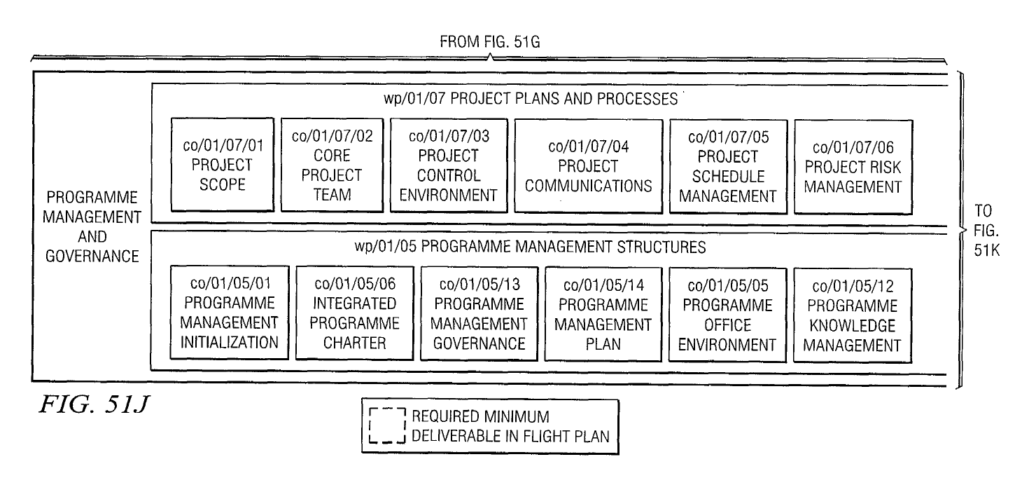

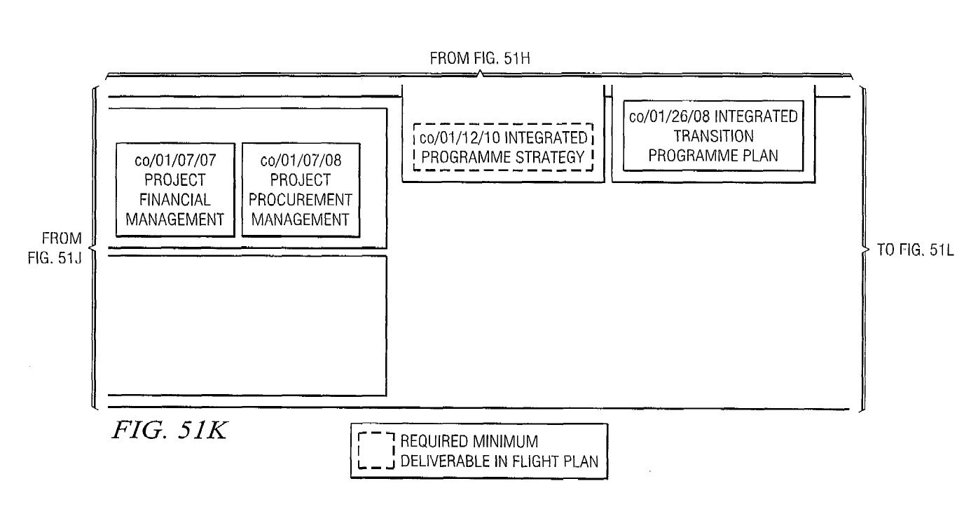

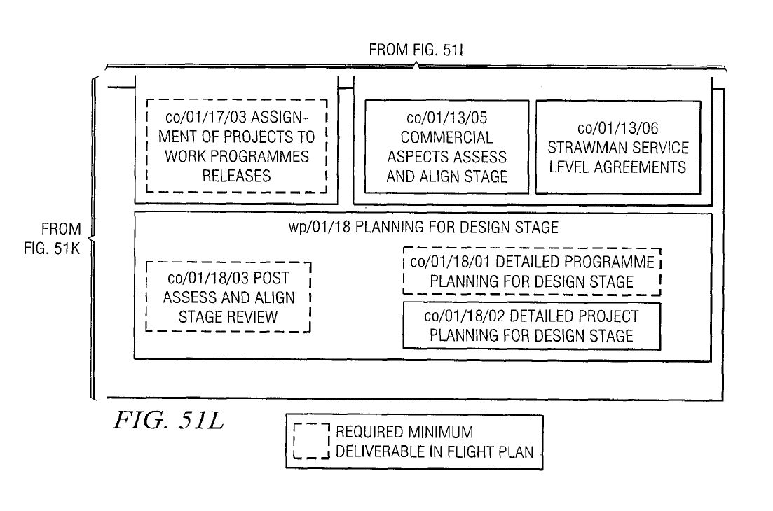

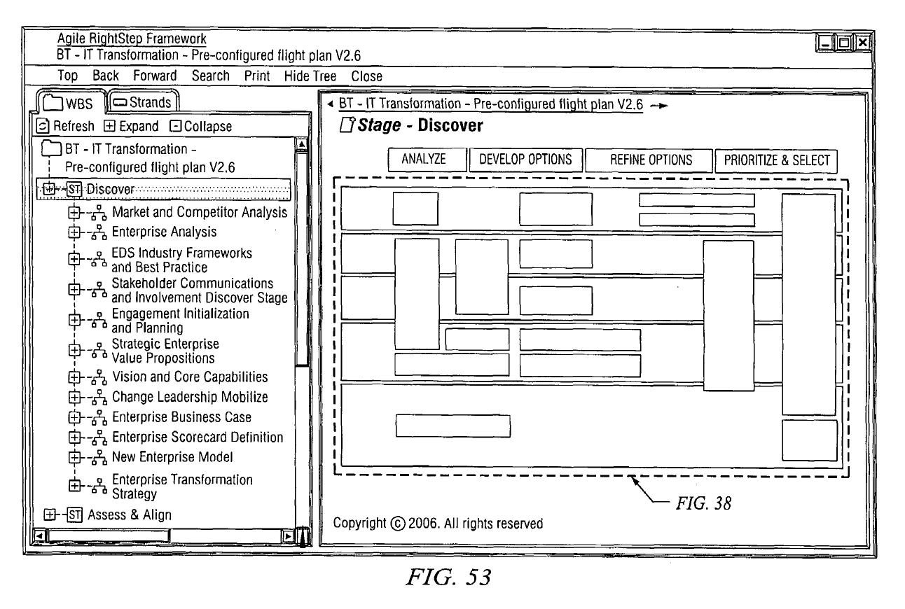

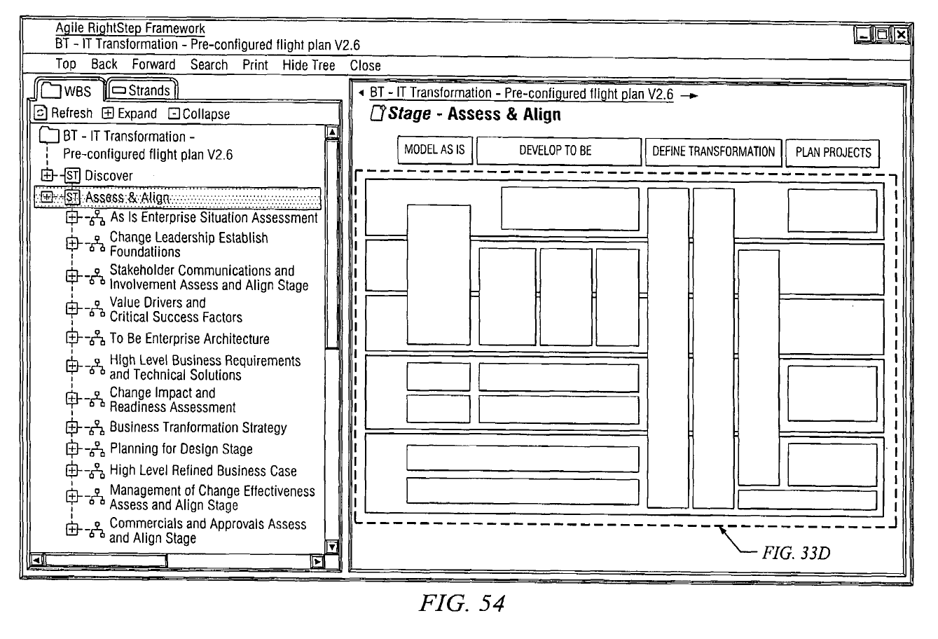

Certain other embodiments are illustrated generally in FIGS. 27 through 54. The systems and methods described herein may further incorporate many additional and/or alternative features.

Certain alternative/additional features relate to tailoring of flight plans within the overall framework. For example, in some embodiments described above, tailoring is directed to the Stages and Deliverables levels. Also, creation of flight plans in same embodiments is largely achieved from scratch. Further, some embodiments do not generally provide for flight plan templates. Moreover, the storage medium for flight plans in some embodiments is limited to CDs, which may require a distribution of PowerPoint versions of the flight plan to interested parties. In addition, in certain embodiments, users may need to manually create schedules and responsibility matrices (RASICS) based on flight planning results. According to certain alternative/additional features, flight planning may be enhanced. For example, one feature provides for the selection/deselection of Stages within a flight plan. Similarly, enhanced flight planning may allow for the selection/deselection of Components within a selected Deliverable and the selection/deselection of Supporting Assets (e.g., specific Process details, Approach documents, Templates, Examples, tools and references).

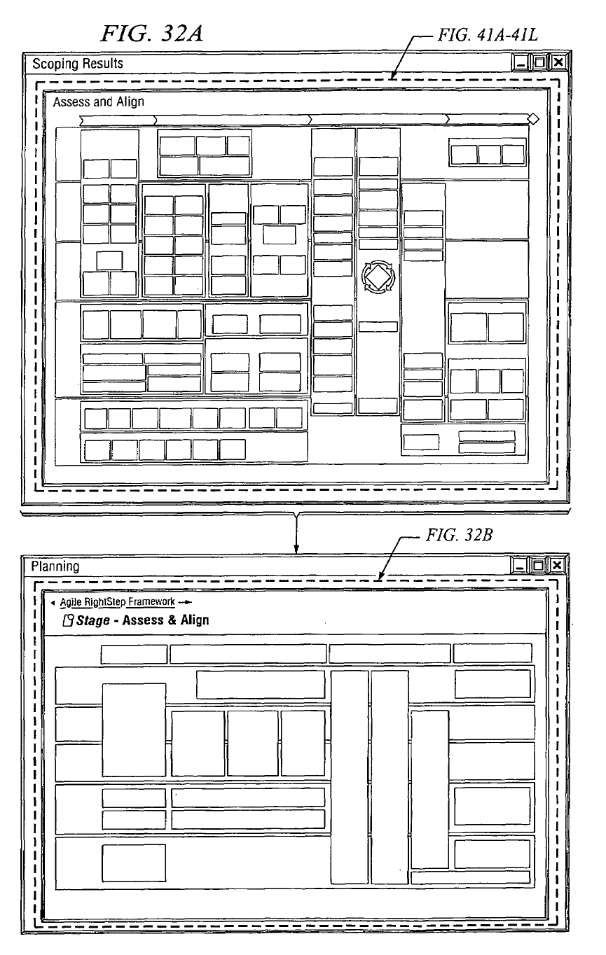

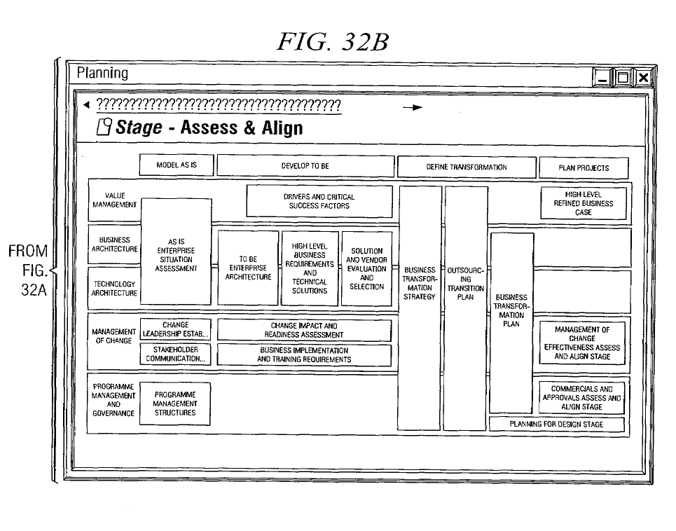

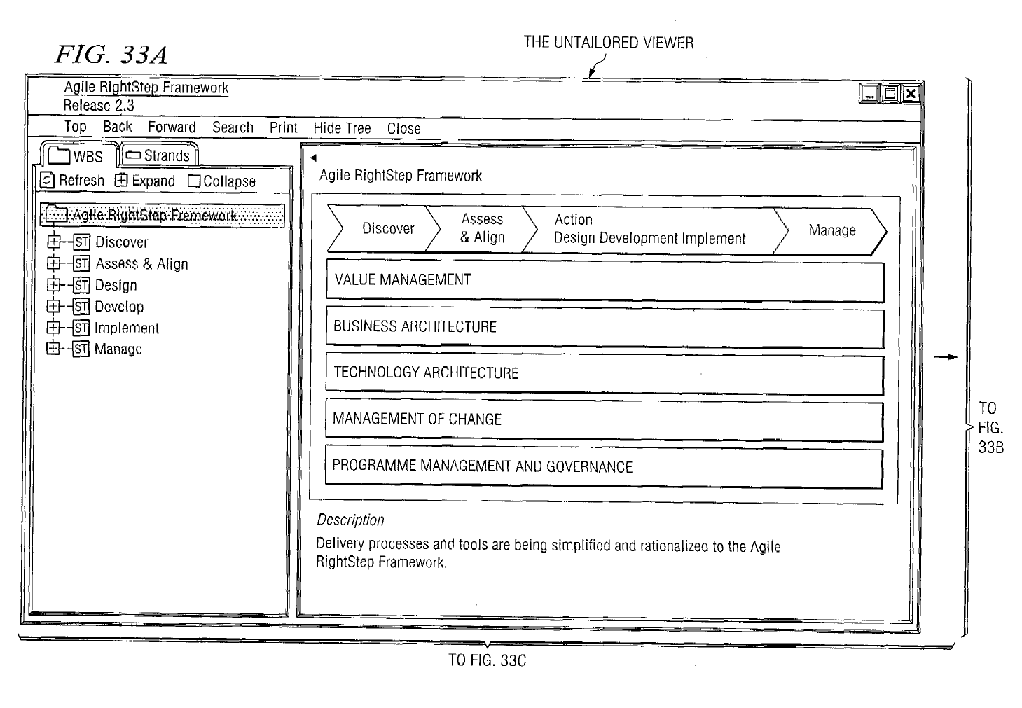

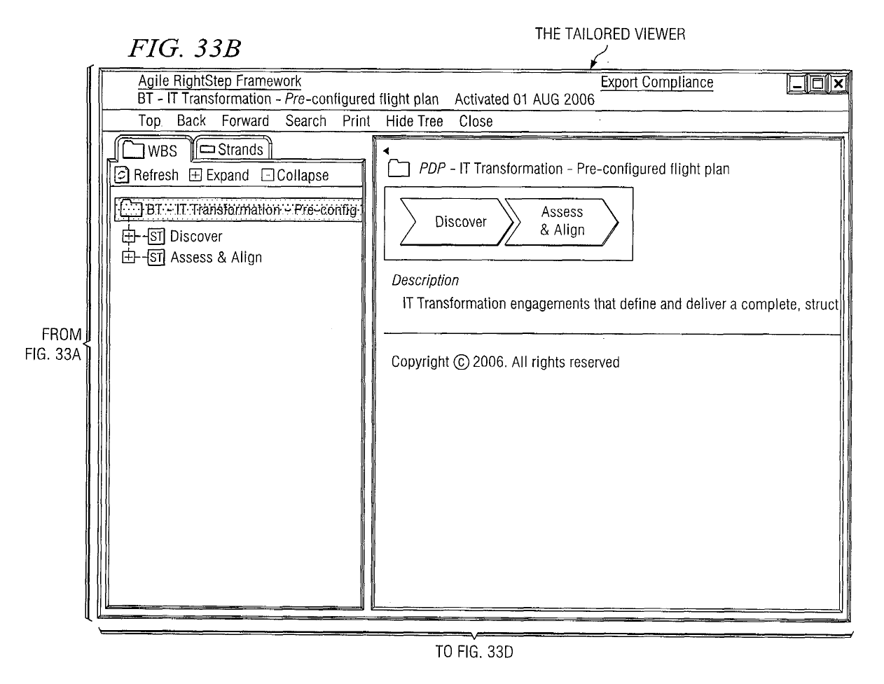

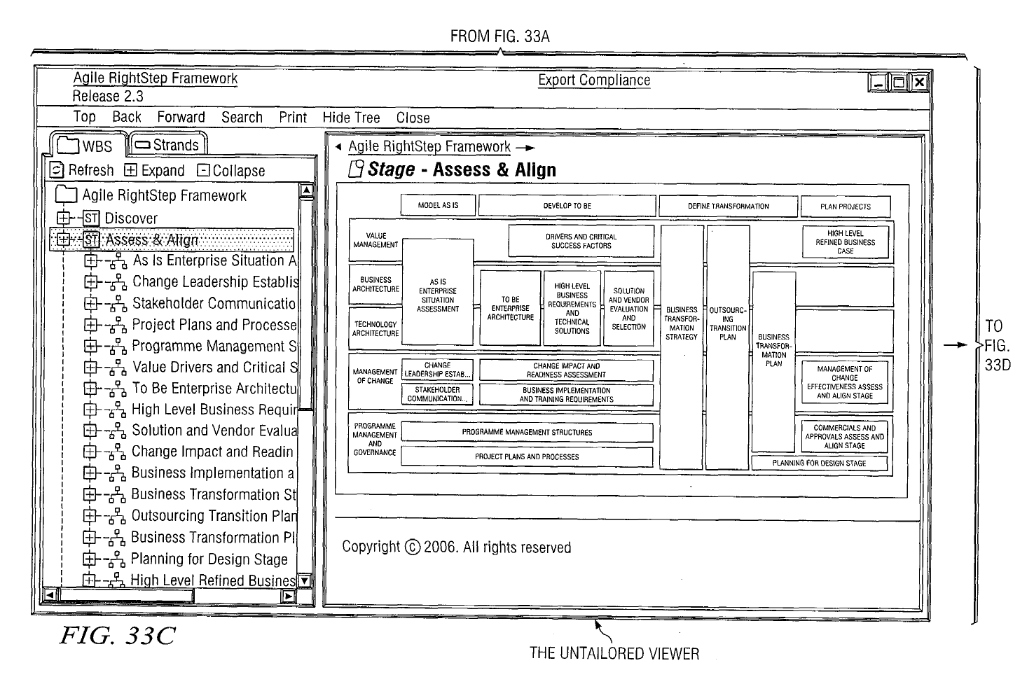

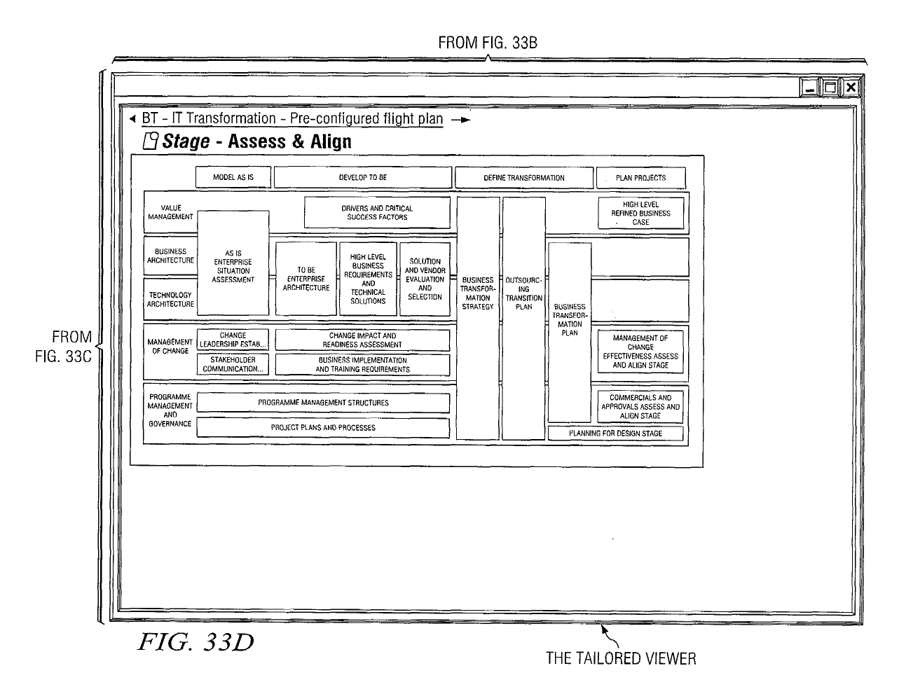

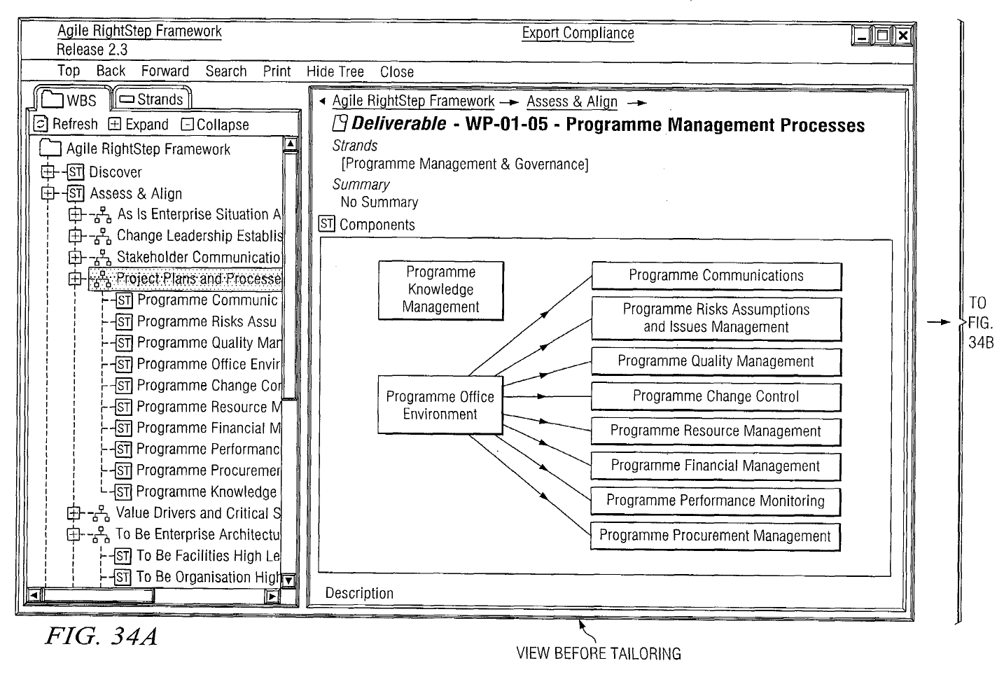

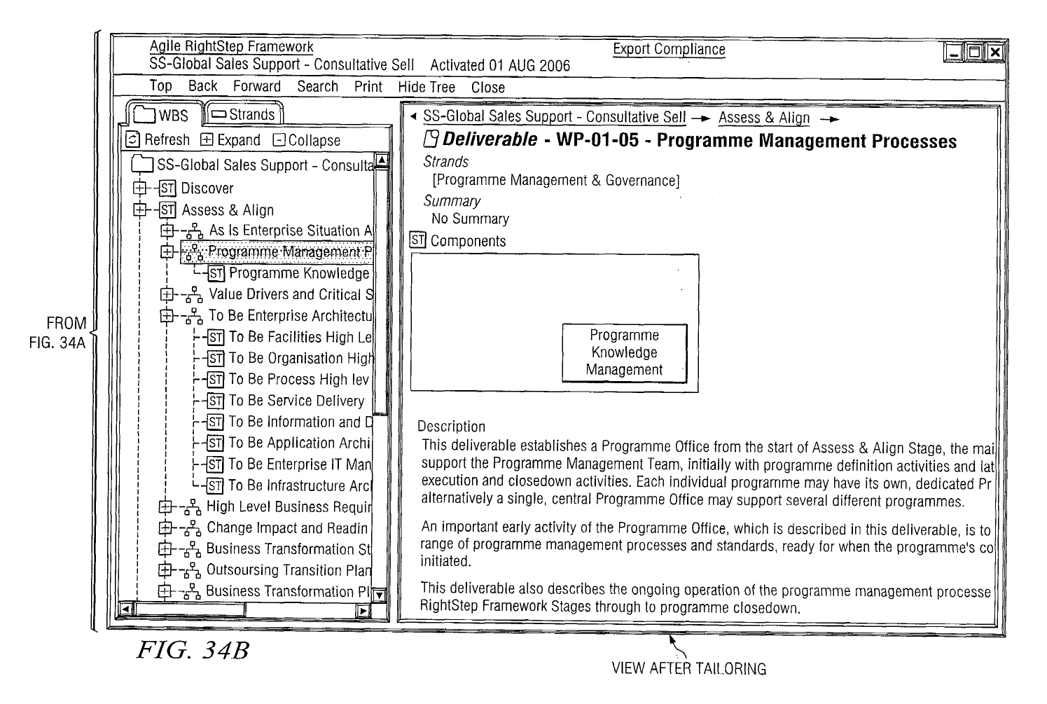

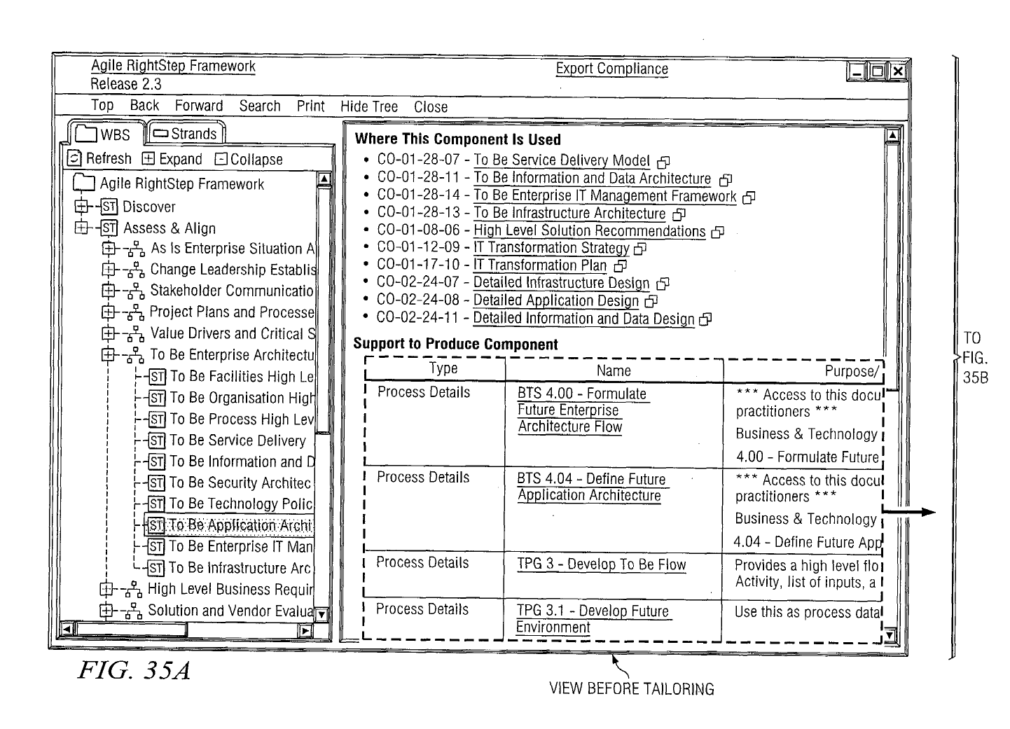

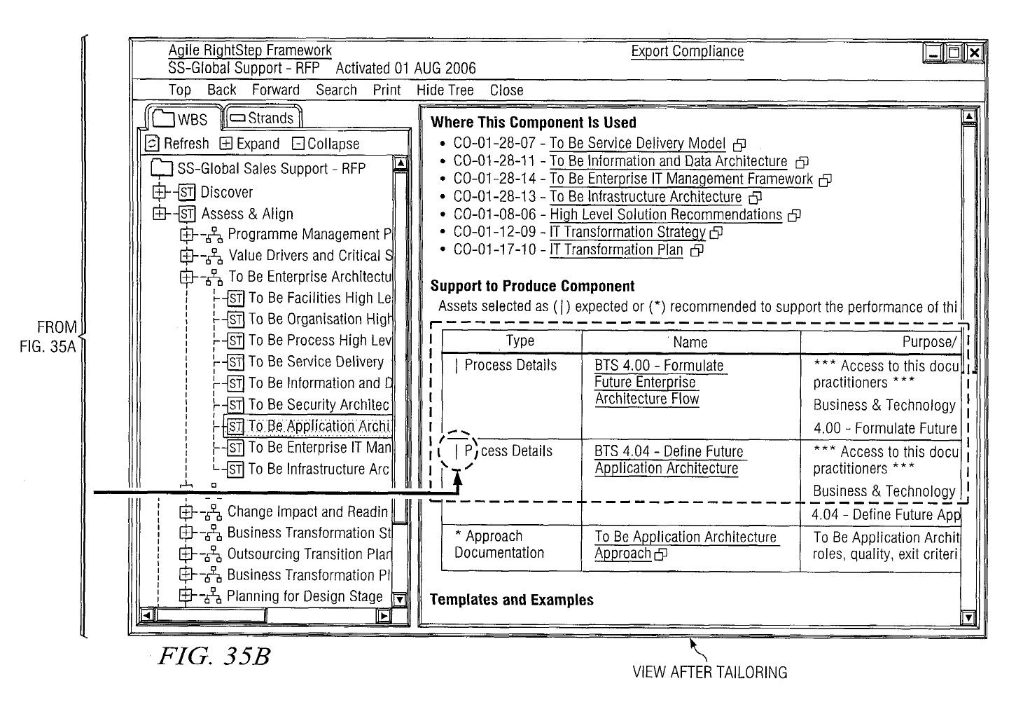

According to another feature, one may selection/deselect specific Process details, Approach documents, Templates, Examples, tools and references. One may further specify for each of these selections whether or not the selection is expected or recommended. In some embodiments, tailoring in the system may be directed toward the Stage and Deliverable levels. This is illustrated, for example, in FIGS. 32 and 33. However, tailoring at additional levels of detail can also be provided. For example, the flight plan can be tailored at a Component level as illustrated, for example, in FIG. 34. Further, tailoring can also be provided at the Supporting Assets level, as illustrated, for example, in FIG. 35.

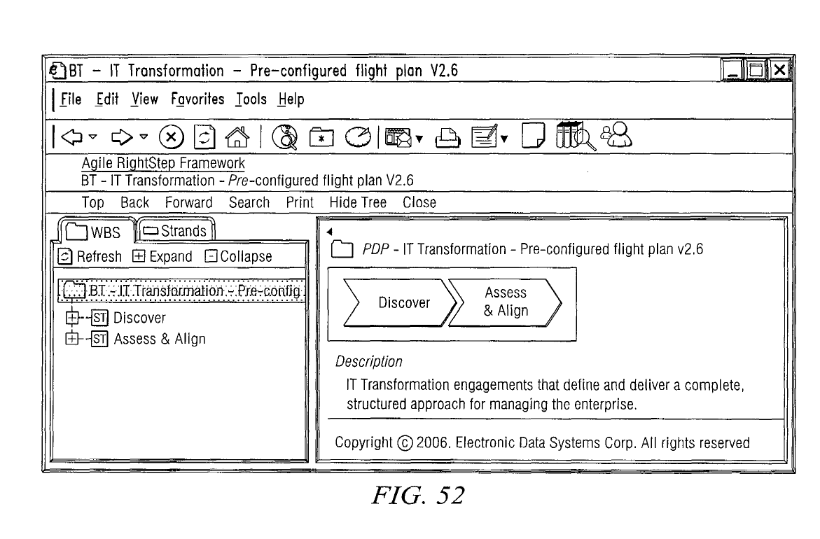

As illustrated in FIGS. 52-54, for example, according to another feature, one may begin flight planning with a pre-configured flight plan, a flight plan or the full framework. In this manner, duplication of work may be reduced and a repeatable approach for delivering a service within a portfolio of services can be provided. For example, if a user performs a flight planning exercise for a client for a particular outsourced service, that user (or a different user within the enterprise) may begin a subsequent project with the flight plan resulting in the first project. Thus, for example, if the user encounters a situation in which he or she needs to develop a flight plan in connection with an outsourcing offering for another client, particularly where the service is the same as, or similar to, the service offered to the first client, the user may benefit from beginning the flight planning exercise with the prior-developed flight plan. Thus, a system and the use thereof may incorporate the development and publication of “Pre-Configured Flight Plans,” which may, for example, define a best-practice set of deliverables and deliverable components used to deliver repeatable solutions (e.g., outsourcing services) in a consistent manner for like situations. Pre-configured flight plan for repeatable services can be made available to all users as a starting point and can be further tailored for a particular engagement.

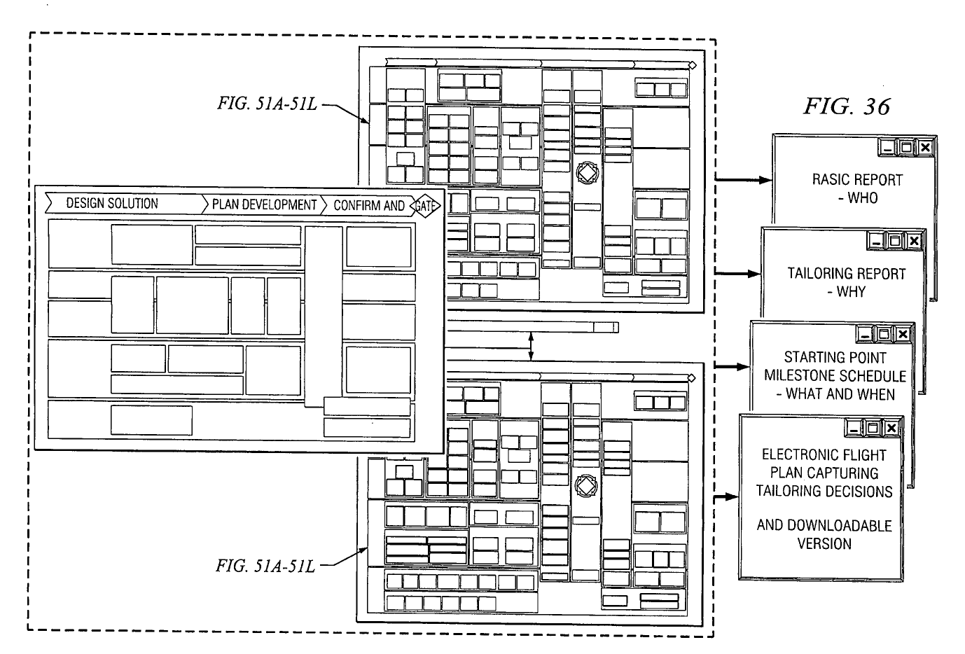

According to further alternative/additional features, users may generate certain outputs from the framework, for example, in connection with their flight plans. This is illustrated, for example, in FIG. 36. For example, a user may be able to generate a Starting Point Schedule File, which may comprise (for example) an MSProject file (mpp file) containing all the deliverables and components selected in the flight plan and linked back to the framework. Activities to produce those deliverables may be added to the File. In addition, deliverables and components are organized by Project Management Phase to meet PPM standards.

As another example, a user may be able to generate a RASIC chart (responsible, approves, supports, information-needed and consults), which may comprise an MS Excel file, used to identify who should produce specific deliverables and deliverable components. The RASIC chart may include links back to the framework. As yet another example, the user may output a set of XML and HTML files that can be used on any standard PC web browser to run as a Framework tool that can be used to derive the information required to produce the deliverables and deliverable components selected. (downloadable for the flight plan).

Still another report that may be generated is a tailoring report, which captures a user's tailoring decisions for the specific flight plan.

In certain circumstances, it may be desirable to simplify the Framework View (seen, for example, by a user through the graphical user interface). Accordingly, the levels of detail may be reduced and/or collapsed. For instance, the levels of detail may be reduced from four levels to two levels, resulting in removal of Key Activities from the Framework tool, and the Deliverable Component level having all the information required to produce the deliverable (instead of having a separate “how-to” level). This may, in certain situations, make the Framework easier to use and the relevant data more readily available for the user. In addition, the number of Framework Views may be reduced from three (Strands, WBS and WPBS), to two (Strands, WBS).

According to still other alternative/additional features, the Framework may include enhanced reporting capabilities. The following additional reports may be created to further support change control reporting:

1. Deliverable/Component Descriptive History Report—A change control log may be added to the InfoPath template used for Deliverable and Component descriptive information. Based on the information from the change log, this report provides a list of the changes and the release it was introduced.

2. Pre-Configured Flight Plan Tracker—This report identifies by Deliverable and Component which pre-configured flight plan it is part of. This is very useful to identify which pre-configured flight plans are impacted by requested changes to a particular Deliverable or Component.

3. Changes Impacting Specific Pre-Configured Flight Plans—By individual pre-configured flight plan, this report identifies updates to components or deliverables included in the pre-configured flight plan as well as any updates to resources attached to components or deliverables included in a pre-configured flight plan.

4. HTML Reports—HTML reports may be generated for the management of change Deliverables and Components so that they can be accessed via the management of a Change web site in addition to the Framework. The functionality added includes the ability to create HTML web pages for each Deliverable and Component within the entire Framework.

In addition to the functional additions and alternatives, there are certain content alternatives and/or additions. For example, an enhanced Framework may include: (1) changes to the PPM strand to reflect that the Framework is applicable to individual projects as well as programs of work; (2) changes to the component deliverables in the PPM strand to enable it to support recursive project and program delivery activities associated with an in-flight activity; (3) integration of a method of Quality Assuring project and program delivery into the Framework, with each QA artifact mapped to the specific deliverables required to meet the respective quality criteria; and (4) inclusion of Data Migration components to ensure that all necessary deliverables have been detailed to enable a reliable identification of information required for migration, systems design, and migration activities to from a legacy environment to it's replacement.

Moreover, the system or parts thereof may be linked with a best-practices repository. For example, the Framework may be linked to an Enterprise Best Practices database whereby any deliverable is supported by an existing best practice or method. This may be referenced, for example, in the “how-to” information contained within the Framework.

Certain various architectures, which may be employed to implement certain embodiments, are illustrated in FIGS. 27-31.

FIG. 27 illustrates a conceptual architecture for a business change framework according to an example embodiment. Framework 2702 may be viewed as representing a business change life cycle. Framework 2702 includes logical classification structure 2704. Structure 2704 may include flight plan 2706 and work products 2716. Flight plan 2706 may include stages 2710 and strands 2908. Strands 2908 comprise deliverables 2714. Stages 2710 comprise key activities 2712 and deliverables 2714. Deliverables 2714 may comprise work products 2716. Deliverables 2714 are linked to attachments 2718 which may comprise, for example, templates, examples, and references. Deliverables 2714 and work products 2716 may also be linked to alternative resources 2720. Alternative resources 2720 may comprise, for example, resources on secondary websites.

The business change lifecycle conceptual architecture may also be represented by a physical architecture such as illustrated in FIG. 28. Architecture 2802 includes business change lifecycle viewer 2804 which is linked to alternative website resources 2818. Viewer 2804 receives input from data storage 2806. Storage 2806 is created from framework pages and viewing scripts 2808, content pages 2810, and documents 2812. This latter information may be provided by, for example, a computer 2814 which receives process content 2816 and converts it to provide content to storage 2806.

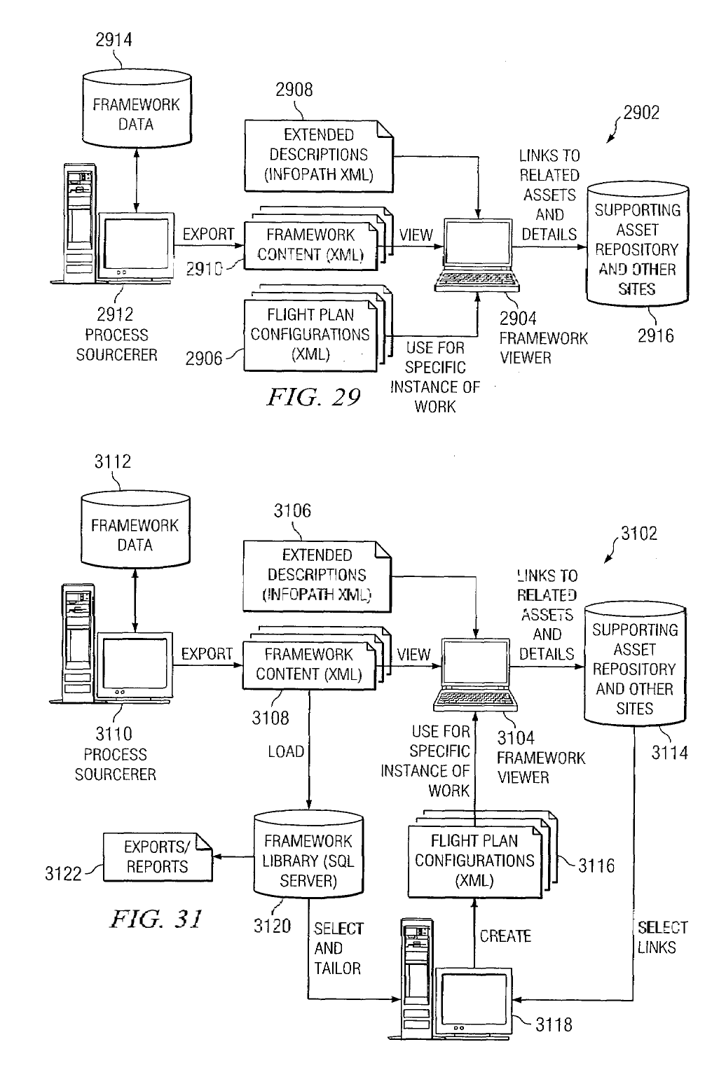

One example of an enhanced framework architecture is illustrated in FIG. 29. Framework 2902 includes framework viewer 2904 which may be linked to supporting asset repository 2916 and flight plan configuration unit 2906. Flight plan configuration unit 2906 may provide input to framework viewer 2904, particularly for use in specific instances of work. Content may be provided to framework 2904 from framework content unit 2910 and extended descriptions 2908. This latter information may be provided by processor 2912 which is linked and receives data from and inputs data to framework data module 2914.

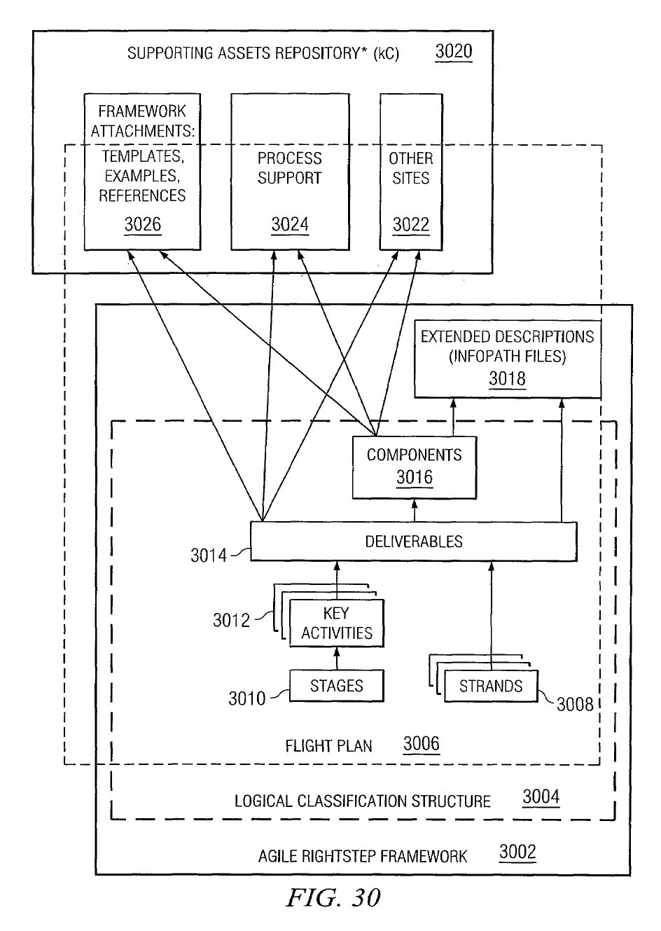

A conceptual architecture for enhanced framework is illustrated in FIG. 30. Framework 3002 includes logical classification structure 3004. Structure 3004 includes certain components that may be viewed as a part of flight plan module 3006. As shown by the dotted line, flight plan module 3006 includes components of structure 3004 as well as at least portions of components from supporting assets repository 3024. Within structure 3004, flight plan module 3006 includes stages 3010 and strands 3008. Strands 3008 comprise deliverables 3014. Stages 3010 comprise key activities 3012 which then in turn comprise deliverables 3014. Deliverables 3014 consists of components 3016. Components 3016 and Deliverables 3014 have external descriptions 3018. The different elements within supporting assets repository 3020 include framework attachments, templates, examples, references 3026; process detail alternatives, guide structure, templates, examples 3024; and other sites 3022 and are linked to from both Deliverables 3014 and Components 3016.

The physical architecture for an enhanced framework may take any number of forms including that already described in connection with FIG. 29 as well as the modified physical architecture shown in FIG. 31. In FIG. 31, architecture 3102 includes framework viewer 3104, supporting asset repository 3114, flight plan configuration unit 3116, framework content unit 3108, extended descriptions 3106, processor 3110 and framework data repository 3112. In general, these elements are similar to those identified and described in connection with FIG. 29. Architecture 3102 further includes interactive tailoring tool 3118 which can receive input from supporting asset repository 3114, and also can provide input to flight plan configuration unit 3116. Tailoring tool 3118 may receive input from framework library 3120 which in turn may receive input from framework content unit 3108. Framework library 3120 may further provide input to exports/reports unit 3122.

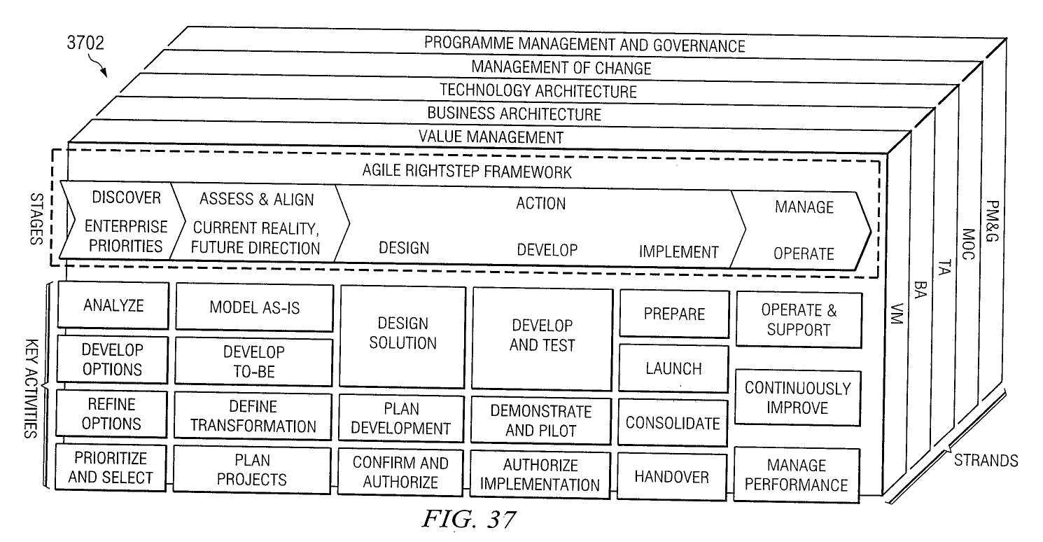

Another example embodiment of the overall framework and its various components is illustrated in FIGS. 37-51. FIG. 37, for example, shows an overall framework 3702. This framework illustrates many stages, strands, and elements as previously described. In certain cases, there are additional, removed, similar, alternative, and/or differently-named components. One purpose in providing FIGS. 37-51 is to demonstrate that the various framework components are not rigid in their nomenclature, functionality and/or configuration.

1. A method of determining and implementing business changes, the method comprising:
defining a set of stages in a business change process;
for each stage, defining at least one deliverable corresponding to the respective stage;
for each deliverable, defining a set of at least one component corresponding to the respective deliverable;
for each component, defining a set of at least one supporting asset corresponding to the respective component; and
manipulating a graphical user interface representing the stages, deliverables, components and supporting assets to customize a change plan, wherein the customization is accomplished at least at a component level.

2. The method of claim 1, wherein the customization is accomplished at a supporting assets level.

3. The method of claim 1, further comprising providing a pre-existing flight plan as a starting point for customizing the change plan, the pre-existing flight plan having at least one stage in common with the customized change plan.

4. The method of claim 1, further comprising providing a pre-existing flight plan as a starting point for customizing the change plan, the pre-existing flight plan having at least one deliverable in common with the customized change plan.

5. The method of claim 1, further comprising providing a pre-existing flight plan as a starting point for customizing the change plan, the pre-existing flight plan having at least one component in common with the customized change plan.

6. The method of claim 1, further comprising providing a pre-existing flight plan as a starting point for customizing the change plan, the pre-existing flight plan having at least one supporting asset in common with the customized change plan.

7. The method of claim 1, further comprising providing a pre-existing flight plan as a starting point for customizing the change plan, the pre-existing flight plan being selected from a plurality of pre-existing flight plans based upon a similarity of the selected pre-existing flight plan to the change plan being customized.

8. The method of claim 1, further comprising generating a starting point schedule file, wherein information from the customized change plan is used as input in generating the starting point schedule file.

9. The method of claim 1, further comprising organizing at least one of deliverables, components, and supporting assets by one or more project management phases.

10. The method of claim 1, further comprising generating a RASIC chart, wherein information from the customized change plan is used as input in generating the RASIC chart.

11. The method of claim 1, further comprising providing a plurality of pre-existing flight plans as a starting point for customizing the change plan, wherein a first pre-existing flight plan includes a first one of a deliverable, component, or supporting asset of the customized change plan, and a second flight plan includes a second one of a deliverable, component, or supporting asset of the customized change plan, tracking pre-existing flight plans used in the customization by establishing a link between at least one pre-existing flight plan and a corresponding one of the deliverables, components or supporting assets of the customized change plan.

12. The method of claim 1, further comprising grouping, in a strand, at least one each of a stage, a deliverable, and a component, the strand being characterized by an interdependence between the grouped at least one stage, deliverable, and component.

13. The method of claim 12, further comprising generating a report identifying a plurality of deliverables and associated components, and a designation of at least one strand associated with each identified deliverable and component.

14. The method of claim 1 further comprising providing one or more assets and resources for supporting execution of at least one deliverable or component.

15. The method of claim 14, further comprising generating a report identifying an association between at least one asset or resource and at least one deliverable or component.

16. The method of claim 1, further comprising enabling the graphical user interface to notify a user of the existence of a plurality of enterprise best practices repositories containing information usable in the customization of the change plan.

17. A system for determining and implementing business changes, the system comprising:
a first module for defining a set of stages in a business change process;
a second module for defining, for each stage, at least one deliverable corresponding to the respective stage;
a third module for defining, for each deliverable, a set of at least one component corresponding to the respective deliverable;
a fourth module for defining, for each component, a set of at least one supporting asset corresponding to the respective component; and
a graphical user interface representing the stages, deliverables, components and supporting assets for customizing a change plan, wherein the customization is accomplished at least at a component level.

18. The system of claim 17, wherein at least two of the first, second, third and fourth modules are provided as one module.

19. A computer program product in a computer readable media for use in a data processing system for determining and implementing business changes, the computer program product comprising:
first instructions for defining a set of stages in a business change process;
second instructions, for each stage, for defining at least one deliverable corresponding to the respective stage;
third instruction, for each deliverable, for defining a set of at least one component corresponding to the respective deliverable; and
fourth instructions, for each component, for defining a set of at least one supporting asset corresponding to the respective component; and
a graphical user interface representing the stages, deliverables, components and supporting assets for customizing a change plan, wherein the customization is accomplished at least at a component level.
